(19) United States
(12) Patent Application Publication
(10) Pub. No.: US 2014/0141888 A1
(43) Pub. Date: May 22, 2014

(54) Methods and Systems for Using Mini-Games to Form a Hierarchical Social Network

(71) Applicant: Plaor, Inc., Los Angeles, CA (US)

(72) Inventor: Alan Pavlish, Marina Del Rey, CA (US)

(73) Assignee: Plaor, Inc., Los Angeles, CA (US)

(21) Appl. No.: 14/054,699

(22) Filed: Oct. 15, 2013

Related U.S. Application Data
(60) Provisional application No. 61/714,602, filed on Oct. 16, 2012.
(60) Provisional application No. 61/820,646, filed on May 7, 2013.
(60) Provisional application No. 61/872,636, filed on Aug. 30, 2013.

(51) Int. Cl. A63F 13/30

(52) U.S. Cl. CPC A63F 13/12
USPC 463/42

(57) ABSTRACT

The present specification describes a method of online gaming among members of a social network, that provides a database of content, in a plurality of formats, for a game allowing an initiating user who has downloaded the gaming application to access and select at least one format from a plurality of formats, from the database, receive a first piece of content corresponding to at least one format, and provide a response to the first piece of content, by planting a seed and growing a tree. Further, when the response is received from the first user, the trunk of a tree is formed. Subsequent users interact with content and form branches and leaves on the tree, thereby creating a viral tree community based on a game.

### CROSS-REFERENCE

The present application relies on U.S. Provisional Patent Application No. 61/714,602, entitled “Methods and Systems for Enabling Online Game Play”, and filed on Oct. 16, 2012; U.S. Provisional Patent Application No. 61/820,646, entitled “Methods and Systems for Integrating Social Network Formation and Management with Gaming”, and filed May 7, 2013; and U.S. Provisional Patent Application No. 61/872,636, entitled “Methods and Systems for Integrating Social Network Formation and Management with Gaming”, and filed Aug. 30, 2013. All of the above-mentioned applications are herein incorporated by reference in their entirety.

### FIELD

The present specification is directed toward methods and systems for integrating social networks with conventional games and, more specifically, for generating, using, and deploying mini-games to enable a user to form a hierarchical social game and network.

### BACKGROUND

Social networks, such as Facebook® and Twitter®, have become the primary means for communities to create networks of friends or followers. These social networks require individuals to create content in order to acquire followers or friends. However, creating content can often be a laborious and difficult task. More specifically, knowing what to create, what will be of interest, or what will get the attention of users is a “hit or miss” activity, with a vast majority of created content often going unnoticed.

Even after content is created, there is no integrated or automated way to incentivize those who receive the content to republish or redistribute the content in order to help the originating user build his or her social network. Expanding one's social network through the redistribution of content requires a user to generate very high quality content and to hope the content is interesting enough to spur the first recipients to distribute that content on behalf of the originating user. This content redistribution, also known as virality, is difficult to incentivize in any cost effective way.

Furthermore, even if one generates quality content that is then redistributed widely, it is difficult to effectively generate revenue reliably. The most common approaches to generating revenue from one's social network is through sending out promotional messages or advertising. This has limited value, however, given that users are typically not interested in receiving such messaging and rapidly tune out, or turn off, such advertising.

While the above problems plague users in social networks, social game developers face similar “content” challenges. Specifically, in order to spur revenue growth, social game developers need to constantly provide new and interesting content to users. This can be quite challenging given the time required to generate content for a social game. Game developers need to balance the need for new content against the cost of developing that content and the extent of impact such new content will have on retaining users and generating revenue from such users over a period of time.

In light of the above, a new approach to building social networks and generating content for games is required. In particular, what is needed is a gaming platform that can rapidly integrate new content and help generate a social network. What is also needed is a way of enabling individuals to automatically generate revenue from an established social network.

These, and other, objectives are further discussed and explained by reference to the Figures and Detailed Description.

### SUMMARY

This specification is directed toward a new game architecture that has several key components: a) a content platform which relies on “micro-apps” or mini-games that can be rapidly developed and deployed into the content platform, b) a game play architecture that automatically generates a large social network as a by-product of the game play, and c) a game play architecture that automatically generates revenue based upon the size, extent, and quality of game play within the user's social network.

In one embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of questions and answers, in a plurality of formats, for said game; c) enabling an initiating user who has downloaded the gaming application to access a first question from said database and receive a first question; d) receiving a first answer from said initiating user to said first question; e) enabling said initiating user to choose a plurality of second users from a contact list of said initiating user; f) sending a first question associated with a challenge to each one of said plurality of second users via a social network message; g) enabling each one of said plurality of second users to independently view and answer said first question associated with a challenge; h) revealing said initiating user's answer to the first question to said plurality of second users; i) enabling each one of said second users to 1) progress with said game if said answer to said first question is correct by re-answering the first question with a personal response or receiving a second question to respond to or 2) providing each one of said second users the opportunity to spend virtual currency to remain in the game if said answer to said first question is incorrect; j) enabling each of said second users to choose a plurality of third users from a contact list of each one of said second users after each one of said second users answers said first or second question; k) sending a first or second question to each one of said plurality of said third users via a social network message; and, 1) repeating the steps of enabling members to choose additional members from contact lists as questions are answered correctly, thereby indefinitely adding new members to said game.

In one embodiment, the first or second question comprises a restatement of the first or second question after a response to said first or second question is provided.

In one embodiment, each member has a predetermined time period to answer a question, further wherein said member is removed from said game if said question is not answered by said member within said time period. In one embodiment, said time period is 24 hours. In one embodiment, said gaming site sends periodic social network messages during said time period to remind said member to answer said question.

In one embodiment, the method further comprises the step of providing each member a graphical user interface wherein said questions and members of said game are graphically represented by a tree, further wherein said initiating user is represented by a trunk of said tree, said first players are represented by a first set of branches emanating from said trunk, and said second players are represented by a second set of branches emanating from said first set of branches, and so forth.

In one embodiment, the method further comprises the step of enabling said members to view member profiles, send questions to new members, answer questions, and view gaming statistics from said graphical user interface.

In another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of questions and answers, in a plurality of formats, for said game; c) enabling an initiating user who has downloaded the gaming application to access a first question from said database and receive a first question, by planting a seed and growing a tree; d) receiving a first answer from said initiating user to said first question, forming a trunk of a tree; e) enabling said initiating user to choose a plurality of second users from a contact list of said initiating user; f) sending a first question to each one of said plurality of second users via a social network message; g) enabling each one of said plurality of second users to independently view and answer said first question; h) revealing said initiating user's answer to the first question to said plurality of second users; and i) enabling each one of said second users to become a leaf on said tree by choosing not to progress with said game.

In one embodiment, said first or second question comprises a restatement of the first or second question after a response to said first or second question is provided.

In yet another embodiment, the present specification discloses a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of questions and answers, in a plurality of formats, for said game; c) enabling an initiating user who has downloaded the gaming application to access a first question from said database and receive a first question; d) receiving a first answer from said initiating user to said first question; e) enabling said initiating user to choose a plurality of second users from a contact list of said initiating user; f) sending said first question to each one of said plurality of second users via a social network message; g) enabling each one of said plurality of second users to independently view and answer said first question; h) revealing said initiating user's answer to the first question to said plurality of second users; and i) enabling each one of said second users to 1) progress with said game if said answer to said first question is correct by re-answering the first question or receiving a second question or 2) providing each one of said second users the opportunity to spend virtual currency to remain in the game if said answer to said first question is incorrect.

In one embodiment, the method further comprises the step of enabling each of said second users to choose a plurality of third users from a contact list of each one of said second users after each one of said second users answers said first or second question.

In one embodiment, the method further comprises the step of sending said answered first or second question to each one of said plurality of said third users via a social network message.

In one embodiment, the method further comprises repeating the steps of enabling members to choose additional members from contact lists as questions are answered correctly, thereby indefinitely adding new members to said game.

In one embodiment, each member has a predetermined time period to answer a question, further wherein said member is removed from said game if said question is not answered by said member within said time period, where said time period is 24 hours.

In one embodiment, said gaming site sends periodic social network messages during said time period to remind said member to answer said question.

In one embodiment, the method further comprises the step of providing each member a graphical user interface wherein said questions and members of said game are graphically represented by a tree, further wherein said initiating user is represented by a trunk of said tree, said first players are represented by a first set of branches emanating from said trunk, and said second players are represented by a second set of branches emanating from said first set of branches, and so forth.

In one embodiment, the method further comprises the step of enabling said members to view member profiles, send questions to new members, answer questions, and view gaming statistics from said graphical user interface.

In yet another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of questions and answers, in a plurality of formats, for said game; c) enabling an initiating user who has downloaded the gaming application to access a first question from said database and receive a first question, by planting a seed and growing a tree; d) receiving a first answer from said initiating user to said first question, forming a trunk of a tree; e) enabling said initiating user to choose a plurality of second users from a contact list of said initiating user; f) sending said first question to each one of said plurality of second users via a social network message; g) enabling each one of said plurality of second users to independently view and answer said first question; h) revealing said initiating user's answer to the first question to said plurality of second users; i) enabling each one of said second users to 1) progress with said game if said answer to said first question is correct by re-answering the first question or receiving a second question or 2) providing each one of said second users the opportunity to spend virtual currency to remain in the game if said answer to said first question is incorrect; j) enabling each of said second users to choose a plurality of third users from a contact list of each one of said second users after each one of said second users answers said first or second question; k) sending said answered first or second question to each one of said plurality of said third users via a social network message, allowing said second user to become a branch on the tree; and, l) repeating the steps of enabling members to choose additional members from contact lists as questions are answered correctly, thereby indefinitely adding new branches to said tree.

In yet another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of content, in a plurality of formats, for said game; c) enabling an initiating user who has downloaded the gaming application to access and select at least one content type from said database, receive a first piece of content corresponding to said at least one content type, and provide a response to said first piece of content; d) receiving a first response from said initiating user from said user's interaction with said first piece of content; e) enabling said initiating user to choose a plurality of first players from a contact list of said initiating user; f) sending said first piece of content to each one of said plurality of first players via a social network message; g) enabling each one of said plurality of first players to independently view and respond to said first piece of content; h) revealing said initiating user's answer to said first piece of content to said plurality of second users; i) enabling each one of said first players to 1) progress with said game if said response to said first piece of content is correct by providing a personal response to said first piece of content or receiving a second piece of content to provide a response to or 2) providing each one of said first players the opportunity to spend virtual currency to remain in the game if said response to said first piece of content is incorrect; j) enabling each of said first players to choose a plurality of second players from a contact list of each one of said first players after each one of said first players responds to said first or said second piece of content; k) sending said answered first or second piece of content to each one of said plurality of said second players via a social network message; and, 1) repeating the steps of enabling members to choose additional members from contact lists as content is responded to correctly, thereby indefinitely adding new members to said game.

In one embodiment, after a response is provided to each of a first, second, and any subsequent piece of content, the piece of content is modified by at least one processor in accordance with said response prior to being sent to each of a first, second or subsequent player.

In yet another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of content, in a plurality of formats, for said game; c) enabling an initiating user who has downloaded the gaming application to access and select at least one content type from said database, receive a first piece of content corresponding to said at least one content type, and provide a response to said first piece of content, by planting a seed and growing a tree; d) receiving a response from said first user to said first piece of content, forming a trunk of a tree; e) enabling said first user to choose a plurality of second users from a contact list of said first user; f) sending said first piece of content to each one of said plurality of second users via a social network message; g) enabling each one of said plurality of second users to independently view and answer said first piece of content; h) revealing said initiating user's answer to the first piece of content to said plurality of second users; and i) enabling each one of said second users to become a leaf on said tree by choosing not to send the content along to subsequent players and to not progress with said game.

In yet another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of content, in a plurality of formats, for said game; c) enabling an initiating user who has downloaded the gaming application to access and select at least one content type from said database and receive a first piece of content corresponding to said at least one content type; d) receiving a first response from said initiating user from said user's interaction with said first piece of content; e) enabling said initiating user to choose a plurality of first players from a contact list of said initiating user; f) sending said first piece of content to each one of said plurality of first players via a social network message; g) enabling each one of said plurality of first players to independently view and respond to said first piece of content; h) revealing said initiating user's answer to the first piece of content to said plurality of first players; and i) enabling each one of said first players to 1) progress with said game if said response to said first piece of content is correct by providing a personal response to said first piece of content or receiving a second piece of content to provide a response to or 2) providing each one of said first players the opportunity to spend virtual currency to remain in the game if said response to said first piece of content is incorrect.

In one embodiment, the method further comprises the step of enabling each of said first players to choose a plurality of second players from a contact list of each one of said first players after each one of said first players responds to said first or said second piece of content.

In one embodiment, the method further comprises the step of sending said answered first or second piece of content to each one of said plurality of said second players via a social network message.

In one embodiment, the method further comprises the steps of enabling members to choose additional members from contact lists as content is responded to correctly, thereby indefinitely adding new members to said game.

In one embodiment, after a response is provided to each of a first, second, and any subsequent piece of content, the piece of content is modified by at least one processor in accordance with said response prior to being sent to each of a first, second or subsequent player.

In yet another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steeps of a) providing a gaming application for downloading onto a mobile device and for use on a mobile platform; b) providing a database of questions and answers, in a plurality of formats, for said game; c) enabling an initiating user who has downloaded the gaming application to access a first question from said database and receive a first question; d) receiving a first answer from said initiating user to said first question, thereby creating a challenge; e) enabling said initiating user to Choose a plurality of first players from a contact list of said initiating user; f) sending said challenge to each one of said plurality of first players via a social network message: g) enabling each one of said plurality of first players to independently view and respond to said challenge; h) revealing said initiating user's answer to said first question to said plurality of first players; i) enabling each one of said first players to 1) progress with said game if said challenge is responded to correctly by re-creating a challenge with a personal response or receiving a second question to create a new challenge or 2) providing each one of said first players the opportunity to spend virtual currency to remain in the game, if said response to said challenge is incorrect; j) enabling each of said first players to choose a plurality of second players from a contact list of each one of said first players after each one of said first players responds to said first or said new challenge; k) sending a said first or said new challenge to each one of said plurality of said second players via a social network message; and, l) repeating the steps of enabling members to choose additional members from contact lists as challenges are responded to correctly, thereby indefinitely adding new members to said game.

In yet another embodiment, the present specification is directed towards a method of online gaming among members of a social network, said online gaming effectuated by a plurality of programmatic instructions stored in a non-volatile memory, either remote or local to client devices and servers, and executed by processors at the client devices or servers, said method comprising the steps of: a) providing a gaming application for downloading onto a mobile device and for use on a mobile platform; b) providing a database of content, in a plurality of formats, for said game; c) enabling an initiating user who has downloaded the gaming application to access and select at least one content type from said database, receive a first piece of content corresponding to said at least one content type, and provide a response to said first piece of content; d) receiving a response from said initiating user to said first piece of content, thereby creating a challenge; e) enabling said initiating user to choose a plurality of first players from a contact list of said initiating user; f) sending said challenge to each one of said plurality of first players via a social network message; g) enabling each one of said plurality of first players to independently view and respond to said challenge; h) revealing said initiating user's answer to said first piece of content to said plurality of first players; i) enabling each one of said first players to l) progress with said game if said response to said challenge is correct by responding to said challenge receiving a second piece of content to create a new challenge or 2) providing each one of said first players the opportunity to spend virtual currency to remain in the game if said response to said challenge is incorrect; j) enabling each of said first players to choose a plurality of second players from a contact list of each one of said first players; k) sending said first challenge or new challenge to each one of said plurality of second players via a social network message; and, l) repeating the steps of enabling members to choose additional members from contact lists as challenges are created and responded to correctly, thereby indefinitely adding new members to said game.

In yet another embodiment, the present specification is directed toward a method for providing a mobile game, comprising: a) providing a first question to a first user; b) receiving a first response to the first question by the first user; c) storing said first response to the first question; d) offering to the first user an option to send a version of said first question to a plurality of second users; e) prompting each of said plurality of second users to answer the version of the first question; f) receiving a plurality of second responses from at least a portion of said plurality of second users based upon said prompting; g) storing said plurality of second responses in a database; h) comparing each of said plurality of second responses against said first response; and i) based upon said comparing, prompting the portion of said plurality of second users to either respond to a second question and send a version of the second question to a plurality of third users, wherein the first user, the portion of said plurality of second users, and a portion of said plurality of third users form a hierarchical social network or spend virtual currency to remain part of said hierarchical social network.

In one embodiment, the first question is the same as the second question. In one embodiment, the first question is not the same as the second question. In one embodiment, the first question is selected by the first user from a plurality of questions.

In one embodiment, the method further comprises the step of providing the first user an option to record an audio, text, video or pictorial message after said first user inputs the first response.

In one embodiment, the step of prompting each of said plurality of second users to answer the version of the first question occurs within a predefined time period.

In one embodiment, the method further comprises the step of notifying each of said plurality of second users of an existence of said version of the first question during said predefined time period using an electronic message.

In one embodiment, the method further comprises the step of dropping a portion of the plurality of second users from the hierarchical social network who do not respond to the version of said first question within the predefined time period.

In one embodiment, the method further comprises the step of dropping a portion of the plurality of second users from the hierarchical social network who do not spend virtual currency to remain part of said hierarchical social network.

In one embodiment, said plurality of second users and plurality of third users do not have any individual users in common.

In one embodiment, the method further comprises the step of providing one of the portion of said plurality of second users with an interface to post an electronic message to other users of the portion of said plurality of second users.

In one embodiment, the method further comprises the steps of receiving a second response to the second question by one of the portion of said plurality of second users; storing said second response to the second question; offering to the one of the portion of said plurality of second users an option to send a version of said second question to the plurality of third users; prompting each of said plurality of third users to answer the version of the second question; receiving a plurality of third responses from at least a portion of said plurality of third users based upon said prompting; storing said plurality of third responses in a database; comparing each of said plurality of third responses against said second response; and based upon said comparing, prompting the portion of said plurality of third users to either respond to a third question and send a version of the third question to a plurality of fourth users, wherein the first user, the portion of said plurality of second users, the portion of said plurality of third Users, and a portion of said plurality of fourth users form said hierarchical social network or spend virtual currency to remain part of said hierarchical social network.

The aforementioned and other embodiments of the present specification shall be described in greater depth in the drawings and detailed description provided below.

### BRIEF DESCRIPTION OF THE DRAWINGS

These and other features and advantages of the present specification will be further appreciated, as they become better understood by reference to the detailed description when considered in connection with the accompanying drawings:

FIG. 1 is a flow diagram showing a general user flow of the gaming application of the present specification;

FIG. 2A is an illustration showing a graphical representation of one embodiment of the present specification where the game is represented by a tree;

FIG. 2B is an illustration showing a graphical representation of one embodiment of the present specification where the game is represented by a tree;

FIG. 2C is an illustration showing a graphical representation of one embodiment of the present specification where the game is represented by a tree;

FIG. 3A is a flow diagram illustrating the steps of game play in one embodiment of the present specification, where the game is played in the form of building a tree;

FIG. 3B is a flow diagram illustrating the steps of game play in one embodiment of the present specification, where the game is played in the form of building a tree;

FIG. 3C is an exemplary game interface wireframe showing a personalization screen in which the initiating user can personalize certain features of the game;

FIG. 4A is a table showing one embodiment of a content type of a mini-game that may be played in accordance with the gaming application of the present specification;

FIG. 4B is a table showing one embodiment of a content type of a mini-game that may be played in accordance with the gaming application of the present specification;

FIG. 4C is a table showing one embodiment of a content type of a mini-game that may be played in accordance with the gaming application of the present specification;

FIG. 4D is a table showing one embodiment of a content type of a mini-game that may be played in accordance with the gaming application of the present specification;

FIG. 4E is a table showing one embodiment of a content type of a mini-game that may be played in accordance with the gaming application of the present specification;

FIG. 4F is a table showing one embodiment of a content type of a mini-game that may be played in accordance with the gaming application of the present specification;

FIG. 4G is a table showing one embodiment of a content type of a mini-game that may be played in accordance with the gaming application of the present specification;

FIG. 4H is a table showing one embodiment of a content type of a mini-game that may be played in accordance with the gaming application of the present specification;

FIG. 4I is a table showing one embodiment of a content type of a mini-game that may be played in accordance with the gaming application of the present specification;

FIG. 4J is a table showing one embodiment of a content type of a mini-game that may be played in accordance with the gaming application of the present specification;

FIG. 4K is a table showing one embodiment of a content type of a mini-game that may be played in accordance with the gaming application of the present specification;

FIG. 5 is an exemplary graphical user interface wireframe of the gaming application of the present specification, in a basic embodiment;

FIG. 6 is an exemplary graphical user interface wireframe of the gaming application of the present specification, in a basic embodiment;

FIG. 7 is an exemplary graphical user interface wireframe of the gaming application of the present specification, in a basic embodiment;

FIG. 8 is an exemplary graphical user interface wireframe of the gaming application of the present specification, in a basic embodiment;

FIG. 9 is an exemplary graphical user interface wireframe of the gaming application of the present specification, in a basic embodiment;

FIG. 10 is an exemplary graphical user interface wireframe of the gaming application of the present specification, in a basic embodiment;

FIG. 11 is an exemplary graphical user interface wireframe of the gaming application of the present specification, in a basic embodiment;

FIG. 12 is an exemplary graphical user interface wireframe of the gaming application of the present specification, in a basic embodiment;

FIG. 13 is an exemplary graphical user interface wireframe of the gaming application of the present specification, in a basic embodiment;

FIG. 14 is an exemplary graphical user interface wireframe of the gaming application of the present specification, in a basic embodiment;

FIG. 15 is an exemplary graphical user interface wireframe of the gaming application of the present specification, in a basic embodiment;

FIG. 16 is an exemplary graphical user interface wireframe of the gaming application of the present specification, in a basic embodiment;

FIG. 17 is an exemplary graphical user interface wireframe of the gaming application of the present specification, in a basic embodiment;

FIG. 18 is an exemplary graphical user interface wireframe of the gaming application of the present specification, in a basic embodiment;

FIG. 19 is an exemplary graphical user interface wireframe of the gaming application of the present specification, in a basic embodiment;

FIG. 20 is an exemplary graphical user interface wireframe of the gaming application of the present specification, in a basic embodiment;

FIG. 21 is an exemplary graphical user interface wireframe of the gaming application of the present specification, in a basic embodiment;

FIG. 22 is an exemplary graphical user interface wireframe of the gaming application of the present specification, in a basic embodiment;

FIG. 23 is an exemplary graphical user interface wireframe of the gaming application of the present specification, in a basic embodiment;

FIG. 24 is an exemplary graphical user interface wireframe of the gaming application of the present specification, in a basic embodiment;

FIG. 25 is an exemplary graphical user interface wireframe of the gaming application of the present specification, in a basic embodiment;

FIG. 26 is an exemplary graphical user interface wireframe of the gaming application of the present specification, in a basic embodiment;

FIG. 27 is an exemplary graphical user interface wireframe of the gaming application of the present specification, in a basic embodiment;

FIG. 28 is an exemplary graphical user interface wireframe of the gaming application of the present specification, in a basic embodiment;

FIG. 29 is an exemplary graphical user interface wireframe of the gaming application of the present specification, in a basic embodiment;

FIG. 30 is an exemplary graphical user interface wireframe of the gaming application of the present specification, in a basic embodiment;

FIG. 31 is an exemplary graphical user interface wireframe of the gaming application of the present specification, in a basic embodiment;

FIG. 32 is an exemplary graphical user interface wireframe of the gaming application of the present specification, in a basic embodiment;

FIG. 33 is an exemplary graphical user interface wireframe of the gaming application of the present specification, in a basic embodiment;

FIG. 34 is an exemplary graphical user interface wireframe of the gaming application of the present specification, in a basic embodiment; and

FIG. 35 is an exemplary graphical user interface wireframe of the gaming application of the present specification, in a basic embodiment.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

For purposes of this application, a social network is an on-line community defined by a first set of data, organized into an account in a mobile application or a set of web pages, that are controlled by and defining the interests, profile, images, video, audio, or other information of a first user (collectively first user data), and a second set of data, organized into an account in a mobile application or a set of web pages, each controlled by and defining the interests, profile, images, video, audio, or other information of a second user (collectively second user data), where the first user can selectively grant to the second user access to the first user data and/or where the second user can selectively grant to the first user access to the second user data. It should be appreciated that the selective granting of data access can be applied by any number of first users by and among any number of second users. It should further be appreciated that when a first user grants to the second user access to the first user data, the first user is “connected” to the second user.

For purposes of this application, a mobile platform is an operating system programmed to execute on a mobile device, such as a phone or tablet computer, and connect with a remotely hosted e-commerce store for enabling a user to access a plurality of applications. The operating system defines a plurality of procedures, calls, methods, and other programmatic tools which, if adopted and integrated into the applications, permit the application to be purchased, downloaded, and used on the mobile device.

Both the mobile platform and social network are further defined in that they provide users with a single point of purchase functionality. Even though each may provide access to thousands of products and services, primarily software of different types from different vendors, they provide users with a single point of purchase functionality that is typically actuated by just inputting an identifier, unique to the user of the mobile platform or social network, which triggers a purchase process by authorizing the use of a stored set of billing processes, such as a bank withdrawal or credit card charging process. In this manner, a user of the mobile platform or social network need not engage with multiple different billing systems or re-input billing information every time the user wishes to purchase a software application from a new or different vendor. The mobile platform and social network provide a single purchase functionality that is integrated into the software for hosting the social network and its e-commerce store and integrated into the software for the mobile device operating system and its remotely hosted e-commerce store.

For purposes of this application, a mini-game is any digital content which can be interacted with by a first user to create a challenge for a plurality of second users. A mini-game differs from a conventional game in that it typically only includes a single level, a single life, and/or a single interaction screen and is designed to obtain an output which is reformatted as a challenge to a plurality of second users. The term mini-game may include abbreviated versions of conventional games such as question and answer games, chain games, fantasy games, arcade games, bingo, racing games, sporting games, football, baseball, tennis, bowling, ping pong, boxing, basketball, rowing, sailing, shooting, archery, judo, equestrian, gymnastics, wrestling, skiing, hockey, volleyball, cycling, fencing, golf, dominoes, baccarat, word games, crosswords, Scrabble, role play, casino games, roulette, craps, dice games, canasta, chess, checkers, simulation games, mah jong, any card games, including poker, all fives, blackjack, old maid, bridge, pai gow, rummy, 21, crazy eights, or cribbage, or any variations thereof.

For purposes of this application, social network messaging, including a “post” or a “tweet”, refers to a person, a user such as a celebrity, using a computing device, such as a PC, laptop, mobile phone, or tablet, to broadcast an image, text message, video, or other media, to other individuals whose communication address is associated with the person's account in a managing database. It should be appreciated that all of the gaming systems described herein are operated by hosting servers, executing programmatic code, communicating in a wired or wireless manner with programmatic code on a client device being operated by a user, such as a mobile phone, tablet computer, personal computer, laptop or other computing device.

In an embodiment, the gaming site of the present specification provides users with an option to play one or more games or mini-games with one or more virtual opponents via the gaming website, via a social networking website such as Facebook®, or via a mobile phone operating system, such as Apple® iOS or Google® Android. In an embodiment, in order to play via a smart phone, a user is prompted to download and install a gaming application by first opening the gaming site on the phone and subsequently clicking on a link provided therein.

In an embodiment, a user may elect to play the game provided by the hosting gaming site via their social network sites such as Facebook®. In an embodiment, a user may perform a search for the gaming application on his/her Facebook® page and commence gameplay via opening the application, while still being on Facebook®. This feature allows the user to play with one or more of his/her Facebook® friends that happen to be online at that time by inviting such friends to play. The invite may be sent to the accounts or profile pages of friends. The user may also post updates on his/her homepage notifying everyone, or his/her friends, a time and date when the user would be playing the online game, thereby allowing other individuals to join the user's game at the notified times.

While accessing the gaming application via a social networking site, such as Facebook®, a user is informed that the application would be accessing the user's basic information which may be made available by the networking site. The online gaming system of the present specification uses this basic information, such as the user's name and photo, as well as the user's friends list in order to enable the user to see and play with online friends. The gaming application also requests permission to send emails to the user by using the email provided by the user to the networking site, in order to send the user alerts on the receipt of gifts, neighbor invitations, and occasionally information on new features, games and special offers, including virtual goods. The user may specify whether the application can send e-mails. Further the user may change the permission granted at any time. The gaming application also requests permission to post to the user's profile page (or ‘wall’) on the networking site for sharing gaming information and rewards with friends. The user may specify whether the application can make such postings. In addition, the user is informed that the gaming application may access the user's profile information provided on the networking site. For example, the gaming application may obtain the user's birth date from the profile information provided to ensure that the user receives age-appropriate content from the gaming application.

The user may also choose to play a mini-game selected from a set of games hosted by the gaming website via the website itself. In this case, the user is required to log-in to a social network from within the gaming site, in order to enable play, gift-sharing, etc. with his/her friends. In one embodiment, if a user does not have an account on any social networking site, the user is prompted to create one prior to commencing gameplay.

### Architecture Overview

In one embodiment, the online gaming system of the present specification provides a user, which may be an individual, a company, a partnership, a charity, or any other legal entity, with an option of initiating certain mini-games that, when played, increase or expand the number of individuals that are part of the users' social network. That social network is visually described as a tree, but it may take any form that has some element of hierarchy embedded within it where an initiating user (the trunk, community owner, or social network owner) is at the base and other members are either directly connected to the initiating user or indirectly connected to the initiating user through other users.

In one embodiment, the tree trunk represents the player that initiates the game, also known as the first user or the initiating user. In one embodiment, branches, also known as a second (or third, fourth, etc.) user or one who was invited to play the game by the another user, represent all players that choose to progress in the game by receiving and engaging in a mini-game challenge from another user and distributing mini-game challenges to another set of users. In another embodiment, leaves represent all players that choose to remain in the game by receiving and engaging in a mini-game challenge from another user but not distributing any challenges from mini-games themselves. In one embodiment, branches and limbs are used interchangeably. In one embodiment, several trees, or several communities, form a forest.

Mini-games may comprise multiple different types of content, as described above, and, within each type of content, multiple different formats. A format may comprise of several types of media, including but not limited to text, audio, images, or video media. In one embodiment, the content is a question and answer game that is passed along among the “initiating player” and “subsequent players”. Thus, the content may comprise multiple different formats, including a multiple choice question (i.e. text or audio) or a series of images. In the game vernacular, each type of format for each type of content represents “food” or “food packets” for the community to feed and nurture trees. An “initiating user” can select from many different types of content and corresponding formats through which their tree is nurtured and for subsequent players to engage in. In addition, within each content type, there are several themes, which are genres or sub-genres. Different types of content, formats, and themes are described below. While throughout this text, examples are provided with respect to “questions”, it should be noted that this is for illustrative and descriptive purposes only and that any content type of any format may be used with the present invention as described in the present specification.

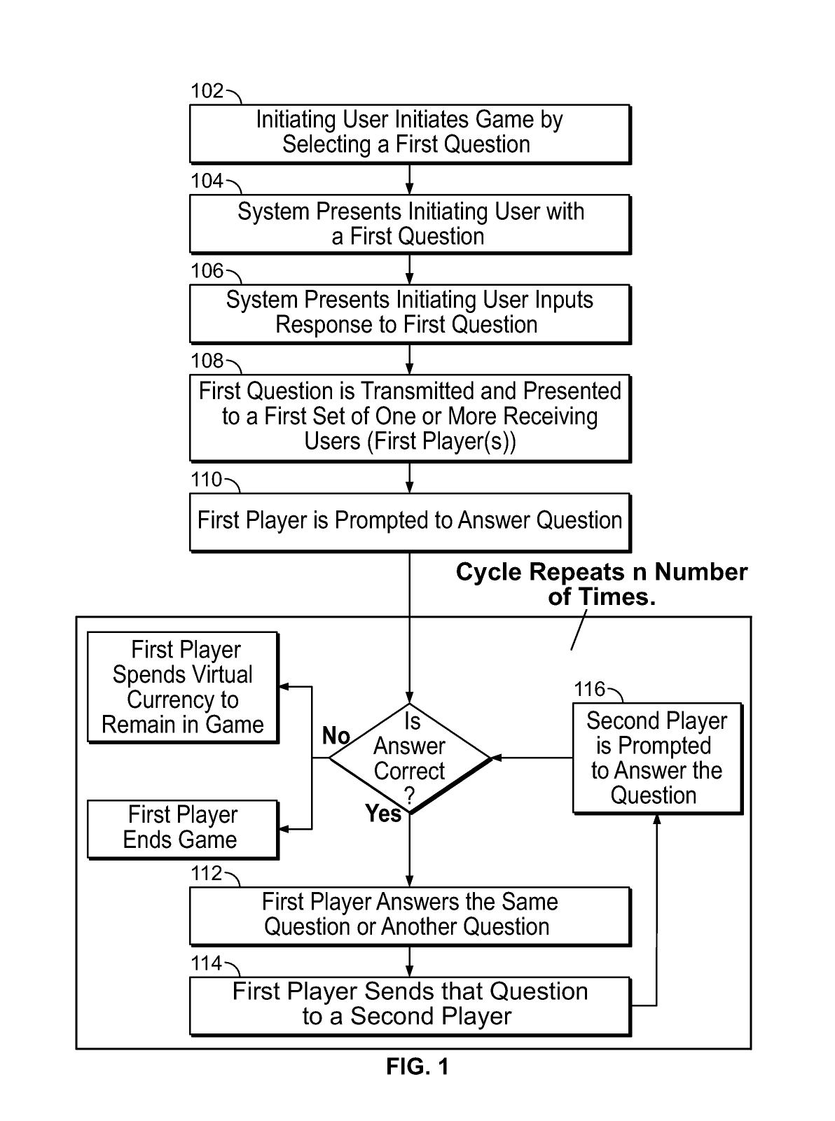

FIG. 1 is a flowchart illustrating the general flow between participants in the mini-game described in the present specification. In step 102, a user (also referred to as an “initiating user”) requests to initiate a mini-game and creates a challenge for other users/players. The request may take the form of the user signing into the game, the user accessing the gaming site via their electronic device, and/or the user selecting a button or other indicator to start the game. For a first time user, they may be routed to a sign-up screen. If the user is a return user that has already logged in, then they will be taken to the home screen. In response to the request, in step 104, the system presents an initiating user with a first piece of content, in at least one of a plurality of formats, as described below, thereby starting the social network hierarchy.

In one embodiment, in step 106, the initiating user inputs their response to the first piece of content or first question, where the response generally relates to the initiating user. The first piece of content or first question is modified in accordance with that response, for subsequent users to answer. In one embodiment, and described in greater detail below, the response is format dependent. For example, the response may be a personal answer to a question, a preference, an opinion, a time score value or any other response appropriate to the format. For example, in a puzzle mini-game, the response may include something such as the “time to beat”. If the response is something in the nature of “time to beat” then a “correct” response to that content would be a better time value (i.e. a shorter time spent to beat the game challenge).

In one embodiment, a mini-game is necessarily centered around some aspect of a user, such as guessing that user's opinion, ideas, beliefs, desires, wishes, likes, dislikes, abilities, or some other personality, talent or thought of that user. Thus, the present specification describes providing to a first user (the initiating user) a plurality of mini-games which that user can use to create a social network hierarchy which permits that first user to connect with and/or communicate directly with, all individuals within that social network hierarchy. Further, it should be noted that this hierarchy can be through dozens, hundreds, thousands, and an infinite number of levels, all of which may be communicated to or with by the initiating user. There is no requirement that this hierarchy be linear, in fact, as represented by the example of a tree, it can contain several branches and limbs all stemming from the initiating user.

In one embodiment, and as described with reference to FIG. 1 but not to be construed as limiting, the first piece of content is a question, in at least one of a plurality of formats. In one embodiment, the gaming site raises a randomly selected question from a pre-defined set of questions. In another embodiment, the user is provided with an option to select a theme for the content (a genre or sub-genre), such as a genre of questions to be answered such as ‘music’, ‘movies’, ‘books’, ‘politics’, current events, among other topics. Alternatively, the genre(s) may be pre-established only by the initiating user. It should be appreciated that the format of the presented question may be any form of communication, including text, graphic, video, image, or other media, form, directed to any subject matter, that, when presented, prompts a receiving person for an answer.

In alternate embodiments, content can be in any format, including text, audio, audio-visual, an image, a video clip, or any other format that may be contemplated by the present specification and as described above.

In step 108, the modified first piece of content or first question is transmitted and presented to a first set of one or more receiving users (also referred to as first player(s) or a second user). When a piece of content is sent, in one embodiment, a “challenge” is created. The term “modified first piece of content” merely refers to the fact that a question, when posed to the initiating player, may be restated in a slightly different way to the second players. Preferably, a database containing the questions and answers have two associated versions of the same question: a first version that that is written in a manner to ask the opinions or thoughts of the initiating user and a second version that is written in a manner to ask a second player to guess the opinions or thoughts of the initiating user.

The first player(s) may be selected by the initiating user, may be randomly selected from the initiating user's list of friends or contacts, and/or may be selected from the initiating user's established followers or fans (members), as indicated within the gaming system. Thus, when content is passed along, the initiating user “initiates” game play. In one embodiment, the first player(s) may be added by the initiating user based upon a request for invitation made by the first player(s).

When any player invites a subsequent player to become part of the social network hierarchy, the subsequent player has the choice of whether to opt-in. While a first player may personally know the initiating user, and responds to the content (and in this example, question) with the knowledge that he will be in that initiating user's network when he engages in the game, this may not be true for subsequent users such as the third player, fourth player, etc. That person may not know the initiating user and may not want to be part of their mini-game community. Thus, in one embodiment, an opt-in is provided. It should be noted herein that each mini-game and its participants form a “social network” or “community” and that these terms may be used interchangeably.

In step 110, the first player(s) is prompted to answer the modified first piece of content or question that is presented to them. If a first player(s) responds to the modified content (or answers the first question) correctly based upon the initiating user's personal response, in step 112, the first player(s) is prompted to input their response to the original content (in one embodiment, the original first question), or a new piece of content (in one embodiment, a second question) which may be selected in the same manner as described above, and in step 114, send that modified first question or modified new content (a second question) to one or more of his or her members (a second set of one or more receiving users, also referred to as second player(s)) to which he or she is connected on one or more social networking sites, so that the second player(s) can answer that question. The second set of one or more receiving users may be selected by the first player(s), may be randomly selected from the first player(s)'s list of friends or contacts, and/or may be selected from the first player(s)'s established followers or fans, as indicated within the gaming system.

In one embodiment, when a player responds to content (or, in one embodiment) answers a question correctly, they earn a unit of virtual currency (or a coin).

Thus, the second player(s) receive(s) the content when the gaming site presents the first player's challenge, as described above in step 114, to be responded to by the second player(s). Alternatively, multiple pieces of additional content (or multiple second questions, in one embodiment) can be selected and sent out to multiple second players from, by, or on behalf of the first player(s). In step 116, the second player(s) is prompted to respond to the content presented to them. Content that is correctly responded to enables the second player responding to the content to forward that content to a second set of one or more receiving users (or third player(s)), in the same manner described above. The goal of the mini-game is to keep the community growing as long as possible, from the initiating user to nth player(s).

In one embodiment, the players are provided an incentive to play by converting the size of the social network hierarchy or community into real money based on predetermined transformation rules. Therefore, as the community grows, the amount of money generated increases.

In one embodiment, if a player responds to content (or answers their question incorrectly), as shown in steps 110 and 118, the player is provided with a choice to either end the gameplay or spend a predetermined amount of virtual or real money to obtain another piece of content (i.e. another question) to keep the gameplay going on. In an embodiment, the virtual money may be obtained by the player by paying a predetermined amount of real money, via an internet payment gateway or via the established payment processes of the social network and mobile platform, to the gaming site.

In most cases the gameplay progresses such that there is pressure on the players to keep the social network or community alive and growing, especially if the mini-game comprises a plurality of correct answers, thereby incentivizing a player who answers incorrectly to spend real money to continue to build the community. The mini-game structure enables players to fundraise for third parties, such as charities, without having to make such donations themselves, which acts as an incentive attracting a large number of players to play the game.

Further, one or more celebrities may choose to be an initiating user on the gaming site whereby the celebrity may initiate a mini-game by choosing a piece of content (i.e. answering a question), thus incentivizing a plurality of players to play the game for having a connection with a celebrity. In an embodiment, the money donated to charity is based upon the amount of virtual money (and therefore, real money) spent by the players of the game on the gaming site. In another embodiment, users that initiate a mini-game can be rewarded with an opportunity to play with a celebrity if their social network or community reaches a predetermined size. In various other embodiments, users can receive other rewards, such as increments of value in the gaming system, based on the size of the community associated with the mini-game(s) that they initiate.

In one optional embodiment, an initiating users plays a mini-game and, in the course of playing the mini-game or after completing the mini-game or creating the challenge, is prompted to add text, image, video, or audio data that is then sent to the subsequent users and displayed either prior to engaging in the challenge, after engaging in the challenge, and/or in response to the user's game play, i.e. dependent upon how the user responds to the challenge, whether the user wins the challenge or whether the user loses the challenge.

Thus, in one embodiment, the initiating user or any subsequent player can upload a text, graphic, image, video, link or other data to the gaming server that may accompany content as they get transmitted from friend to friend. In this manner, the initiating user can get his or her “message” out to the world while still delivering significant value in the form of an interesting game. For example, the player can be presented with the option of sending an image, video or audio clip with an interesting anecdote or a challenge such as “I hope you get this right because there is no way I would have chosen . . . ” The player can even send a private message in the form of an image, video, or audio clip to a selected member of their community.

In one optional embodiment, an initiating user plays a mini-game and a challenge is generated. The challenge is then sent to second users. The second users play the challenge and, after completing the challenge, are presented a plurality of options, including selecting an interface that displays where the second user ranked in terms of successfully or accurately completing the challenge relative to other users, a messaging interface that enables the second user to communication with the initiating user or other users to discuss the challenge, and/or an interface that permits the second user to issue a “challenge to the challenge”. A “challenge to the challenge” is where the second user may a) submit an alternative response to the challenge (as opposed to the one provided by the initiating user); b) optionally provide text in support of the alternative response; c) send a message to the other recipients of the original challenge to prompt the other recipients to vote in support of the alternative response and d) depending upon the extent of support for the alternative response, reevaluate what response qualifies as a winning or losing response to the original challenge. If the alternative response is deemed to be a winning response (instead of a losing response) to the original challenge, all users with the alternative response are deemed to have gotten the challenge correct and are awarded a virtual coin. In one embodiment, the challenge to the challenge must be issued within a predefined period of time or such a challenge may not be issued.

Further, it should be appreciated that the gaming site may not provide a player with the ability to present a communication that will be integrated into the content until that user has obtained a predefined number of other users within the existing or prior communities. For example, an initiating user may only have the ability to upload a communication if he has previously obtained, or currently obtained, at least 25 people in his community. In another example, a subsequent user may only have the ability to upload a communication is he has previously obtained, or currently obtained, at least 50 people in his community. The requirements may be scaled depending upon the level of the user.

In one embodiment, the system presents a visual indication of a community in the form of a tree. In one embodiment, the game as described in the present specification is a viral social network or community that bands people together to build and sustain a series of linked people to form a tree. The objective of the game is to build and sustain the largest tree possible. In one embodiment, users can create trees to raise money for charity.

The tree is presented on the gaming interface and is shown as “growing” (becoming greener and/or taller and/or having more branches) if more content is being sent out, generally by people successfully responding to content such as answering questions and sending the questions onward. The tree is shown as having at least a portion dying if people fail to respond to content, such as by not answering questions or answering questions incorrectly). In another embodiment, all users who are part of the chain or tree are automatically made followers or contacts of the user who initiated the game.

It should be appreciated that, while the game design is being discussed in terms of a tree, it can take the form or shape of any multifaceted and/or multi-tiered (hierarchical) structure, such as a jewel, a pattern, a set of roads, a network of tunnels, roads, paths, or lines, or any other image. Further, it should be appreciated that, while the graphic is being discussed as growing, the growth of the tree or other hierarchical structure could operate to incrementally reveal an underlying image. Therefore, as the structure grows, portions of the image are revealed in direct relationship to the growing community.

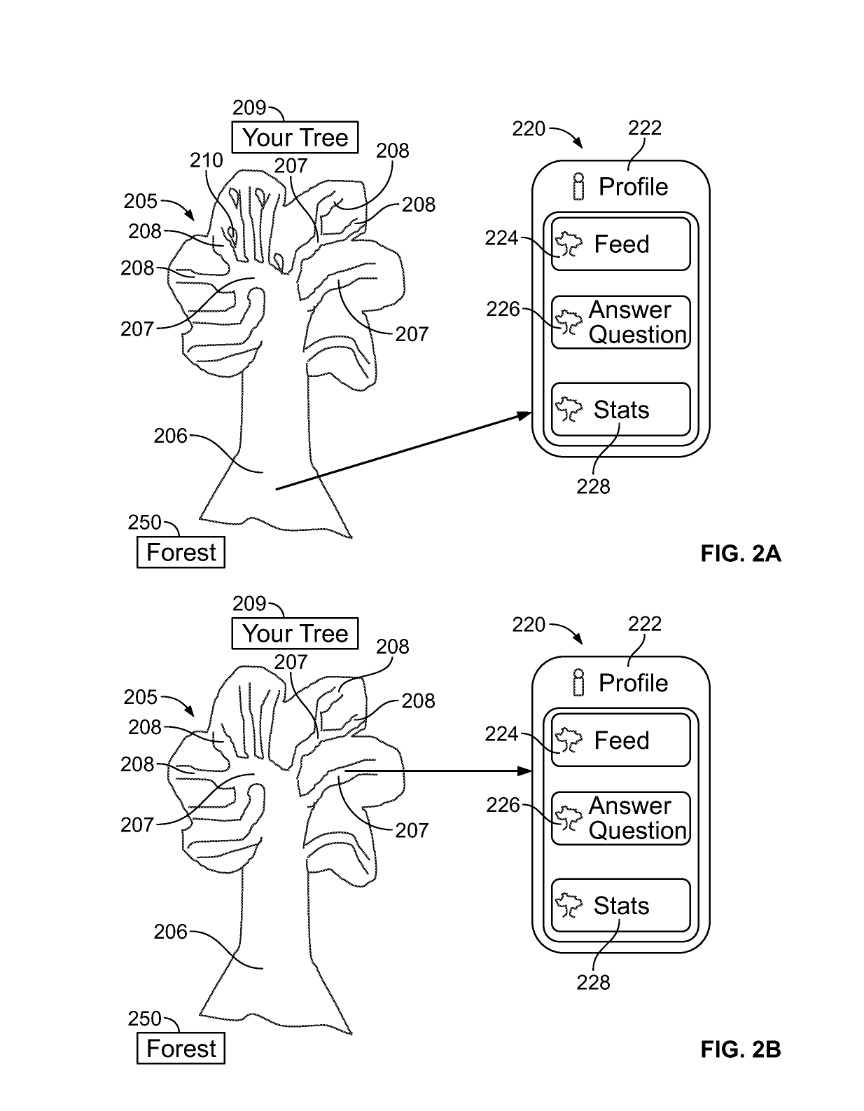

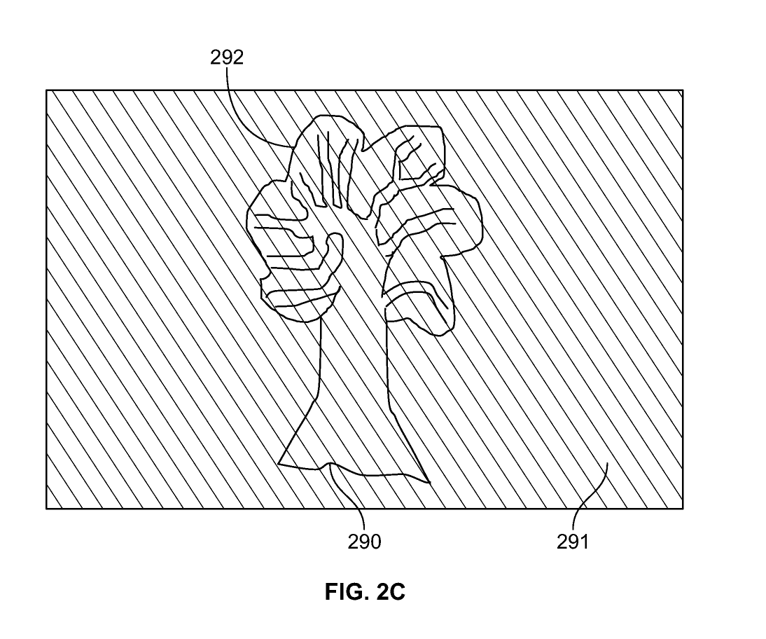

FIGS. 2A and 2B are illustrations of one embodiment of a graphical display for a mini-game where a tree is used as the primary graphic, depicting the initial user trunk and player branches. Referring to FIGS. 2A and 2B simultaneously, the graphical display includes a depiction of a tree 205, a player profile window 220, and a button labeled ‘Forest’ 250. The tree includes a trunk 206 with a number of primary branches 207 emanating therefrom. Each primary branch 207 can have a number of secondary branches 208 emanating from it and each of these branches 208 can have tertiary branches emanating therefrom and so forth. In addition, the trunk, each branch and level of branches can have leaves 210.

The trunk represents the tree owner or initiating user. A friend who was invited to the game by the initiating user or a subsequent user can either be a branch or a leaf. In one embodiment, a friend may be invited by a user where the user selects one or more contacts from a list of contacts. In another embodiment, a person may be invited by the user where the user accepts a request from someone to be part of that tree. A user invites a friend to play the game by sending that friend content in at least one of a plurality of formats, such as a question. Each branch represents a friend who was invited to the game by a user, where that friend correctly responds to the content sent by the user and sends a subsequent format of content to at least one of their friends. Each leaf represents a friend who was invited to the game by a user, where that friend correctly responds to content sent by the user, but chooses not to send subsequent content to at least one contact on their list.

In one embodiment, the trunk 206 represents the initial user who starts the mini-game (the initiating user) responding to a first piece of content (such as by answering a first question in one example) and sending that first piece of content (the first question) to at least one contact (or friend) from their list of contacts. In the description that follows, the mini-game is represented as having content in the form of questions and answers, which is not to be construed as limiting. The content can take any format, as described above. Each primary branch 207 emanating from the trunk 206 represents a friend (first player) who was invited to the game by the initial user where that first player correctly answers the first question sent by the user and sends a subsequent question to at least one of their friends (second player). Each primary leaf 210 represents a friend (first player) who was invited to the game by the initial user, where that first player correctly answers the first question sent by the user, but chooses not to send a subsequent question to at least one contact on their list.

Each secondary branch 208 emanating from primary branch 207 represents a friend (second player) who was invited to the game by the first player where that second player correctly answers a question sent by the first player and sends a subsequent question to at least one of their friends (third player). Each secondary leaf 210 represents a friend (second player) who was invited to the game by the first player, where that second player correctly answers the first question sent by the first player, but chooses not to send a subsequent question to at least one contact on their list (third player). Branches and leaves can continue to be added indefinitely as players continue to invite new friends, thus creating a tree structure with multiple hierarchies.

Above the tree 205 is a title box reading ‘Your Tree’ 209, indicating the tree or trees in which that player is the initiating user or trunk 206. Clicking on the button labeled ‘Forest’ 250 will take the player to a screen showing all the trees in the game that the player is a part of (either in the form of a trunk, branch or leaf). The player can click on any tree that he is a part of to view the players on that tree.

Referring to FIG. 2A, the initial user can click on trunk 206 of tree 205 which brings up the player's profile window 220. Referring to FIG. 2B, a player invited by the initial user has clicked his branch 207 on the tree 205 which brings up the player's profile window 220. An initiating user can click on trunk 206 of any tree of which they are the initiating user to obtain their profile window 220. Similarly, a first player, second player, etc. can click on their branch or leaf on any tree to which they are a member of and obtain that player's profile window.

In various embodiments, the player profile window 220 includes links and buttons for performing various tasks or viewing player and tree information. For example, and by way of example only, the player profile window 220 depicted in FIGS. 2A and 2B includes information about, and a link to, the player's profile 222, a ‘FEED’ button 224, an ‘ANSWER QUESTION’ button 226, and a ‘STATS’ button 228.

In one embodiment, the player's profile link 222 can be used to manipulate and customize the tree profile/settings if that player is the tree owner, or trunk 206. These settings include, but are not limited to the tree name, the tree image (which can be selected from a library of tree images), and the tree's mission statement. In addition, the tree owner can designate the tree as “private” where the tree is unavailable to be searched and player cannot see who else is on the tree. If the private setting is selected, the tree can only be viewed by those who are invited to be part of the tree, either by the initiating user or a subsequent user. In addition, the tree may be set to allow for AutoFeed, so that the tree is fed for each day past a predetermined deadline that a player does not answer a question or “feed the tree”. “Feeding the Tree” is described in greater detail below. In addition, a player can mute the trunk player if they do not want to receive messages from the trunk.

In one embodiment, the player's profile link 222 can be used to manipulate and customize that user's profile/settings. The user profile/settings are used to personalize the game for that specific user. In one embodiment, user profile settings are connected with a social media account, such as Facebook®, Twitter® or Instagram®. In one embodiment, user profile information is extracted directly from the user's Facebook®, Twitter® or Instagram® account. In another embodiment, a user profile menu is provided that allows each player to input their demographic information, such as but not limited to gender, geographic location, etc. In another embodiment, the user profile menu is used to allow people to request connections. In another embodiment, the user profile menu is used to allow a user to designate favorite categories of question categories, which is described in greater detail below. In one embodiment, the user profile settings include multiple privacy filters. Thus, a user can designate their profile as public and thus be invited to play by anyone in the world or any other user that they are connected with on any tree. In addition, a user can allow requests from strangers and/or friends to become branches on that user's tree. In one embodiment, a user can mute the trunk player if they do not want messages from them.

In one embodiment, the ‘FEED’ button 224 allows a player to invite more friends to the game and is described in greater detail below with respect to gaming mechanics. In one embodiment, the ‘ANSWER QUESTION’ button 226 allows a player to respond to content or answer a question. In one embodiment, the ‘STATS’ button 228 allows a player to view statistics relating to the current tree. In one embodiment, in the example where the mini-game is a question and answer game, the statistics include the in-game question history, the number and percentage of questions used, the number and percentage of questions answered, the number and percentage of questions answered correctly, the number and percentage of questions answered incorrectly, and the number of trees the player is playing on. The statistics are, in one embodiment, tailored to each mini-game, representing important information on each game. In one embodiment, the statistics also includes the overall questions statistics for all trees the player is playing on.

In one embodiment, people can browse and search the entire database of trees. The search can be based upon a tree name, a person's name, the person's email address or any other unique identifier. Once a tree is identified, the statistics of the tree and/or tree profile are also presented.

Referring to FIG. 2C, it should be appreciated that, rather than present the image as a tree, there could be a negative presentation where an image 290 is obfuscated under a top opaque layer 291 and then slowly revealed, possibly using a tree and branch 292 or by another form of stripping pixels or lines from the top opaque layer 291. As branches die, a player can choose where on the tree or pattern of stripped pixels or lines he or she wishes to place his or her branch or begin a new chain, thereby targeting what part of the image he or she wishes to reveal.

### Gaming Mechanics

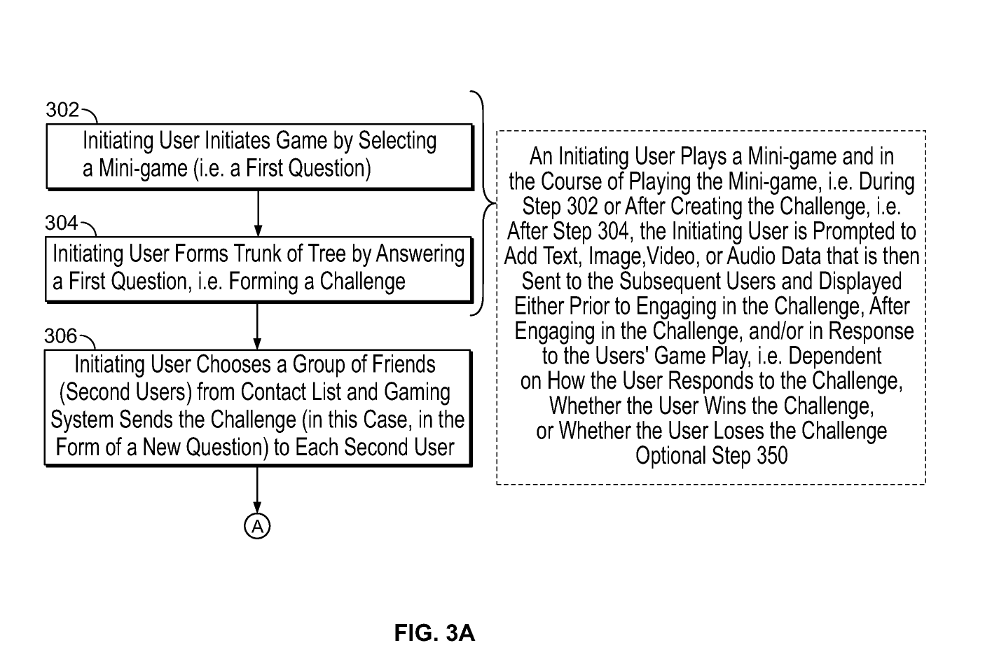

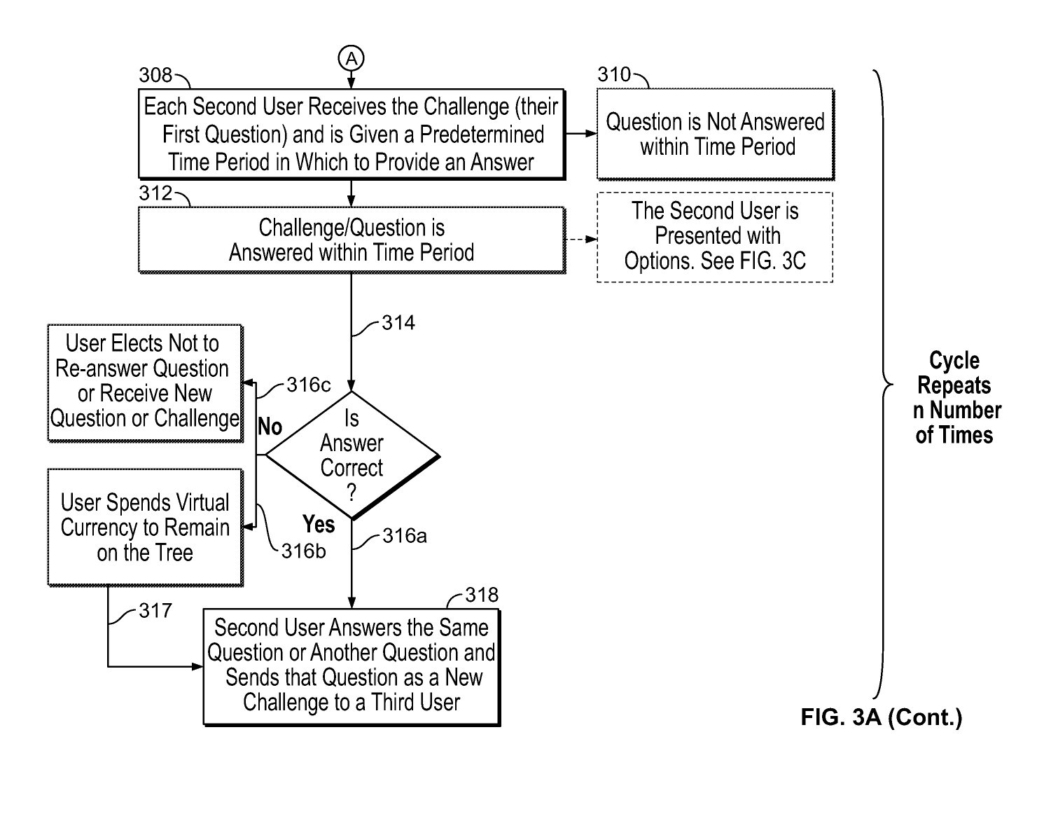

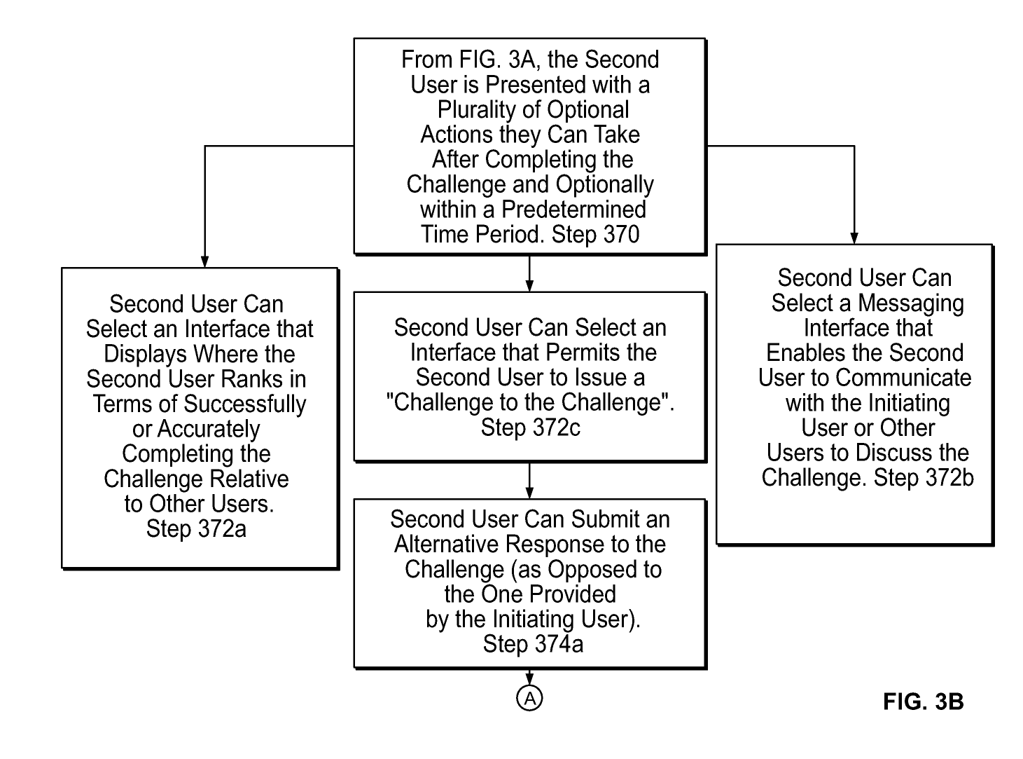

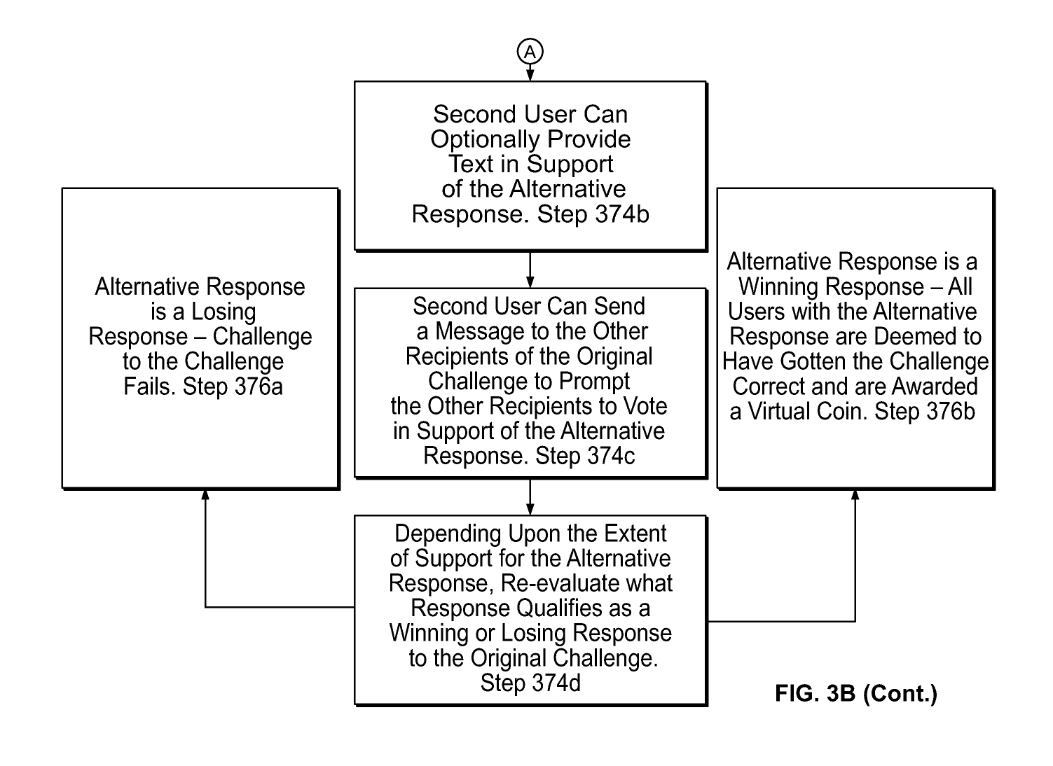

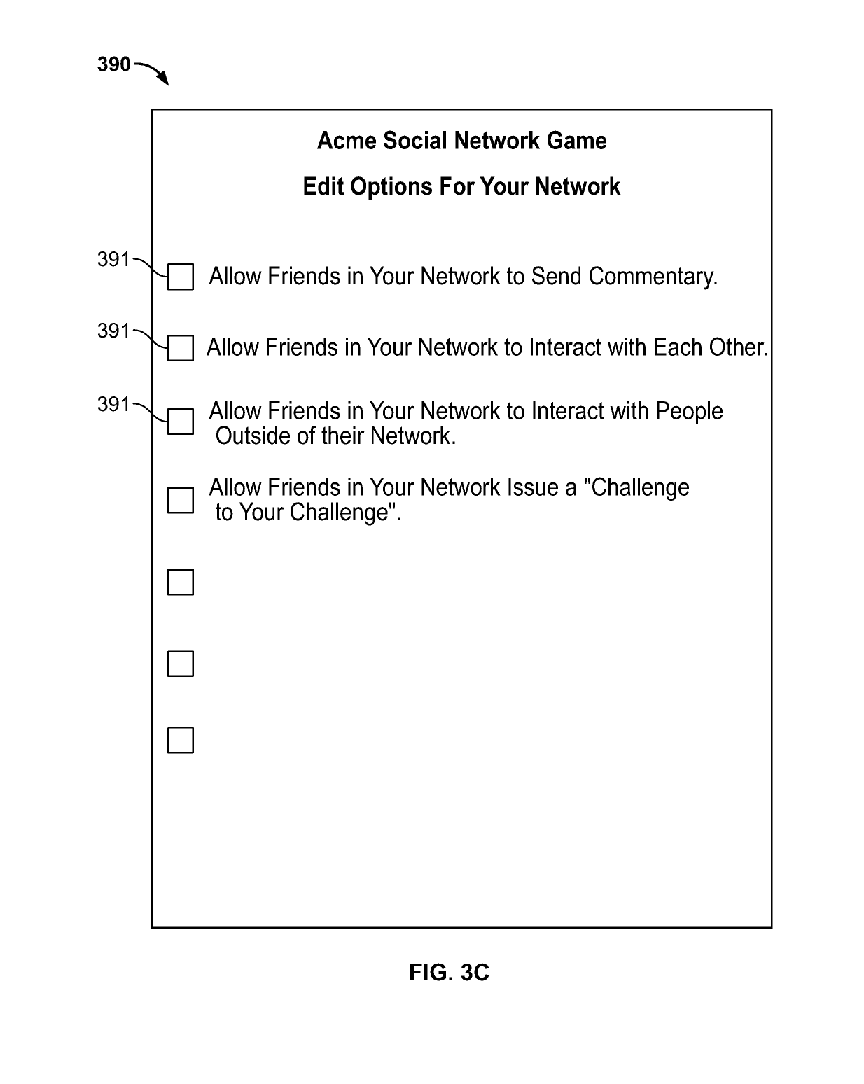

FIG. 3A is a flowchart illustrating the steps involved in an exemplary mini-game, in accordance with one embodiment of the present specification. While FIG. 3A is described with respect to the content being the question and answer type and the format being textual, it should be noted that this is for exemplary purposes and should not be construed as limiting. It should also be noted that each initiating user is initiating a “mini-game” within the gaming application described in the specification, which can be in at least one of a plurality of content types and format types associated with each content type as described below.

In one embodiment, an initiating user is the seed of the tree and can plant that seed to form the trunk. In one embodiment, in step 302, a user initiates a game by selecting a content type, and either manually selecting a format for that content type or having the system randomly select a format within that content type. In one embodiment, and by way of illustration only, in one embodiment, the initiating user selects a question/answer content type. Thus, the user selects a first question or has the system randomly select a question from the database of content in at least one of a plurality of formats.

In one embodiment, the user is able to select a question by spending a predetermined amount of virtual currency. In another embodiment, the first question of a new game is provided by the gaming system free of charge. In step 304, once the initiating user receives the question, the user inputs an answer to that question. In one embodiment, the initiating user simply provides an answer to a question, where the question generally relates to the initiating user, for subsequent users to answer. The content is generally centered on some aspect of a user, such as that user's opinion, ideas, beliefs, desires, wishes, likes, dislikes, abilities, or some other personality, talent or thought of that user. The user initiation, including the steps of receiving and responding to content (such as receiving and answering a question), forms the trunk of the tree, as described above. In one embodiment, the first piece of content (such as a question) is visually represented on the gaming interface as the trunk of a tree.

In optional step 350, an initiating user plays a mini-game and, in the course of playing the mini-game (such as during step 302) or after completing the mini-game or after creating the challenge (such as after step 304), the initiating user is prompted to add text, image, video, or audio data that is then sent to the subsequent users and displayed either prior to engaging in the challenge, after engaging in the challenge, and/or in response to the users' game play, i.e. dependent on how the user responds to the challenge, whether the user wins the challenge or whether the user loses the challenge.

A challenge is created by the initiating user once the question is answered. Play then proceeds to step 306, where the initiating user chooses at least one friend from his contact list (second users), as described above, and the gaming system sends the challenge (or that first question) to the second users. This forms branches and/or leaves on the tree. In one embodiment, the second users and subsequent questions are visually represented as branches and/or leaves off the trunk of a tree. In one embodiment, a branch or a leaf on the tree is formed when the question is sent to the second user and the status of the branch or leaf is determined based upon a correct/incorrect answer. Alternatively, a second user becomes a leaf on the tree with a correct answer and becomes a branch on the tree if they decide to pass the same challenge/question or a new challenge/question along to at least one friend in their group of friends, or a third user.

When any user invites a subsequent user to become part of the tree, the subsequent user has the choice of whether to opt-in. While a second user may personally know the trunk, and answers the trunks question with the knowledge that he will be in trunk's network when he engages in the game, this may not be true for the third user, fourth user, etc. A third user, fourth user, etc. may not know the trunk and may not want to be in the trunk's community. Thus, in one embodiment, an opt-in is provided.

At step 308, each second user receives the challenge (in this example, in the form of a question) is given a predetermined time period for the second user(s) to answer the question as it relates to the initiating user.

If, at step 310, the challenge is not responded to or the question is not answered within the time period, the branch or leaf is never formed and the second user is never part of the tree. Alternatively, if a question is not answered, the tree branch or leaf ‘dies off’ and is removed from the tree.

If, at step 312, the challenge is responded to or the question is answered within the specified time period, the game system determines, in step 314, if the answer is correct or incorrect. If the answer is correct, the second user earns a unit of virtual currency and is given the opportunity, in step 316a, to pass along the same challenge or a different challenge (i.e. the same question or a different question), answered as it pertains to their opinion, ideas, beliefs, desires, wishes, likes, dislikes, abilities, or some other personality, talent or thought, along to at least one friend in their group of friends, or a third user. If the second user decides not to pass the challenge/question along to new friends, or third users, they remain a leaf. If the second user decides to pass the challenge/question along to third users, in step 318, they become a branch. Alternatively, if the answer is correct, in one embodiment, the tree branch remains “alive”. In one embodiment, the unit of virtual currency is a coin.

If the answer is incorrect, the second user, at step 316b, is presented with an opportunity to spend a unit of virtual currency, such as a coin, to remain on the tree. In spending a coin, play proceeds, in step 317, as if the second user responded to the challenge (or answered the question correctly) and the second user is given the opportunity, in step 318, to pass along the same question or a different question along to at least one friend in their group of friends, or a third user. If the second user decides not to pass the challenge/question along to new friends, or third users, they remain a leaf. If the second user decides to pass the challenge/question along to third users, they become a branch. Alternatively, if the answer is correct, in one embodiment, the tree branch remains “alive”.

Alternatively, the second user may spend a unit of virtual currency, such as a coin to re-answer the same challenge or receive a new challenge (in this example, in the form of a question or new question). If the player re-answers the original question or answers the new question incorrectly, he can again spend virtual currency to re-answer the current question or receive another new question. Once the question is answered correctly, play proceeds to step 318, as described above.

After an incorrect answer, the player, at step 316c, also has the option to not spend virtual currency to re-answer the question or receive a new question. If the player does not elect to try again or receive a new question, the branch or leaf is never formed and the second user is never part of the tree. Alternatively, if a question is not answered, the tree branch or leaf ‘dies off’ and is removed from the tree.

At step 318, game play continues on in the same manner starting again with step 306. The player who answered the question correctly chooses a group of friends from his contact list who receive a new question from the gaming system. Play continues on indefinitely from steps 306 through 318, each time adding new leaves or branches to the tree.

In one embodiment, each contact receives a social network message, such as an email or text message or notification that they have a challenge to respond to. The contact can click on the notification to be taken directly to the gaming service to answer the question. If the contact does not already have the gaming platform installed on their device, they will be prompted to do so by the notification. In one embodiment, the trunk, via the gaming system, sends periodic reminders in the form of social network messages, to each contact to remind them to answer the question.

In one embodiment, the gaming mechanics are reinforced by preventing users from engaging in certain activities. For example, in any of the embodiments disclosed herein, a second user connected to a first user is not able to receive a challenge from any other user, except the first user. Therefore, a “branch” or “leaf” connected to a “limb” will only be able to receive challenges from that limb and not from any other limb. In another embodiment, the second user is not prohibited from receiving a challenge from any other user.

In another embodiment where the first user issues challenges to a second user who, in turn, issues challenges to a third user, the first user is not able to receive a challenge from the second user and/or the third user (i.e. reverse the flow of the challenges). In another embodiment where the first user issues challenges to a second user who, in turn, issues challenges to a third user, the third user is not able to receive a challenge directly from the first user, but rather, only receive a challenge from the second user.

In one embodiment, each player can view his or her statistics or the statistics of other players on the tree, including, but not limited to, number and percentage of questions received, number and percentage of questions answered, number and percentage of questions answered correctly, number and percentage of questions answered incorrectly, statistics related to all format and content types, amount of virtual currency earned, and amount of virtual currency spent. In one embodiment, this is done via a Statistics Browser. In one embodiment, each player can view all the trees in the game. In an alternate embodiment, and as described below, a player can only view statistics of a limited number of players on the tree, depending upon their relationship to the other players on the tree.

In another embodiment, trunks and/or branches are able to view the results of all content that is sent out. Thus, trunks and branches can see which members of the community lateral to and below them in the social network hierarchy provided which response to which content sent by them, what the response was, and whether the response was right or wrong. As mentioned above, a response can be of any form, including an answer to a question, a time to beat, a word, or any other challenge.

In a specific embodiment, where the content is question/answer type, trunks and/or branches are able to view the results of all of the questions that are sent out.

In one embodiment, a friend can challenge another friend to determine who knows the trunk the best. In one embodiment, the players can bet coins into the challenge. In another embodiment, a person can get closer to the trunk by winning challenges. Thus, a tertiary branch can work their way to becoming a secondary branch and so forth.

In another embodiment, a player can challenge the trunk to “uproot” the tree and take it over. Thus, a branch can challenge the trunk to a “root challenge” so that the tree can be “replanted” within their forest of trees.

In yet another embodiment, tree communities can challenge each other and all members can participate in these challenges. Thus, if a tree community wins a challenge, it is possible to “uproot” or “kill” the tree. In another embodiment, it is possible to take over the tree and use that tree as a host for food packets. Thus, once a tree is taken over, the conquered tree's members respond to content to feed the invasive tree.

In an optional embodiment, and as shown in FIG. 3A, an initiating user plays a mini-game, a challenge is generated, and the challenge is sent to second users. The second users play the challenge and, after completing the challenge, in step 314, the second users, in optional step 370 and shown in FIG. 3B, are presented a plurality of options from which the second user can select at least one, and even a plurality of options.

In one embodiment, in step 372a, the second user can select an interface that displays where the second user ranked in terms of successfully or accurately completing the challenge relative to other users. In another embodiment, in step 372b, the second user can select a messaging interface that enables the second user to communicate with the initiating user or other users to discuss the challenge.

In another embodiment, in step 372c, the second user can select an interface that permits the second user to issue a “challenge to the challenge”. In one embodiment, if a “challenge to the challenge” option is selected in step 372c, the second user, in step 374a can submit an alternative response to the challenge (as opposed to the one provided by the initiating user). In step 374b, the second user can optionally provide text in support of the alternative response. In step 374c, the second user can send a message to the other recipients of the original challenge to prompt the other recipients to vote in support of the alternative response. In step 374d, the second user can, depending upon the extent of support for the alternative response, reevaluate what response qualifies as a winning or losing response to the original challenge. In the alternative response is a losing response, the challenge to the challenge fails and in step 376a, game play reverts to the original challenge. If the alternative response is deemed to be a winning response (instead of a losing response) to the original challenge, in step 376b, all users with the alternative response are deemed to have gotten the challenge correct and are awarded a virtual coin. In one embodiment, the challenge to the challenge must be issued within a predefined period of time or such a challenge may not be issued.

In one embodiment, and as shown in FIG. 3C, the initiating user can personalize certain features of the game so that the initiating user has control over the scope and extent of interactivity and game play in his or her social network hierarchy. For example, some optional features can be selective deployed or not deployed, depending upon the level of interactivity the initiating user wants their community to have with the gaming application. As shown in FIG. 3C, an interface 390 is provided to allow the initiating user to select or deselect certain optional features by use of checkboxes 391. In one embodiment, the non-initiating user is a member of the initiating user's community or social network hierarchy. Some key options include, but are not limited to the ability to let or require non-initiating users to send supporting commentary in the form of images, text, audio and/or video; the ability to let or require non-initiating users to comment on a challenge with other users—this includes the ability to allow friends within the community or social network hierarchy interact with each other; the ability to let (or require) non-initiating users to send messages to users who are not directly connected to the non-initiating user (this includes the ability to allow friends in the initiating user's network communicate with and interact with other people in the network, even if they are not directly connected to that user); the ability to let non-initiating users issue a “challenge to the challenge” and the ability to let (or require) non-initiating users to send supporting commentary in the form of images, text video and/or audio.

### Content Types, Format Types, Themes and Content Creation Tools

In one embodiment, a mini-game is any game within the gaming application of the present specification. For purposes of this application, a mini-game is any digital content which can be interacted with by a first user to create a challenge for a plurality of second users. A mini-game differs from a conventional game in that it typically only includes a single level, a single life, and/or a single interaction screen and is designed to obtain an output which is reformatted as a challenge to a plurality of second users. The term mini-game may include abbreviated versions of conventional games as described above.

Thus, a mini-game is made of content that has a certain format. Each content type consists of at least one of several “formats”, including but not limited to text, audio, pictorial, or video formats. Further, each content type has several themes, which are essentially genres or sub-genres. In one example, the “content” is represented by a question/answer type mini-game in a textual “format” having a theme based upon a “Would you ever?” scenario. The question is passed along among the “initiating player” and “subsequent players”. In another embodiment, the format representative of content includes a series of images that are passed along among the “initiating player” and “subsequent players”. Each piece of content represents “food” for the community to feed and nurture trees. An “initiating user” can select from many different content types in at least one of a particular format, and in at least one of a particular theme through which their tree is nurtured and for subsequent players to engage in. Different types of content, formats and themes are described below. While throughout this text, examples are provided with respect to “questions”, it should be noted that this is for illustrative and descriptive purposes only and that any content type of any format may be used with the present invention as described in the present specification.

In one embodiment, each content type may be modified to include both free and paid versions. In one embodiment, the paid versions may offer different gaming attributes.

In one embodiment, content types may be sourced from third party sites. In one embodiment, third party websites may be used to generate data for each content type in a plurality of formats and themes. In one embodiment, the present specification contemplates scraping the most popular questions of the day from a third party website and creating answers to these questions.

In another embodiment, any entity can customize content for their own purposes. For example, an automobile manufacturer may create content based on a custom car-related challenge or a cereal company may create content based on a cereal brand related challenge and use that content to create challenges as use them as viral marketing tools.

In one embodiment, content types may be ranked at different levels. For example, in one embodiment, a particular content type may only be accessible to a player that pays for access. In another embodiment, a particular content type may only be accessible to a player that has achieved a certain level within the game.

### 1) Question/Answer Based Content

In one embodiment, the gaming system includes a database of questions relating to a variety of genres. Although the term “question” is employed, the “question” may be in any one of a plurality of communication formats, including text, graphic, video, image, or other media form, directed to any subject matter, that, when presented, prompts a receiving person for an answer. The question may be one of, but not limited to, a multiple choice text question; a true/false text question; a multiple choice graphic or video question; a true/false graphic or video question, etc. In one embodiment, the question is designed such that it reveals information indicative of the person answering the question, i.e. an opinion, desire, belief, want, experience, preference, etc. In one embodiment, the question is able to support graphic image or video capability. Further, questions may also be gender-specific.

In one embodiment, free question-type content is offered. This is the standard option. In another embodiment, paid question-type content is offered. This may include, but is not limited to, a celebrity version (such as a multiple choice question created by a celebrity).

a) Survey Question BasedContent

In one embodiment, the question is a survey question. For example, the question may ask “Out of 100 people surveyed, what movie do people like the most?” The possible answer choices are presented as multiple choices where the user may select one answer from a plurality of possible answers. For example, the answer choices may be a) Titanic, b) Godfather, c) Casablanca, and d) One Flew Over the Cuckoos Nest.

b) Opinion Question Based Content

In one embodiment, the question is an opinion question. For example, the question may ask “What does your friend Joe think is the best cop buddy movie of all time?” Similarly, possible answer choices may be presented as multiple choices where the user may select one answer from a plurality of possible answers. For example, the answer choices may be a) Titanic, b) Godfather, c) Casablanca, and d) One Flew Over the Cuckoos Nest.

c) Opinion-Survey Question Based Content

In one embodiment, the question is an opinion-survey question. For example, a question may ask “From the list below, what do you think is the best movie?” If the answer matches the most chosen, then the player gets that question right. Similarly, possible answer choices may be presented as multiple choices where the user may select one answer from a plurality of possible answers. In one embodiment, for this type of question, the answer that the player gives is included in the pool of answers which grows the survey samples. Another question that may be asked, for example, is “What would you do for $1,000,000?” Similarly, possible answer choices may be presented as multiple choices where the user may select one answer from a plurality of possible answers.

d) Factual Question Based Content

In one embodiment, the questions are factual (pertaining to that user), such as what city the user grew up in, what the user's first car was, etc. The user pre-answers these questions, which are stored in a questions bank within the questions database for that user, for later use by the system when a question needs to automatically be sent downstream.

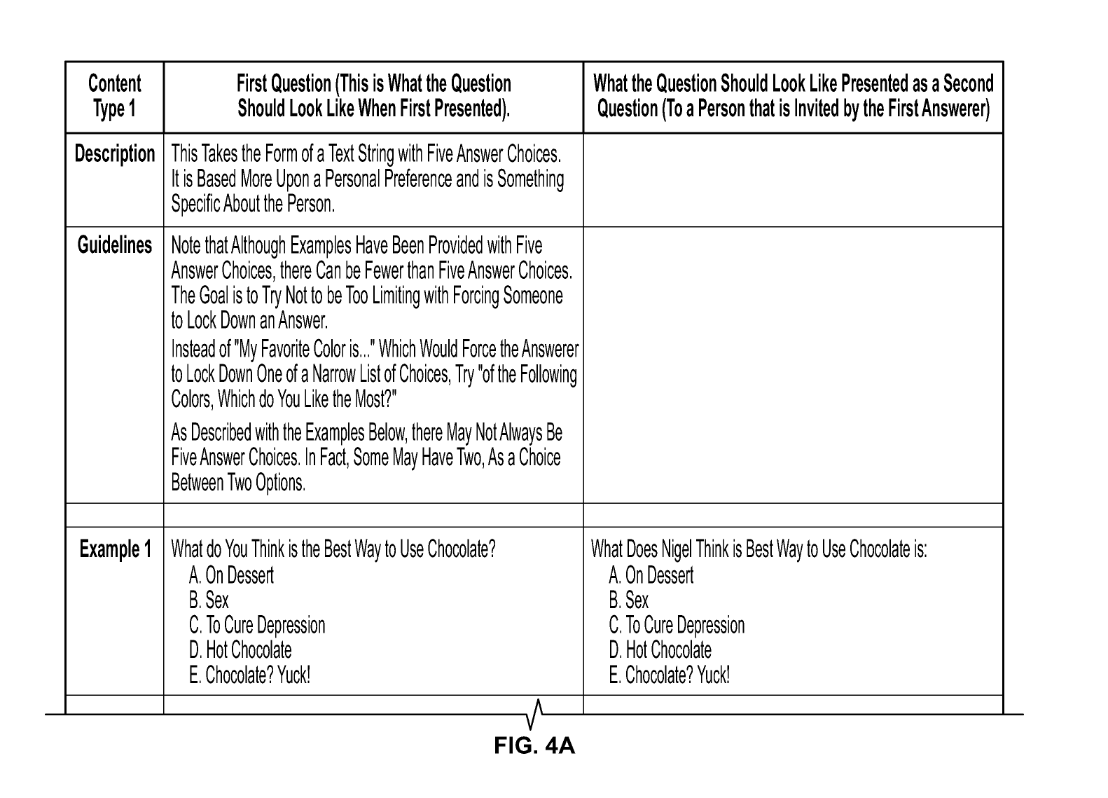

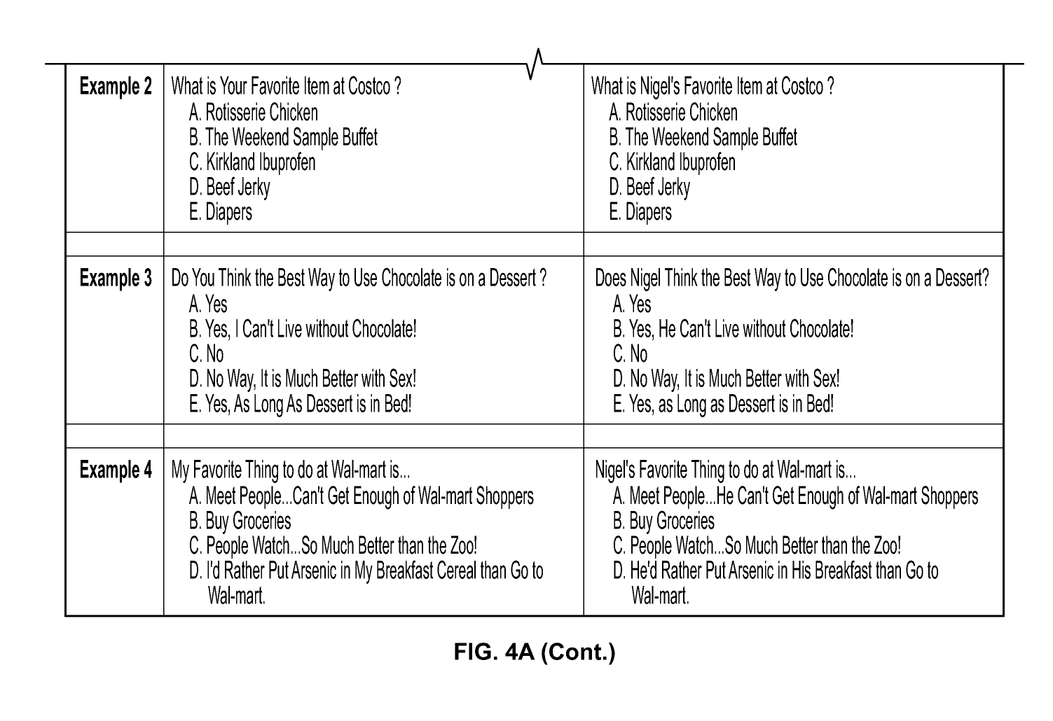

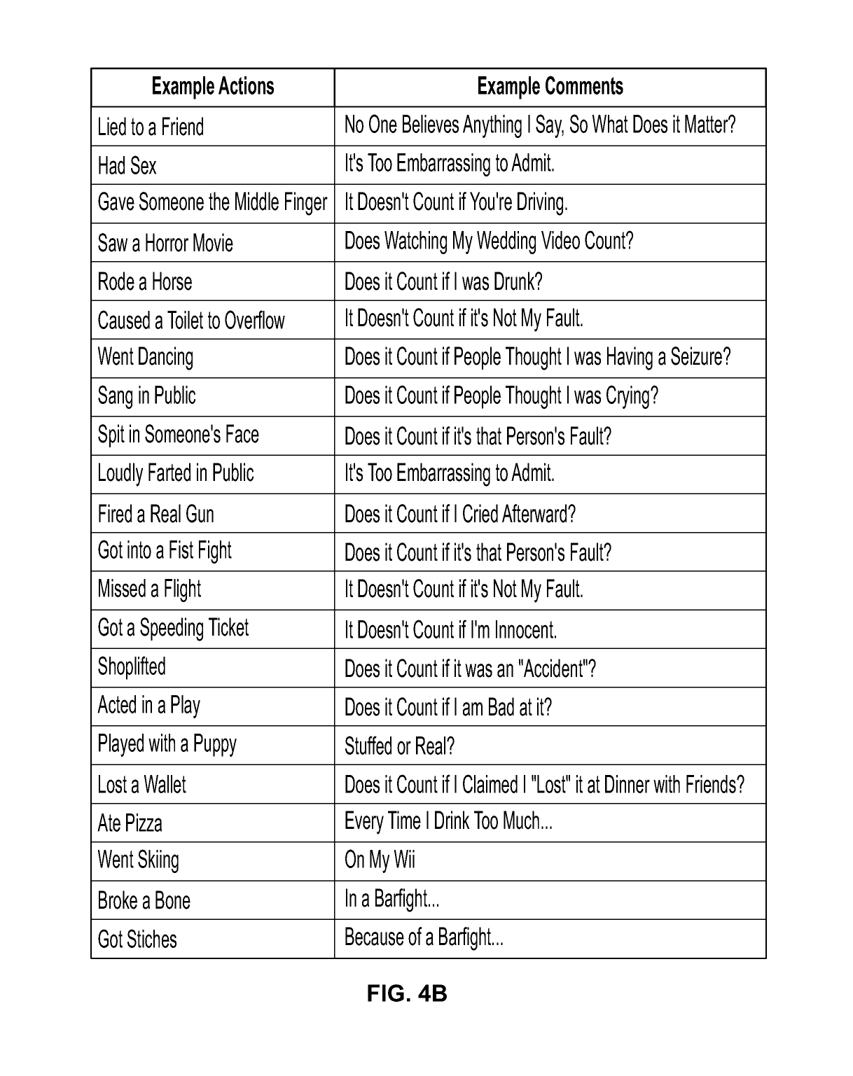

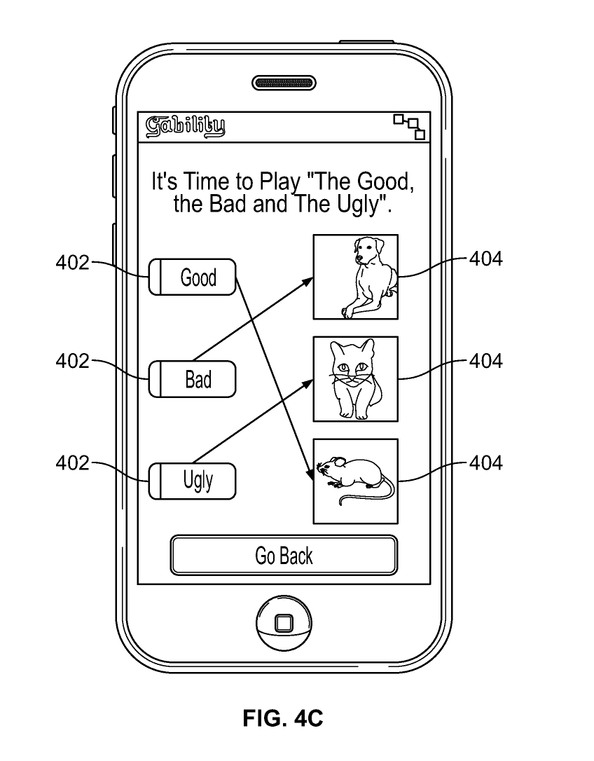

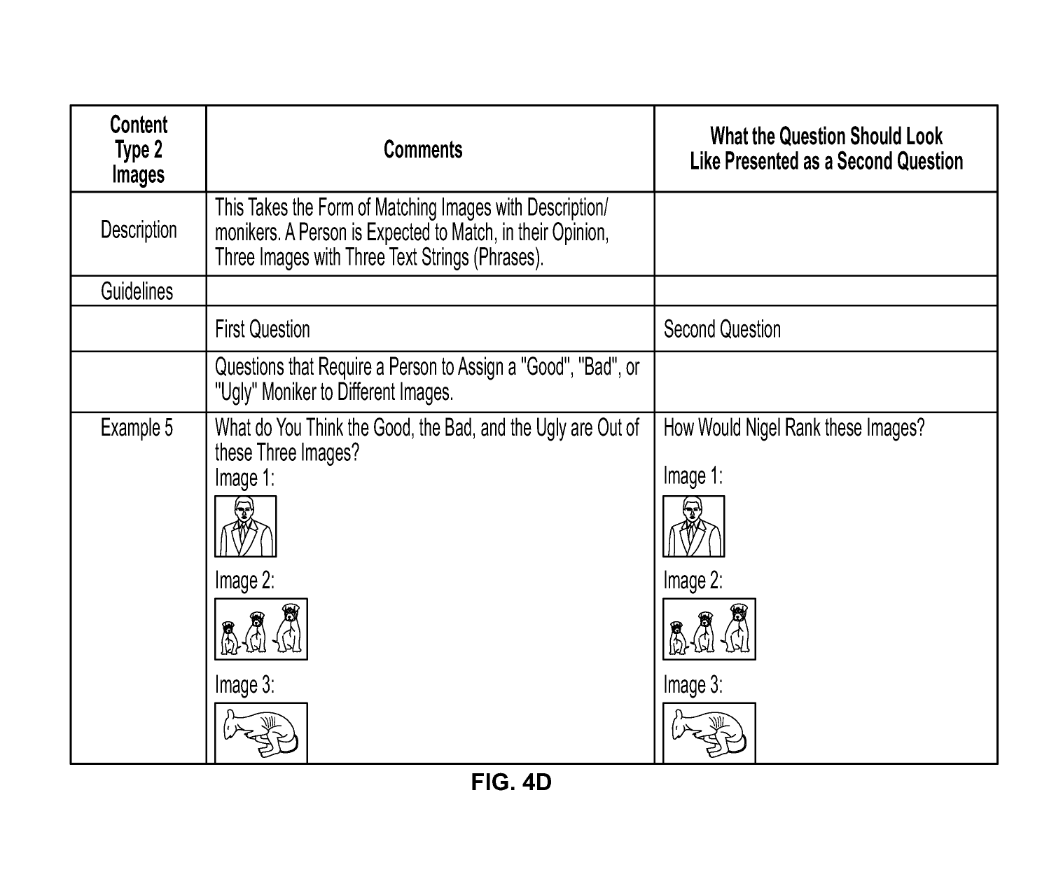

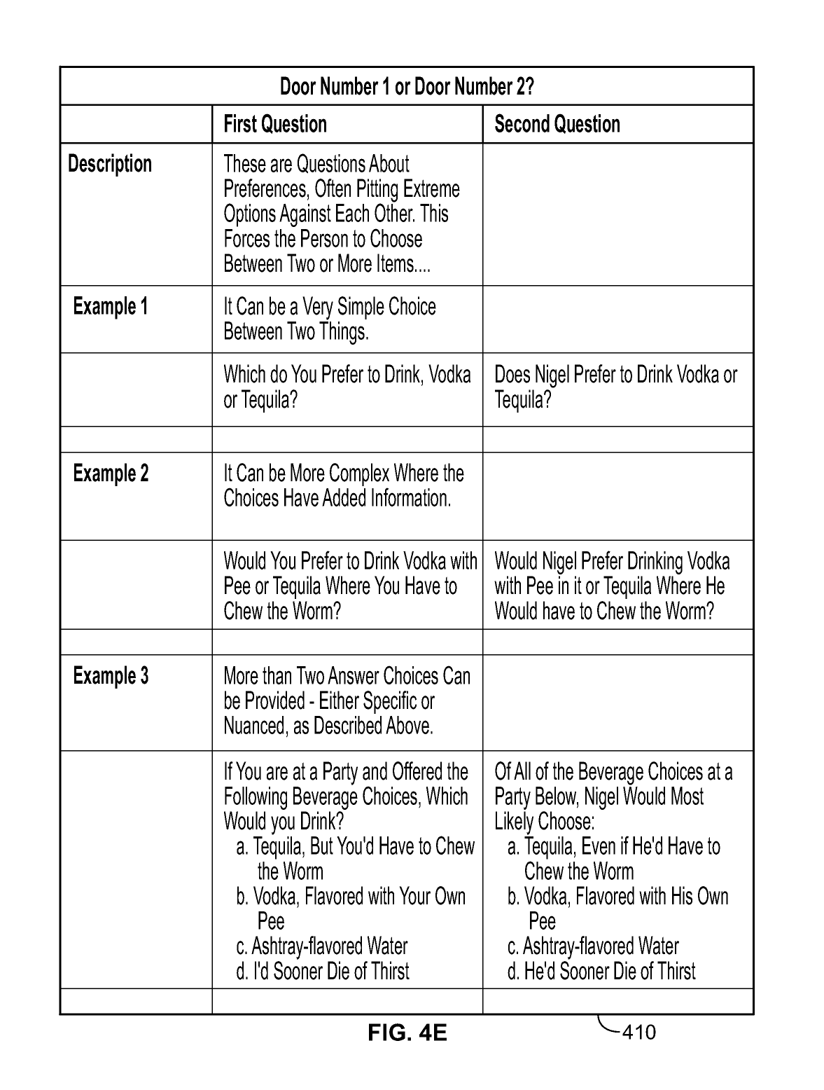

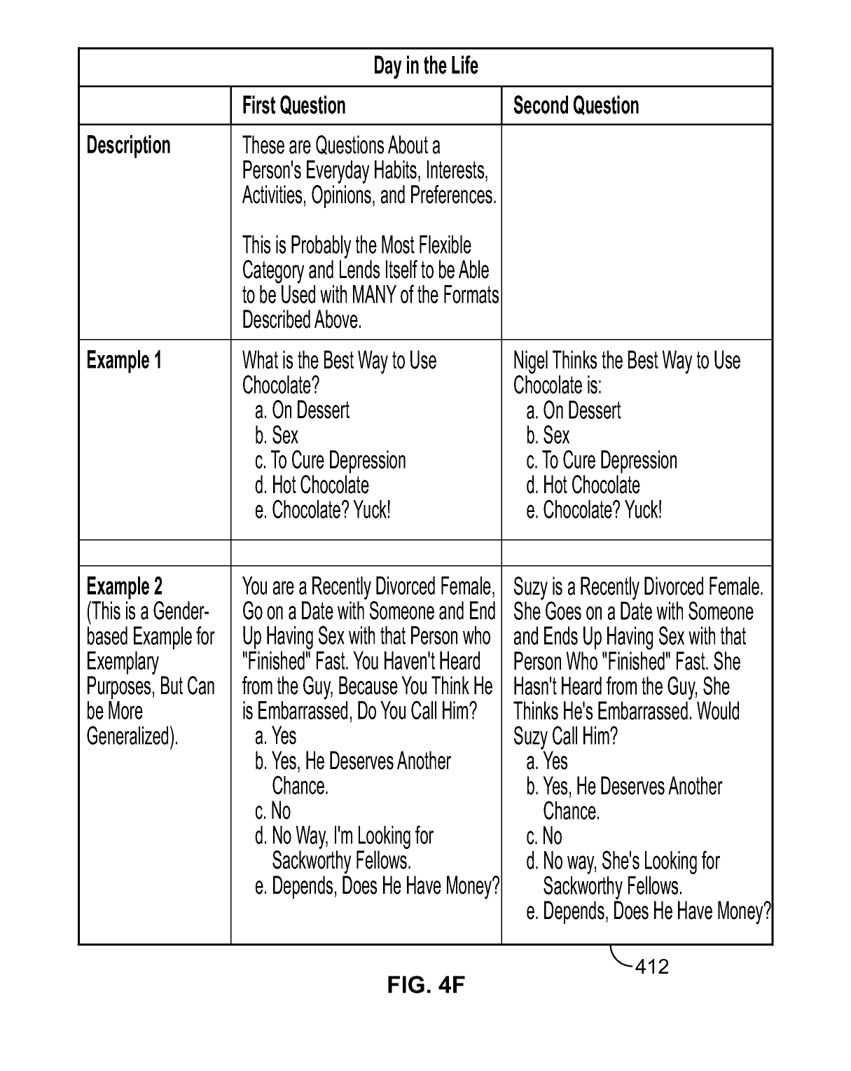

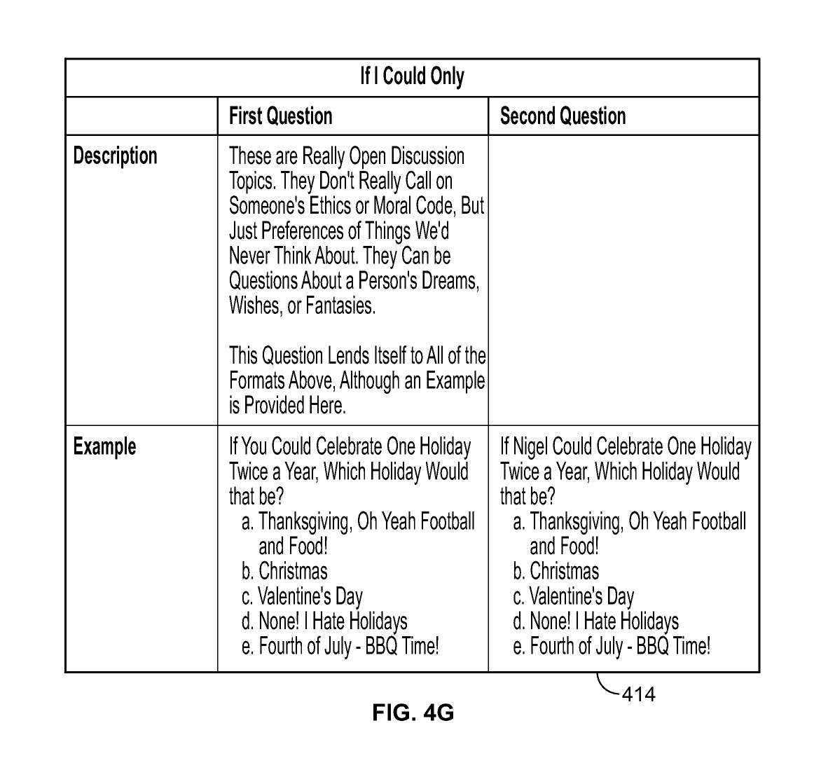

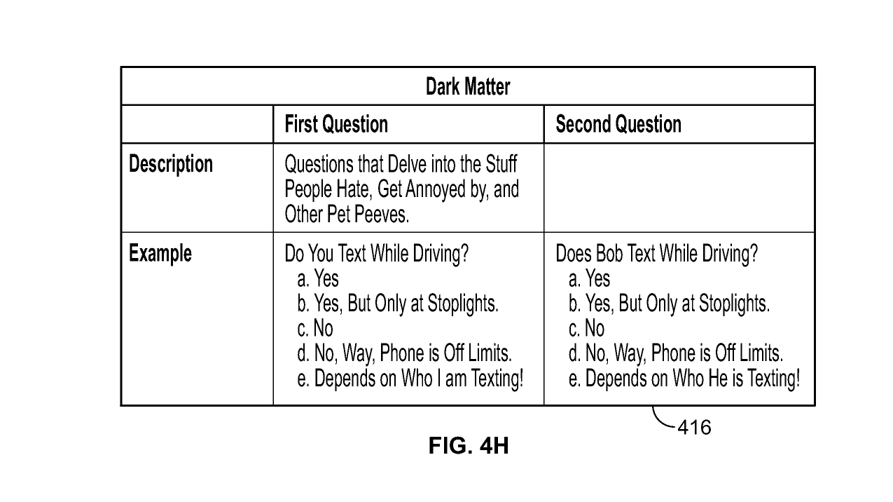

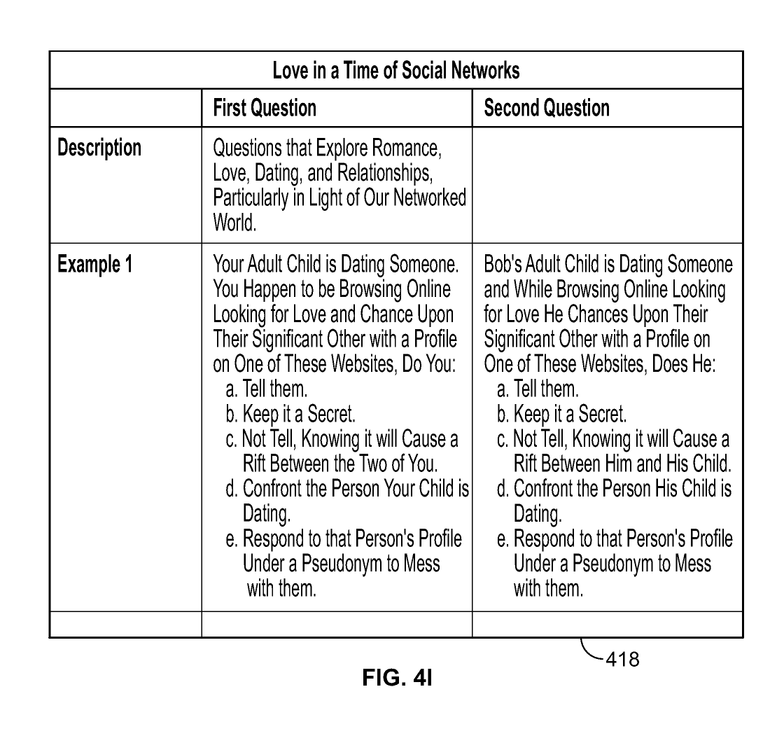

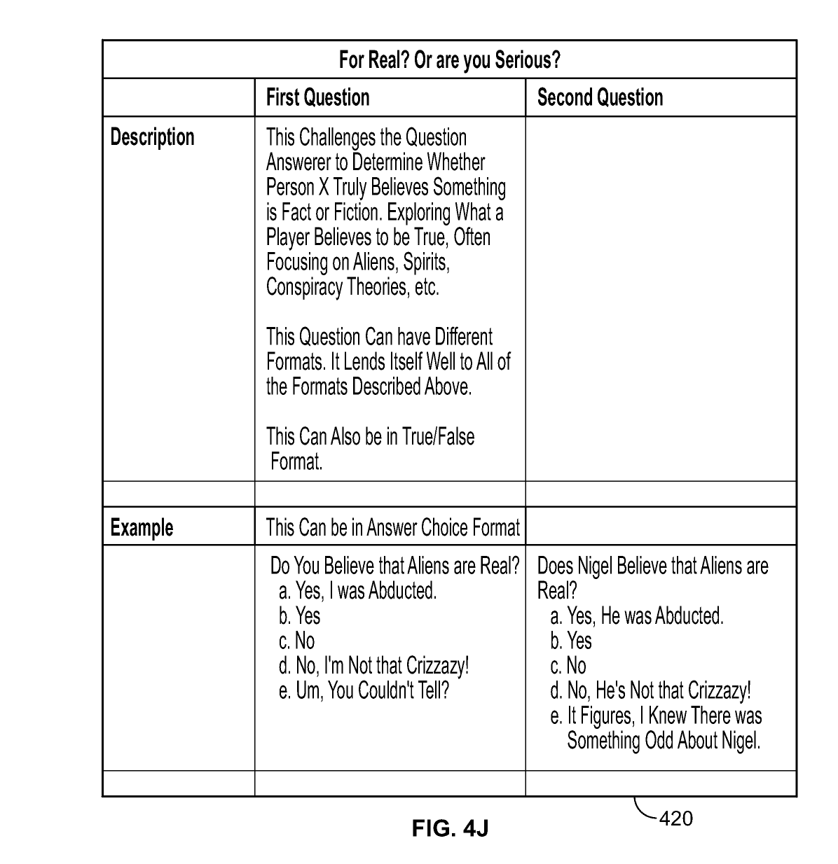

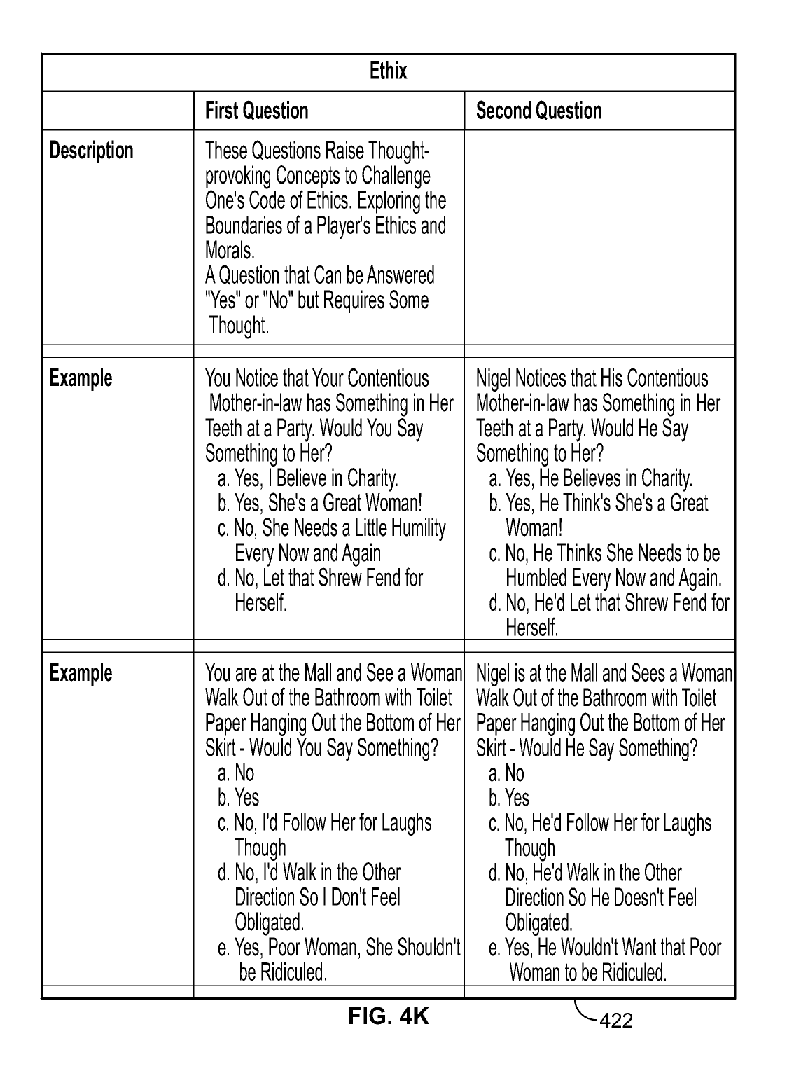

FIG. 4A is a table representing different embodiments of question/answer content types of a mini-game that may be played in accordance with the gaming application of the present specification. These include multiple choice question content types, true-false question content types, and statements from which a user can select the best answer that pertains to them.

e) Structured Question Based Content

In one embodiment, the question content is in a “structured”, yet customizable form. For example, in one embodiment, the question is a “Last Time Question” and is asked in the following customizable, yet structured form: “The last time [Initiating User Name] [Action] was within [Time Frame] and/or [Evasive/Interesting Comment]”. The Initiating User Name is prefilled based upon the tree owner's screen name. The action and time frame are selected from a predetermined answer base. In one embodiment, the time frame may include any incremental time range, including but not limited to a selection of never, 1 day, 2 days, a week, a month, a year, five years, a decade, 10-20 years, 20-30 years, 30+ years and any other time period. In one embodiment, the evasive/interesting comment corresponds to an action and only one choice is available. In one embodiment, the evasive/interesting comment corresponds to an action and many choices are available. In another embodiment, the evasive/interesting comment can be created from scratch by the trunk (initiating user). An example of actions and comments are presented in the table of FIG. 4B.

For example, an initiating user may be asked: When was the last time you {action}? The user can then select an action from a selectable list, such as a drop-down menu. In this example, the user selects “got into a first fight”. The initiating user may then answer the question they created as follows, using the game interface: The last time Joe got into a first fight was within five years. In another example, an initiating user may answer as follows (using a comment instead of a time frame): The last time Joe got into a first fight was “Does it count if it's that person's fault? The system then forms this question and answer into a question for Joe, the initiating user, to send to at least one friend in the following structure: “When was the last time Joe got into a first fight? The answer choices can then be presented as a multiple choice question in one embodiment.

f) Custom Question Based Content

In one embodiment, a trunk (initiating user) can create a custom question. In one embodiment, a questions tool is provided for selecting question options. Using the question tool, a user can create a custom question. In addition, a user may be able to set the status of a question to active or inactive, depending upon whether they want that question to be asked to members of their tree or their community. Further, the questions tool may have category check boxes in the database so that a user can indicate which question categories they want to use.

In one embodiment, a questions database is used to track which question is posed to which person, whether a trunk, branch or leaf such that the database avoids the same question being sent to the same person more than once.

g) Poll Question Based Content

In another embodiment, the trunk or tree owner can send out a poll to everyone on the tree. After a predetermined time period, the people with the most popular answer can earn a credit or reward, which, in one embodiment, is a coin.

### 2) Image-Based Content

In one embodiment, a player is asked to match images with descriptions/monikers. A player is expected to match, in their opinion, three images with three text strings (phrases).

In one embodiment, standard picture choices are offered as a free content option. In another embodiment, a paid version may include a special “picture” catalog, for example, a catalog of art that a particular celebrity may like or hate.

a) The Good, The Bad, The Ugly Themed Content

For example, as shown in FIGS. 4C and 4D, one possible game can be described as “The Good, The Bad, and the Ugly”, where a player is instructed to match what the person sending the question considers the good, the bad, and the ugly 402 within a set of at least three images 404.

### 3) Puzzle Based Content

In one embodiment, content is in the form of a puzzle in which players are pitted against each other to beat other players' time, score, and the like.

a) Arcade Type

In one embodiment, the puzzle may be an arcade type game.

b) Geometric Challenge Type

In another embodiment, an actual game can be sent along. For example, the game can be structured so that players had 30 seconds to clear a block of blocks. Alternatively, they may have to clear 100 blocks of the total block of the tree. Still alternatively, the game can be structured so that the block had to be cleared by everyone on the tree for the tree (or some percent of branches) to survive.

c) Hole-In-One

In one embodiment, the mini-game content may be simple, such as a hole-in-one. For example, the challenge may ask the subsequent user to beat the time it took for the player that sent them the question to get a hole in one.

4) Song-Based Content

In another embodiment, players can challenge each other based on their knowledge of music. For example, subsequent players have to beat the time in which the previous player(s) guessed the song name. In one embodiment, a clip of the song is played and when the player is ready to answer, the player presses a button and are presented with “X” number of options. In another embodiment, they are presented with an interface in which to type the answer. Once an answer is input, the time clock is stopped. In an optional embodiment, the song can be played again and the time clock resumes ticking to count all time spent on guessing the song. The songs can be presented in a plurality of formats, including audio and video. In addition, the songs can have a plurality of themes, such as but not limited to classic rock, 80's, 90's, Beatles, etc.

5) Video-Based Content

In one embodiment, certain mini-games include video-based feeds. In one embodiment, video clips are presented and a player is prompted to guess what happens in the remainder of the video. For example, the video clip may be of a ball being thrown towards a person and the player is supposed to guess where that ball hits the person i.e. head, gut, or groin). After the player inputs a guess, the remainder of the video plays and the user can see if he or she was right. This same video clip is then sent to subsequent players to see if they get it right. In one embodiment, the video content creator is incentivized because the video clip then becomes viral as it is integrated into a game.

In one embodiment, each content type or mini-game has a simple rating scale so that players of the game can rate the mini-game. Further a player can indicate whether they like or dislike a mini-game. In one embodiment, the gaming interface is programmable such that it can ensure that mini-games do not repeat across trees to the same player so that the player will only play each mini-game or piece of content within a tree once.

In one embodiment, after responding to content, a player is able to send a comment back to the person that sent them that content.

6) Themes

In another embodiment, content types may also include questions having predefined genres or themes, such as, but not limited to, board game type questions; trivia type questions; dating game type questions; ethics type questions; brackets/rankings types; hangman types; betting types, in which players are pitted against one another; fill in the story types, where players are asked to fill in part of a story based upon the word type; the telephone game type where a story is created as it is passed along, and various other content types.

For example, FIG. 4E is a table 410 showing one embodiment of a mini-game in a question content type that may be played in accordance with the gaming application of the present specification, showing exemplary preference-themed questions. For example, the questions offer a choice between two options or a multiple choice format, asking the user a preference, often pitting extreme options against each other. These questions force a user to choose between one or more items.

For example, FIG. 4F is a table 412 showing one embodiment of a mini-game in a question content type that may be played in accordance with the gaming application of the present specification, showing exemplary lifestyle themed questions. The questions in this format are about a person's everyday habits, interests, activities, opinions, and preferences.

For example, FIG. 4G is a table 414 showing one embodiment of a mini-game in a question content type that may be played in accordance with the gaming application of the present specification, showing exemplary questions with a speculative theme. The questions in this content type are open discussion topics. The questions don't really speak to a person's ethics or moral code, but just preferences of things that a person may never think about. They can be questions about a person's dreams, wishes or fantasies.

For example, FIG. 4H is a table 416 showing one embodiment of a mini-game in a question content type that may be played in accordance with the gaming application of the present specification, showing exemplary dark matter, possibly macabre themed questions. They delve into the stuff that people hate, get annoyed by, and other pet peeves.

For example, FIG. 4I is a table 418 showing one embodiment of a mini-game in a question content type that may be played in accordance with the gaming application of the present specification, showing exemplary love in a time of social networks themed questions. The questions are centered on romance, love, dating, and relationships, particularly in light of our networked world.

For example, FIG. 4J is a table 420 showing one embodiment of a mini-game in a question content type that may be played in accordance with the gaming application of the present specification, showing exemplary fact or fiction themed questions. These questions challenge the question answerer to determine whether the user that sent them the question truly believes something is fact or fiction—exploring what a player believes to be true, often focusing on aliens, spirits, conspiracy theories, etc.

For example, FIG. 4K is a table 422 showing one embodiment of a mini-game in a question content type that may be played in accordance with the gaming application of the present specification, showing exemplary ethics themed questions. These questions raise thought-provoking concepts to challenge one's code of ethics and explore the boundaries of a player's ethics and morals.

In one embodiment, the chain game format is that of a fantasy sports bracket where users can earn free play or virtual currency based on the performance of their team during a live sports event and/or based on sports trivia. Users can join communities based on team affiliations and tree communities can be pitted against each other. Thus, it is possible to uproot or even kill another tree community.

### Benefits of Being a Trunk

As described above, the trunk is the player that begins the game, and therefore, the initiating user. The trunk is responsible for initiating the formation of the “viral” community and may not be connected to everyone that is in their tree. For example, a trunk may send a question to their list of friends. If a friend becomes a branch from the trunk, then they are a first order branch or leaf, with respect to the trunk. The first order branch may send a question to their list of friends and if the trunk is not directly connected to a friend on the first order branches' contact list, then that friend is a secondary connection to the trunk or a second order branch or leaf. Further, if the second order branch sends a question to their list of friends and the trunk is not directly connected to a friend on the second order branches' contact list, then that friend is a tertiary connection to the trunk or a third order branch or leaf and so forth, up to nth order branches.

In one embodiment, a trunk can create a “special interest tree” that can include, but is not limited to clubs, political beliefs, sports teams, states, countries, charities, and the like (i.e. Laker fans, Orange County Triathlon Club, PETA, etc).

In one embodiment, a trunk can browse through their tree (Tree Browser) and look at the structure of the tree and user profiles for each person on their tree. In one embodiment, the tree structure is presented as a statistical report with a visual graphic on the size and structure of the tree. In one embodiment, the tree structure is provided as a multi-tiered hierarchical list of each person on their tree and a list of the people that are connected to those people. In one embodiment, the trunk is able to mute a player from the message feed (in this case, the trunk is able to ignore messages from a player on their tree). In one embodiment, the tree structure may be viewed using a file viewer.

In one embodiment, the trunk is able to prune their tree, which allows them to kick people off of the tree by deleting branches and leaves. Further, the tree may also include a “Death List” that shows which players have died and fallen off of the tree and how many sub-branches and leaves they have taken with them. In one embodiment, the list includes pruned branches and leaves. In one embodiment, the trunk is provided with an advance notification of which branches are falling off or dying. Further, the trunk is able to send messages to those branches to notify these branches that they need to feed themselves. In one embodiment, the trunk can spend virtual currency to keep these branches alive.

In one embodiment, each tree has a discussion group that is a simple message thread sorted by date.

In one embodiment, a player can only become a trunk owner based upon how much a branch participates in someone else's tree. For example, a player may only become a trunk based upon a threshold number of interactions, or amount content responded to correctly, or number of questions answered correctly or virtual currency (coins) earned in order to be able to establish their own trunk.

### Tools for Trunk to Nurture Their Community

A trunk is provided with communication tools that they can use to nurture their community to grow it, maintain it, and let it thrive, for long term success.

In one embodiment, trunks are able to communicate with their tree members by messaging within the application, such as via Twitter®. However, in one embodiment, messages are sent to all players that are in the tree, not only to those that are directly connected to the trunk by a first order connection. Therefore, the trunk can “tweet” to first, second, third all the way to nth order connections. In one embodiment, photos can be sent to the tree members via message feed.

In one embodiment, trunk messages are shown in a scrolling window so that all messages may be viewed from the trunk in chronological order. A player can click on a tree button (such as button 209 in FIGS. 2A and 2B) to get information (an information screen) about the tree and can see trunk messages like a message feed.

A trunk may also have the ability to ask questions of their tree members and get results back, so that their tree can vote and give opinions about the tree.

### Content Creation Tools

In various embodiments, a trunk may be equipped with “tools” that can be used to create content. The tools can include customized or partially customized questions, an interface to create those questions, and/or an interface to use graphics or video of any other format within the content type.

In one embodiment, the gaming application of the present specification provides a development kit for content creation. The development kit will allow players to create micro-applications within the game application (such as mini-games) that will be added to the library of content. In addition, these “independent” developers can sell these micro-applications within a storefront in the gaming application to community owners.

In one embodiment, content is created using a content creation platform or development kit that is designed to publish a content template available to third parties. Third parties can then tailor the content template with specific media or data to generate a playable mini-game, receive mini-games and/or corresponding challenges from third parties, store the mini-games and/or challenges in a database, and present a plurality of stored mini-games for use or purchase by an initiating user.

Preferably, each content template comprises a first version tailored to be presented to users in the form of a challenge. In one embodiment, the system described in the present specification automatically creates the second version based on the content of the first version. In one embodiment, the system of the present specification automatically creates the first version based on the content of the second version. In another embodiment, the system of the present specification automatically creates the challenge based on the content of the mini-game.

### Benefits of Being a Branch

It should be noted herein that the benefits that pertain to being a branch on the tree also apply to the trunk. The trunk, however, does not suffer from any of the repercussions or consequences.

In one embodiment, and as described above, a player becomes a branch by opting to send content (such as a question) to friends after responding to content (such as a question) that was presented to them by the initiating user or a subsequent player.

In one embodiment, a branch can initiate reverse play. This is implemented by allowing a branch that is downstream to send content (such as a question) to select users upstream.

Content is responded to (i.e. questions are answered) in the same manner described above. A trunk or branch can also select, in their user settings, to not have content sent back to them from downstream users.

In one embodiment, branches and leaves can only see, on the tree information screen, the identity of their direct parent and the branches and leaves at their level (laterals) and/or below them (children) that they are associated with or that they have invited. In an alternate embodiment, the branch can see all branches and leaves below them (children). Further, they cannot see their grandparents, parents or any other identity beyond the first order parent in their tree.

In an embodiment, branches can see a list of children that have fallen off of the tree and what time they fell off. This is a redacted version of the trunk's death list, mentioned above. Therefore, a player (whether a trunk or a branch) can tell when branches and leaves fall off so that they can monitor the people that they are connected to.

In one embodiment, a Content Browser is provided to each player for showing statistical information regarding content for each player. For example, in one embodiment where game play is limited to a question-based content, a Question Browser is provided to each player. Optionally, the question browser can show each user the questions answered (statistics), the number of people that answered the questions, and the percentage of people that answered the questions. Trunks and branches can also see which children answered the questions about them, what they answered, and who go the answer right or wrong. In one embodiment, people can comment on the questions and/or their answers. In an alternate embodiment, players can see questions answered by their friends and can comment on them. In an optional embodiment, questions can be set as private so that they do not appear in the Question Browser. For example, certain questions and polls may be sponsored by corporations who wish to keep the results private. In an alternate embodiment, users can pay a fee to view the Question Browser and thus, statistical information on their questions. In one embodiment, a player can only see the two most recent questions that were sent. It should be noted that the content browser can show statistical information on any and all content contained therein and is not limited to just question-based content.

### How to Feed and Nurture the Tree

The process of responding to content, in any format, having any theme such as answering questions, is referred to as ‘feeding the tree’ and each player is able to view his or her spot on the tree via the graphical representation on the gaming interface. As mentioned above, each min-game or content type represents food for the community; thus, each piece of content is a packet of food.

In one embodiment, the trunk must feed their tree at least once during a predetermined time period by sending nutrients up the tree. The predetermined time period may be any length of time and, in one example, is 48 hours. To send nutrients up the tree, a player sends content or food packets to current branches, leaves and other contacts that are not currently branches or leaves. A trunk or branch can create new branches by sending content or food packets to a list of contacts that are not currently branches. Thus, in order to remain “alive” a trunk must constantly nurture their community. A trunk may choose to send more than one piece of content or food packet per day, but must be careful because the branches and leaves on a tree can be overfed with content food packets and will die. In one embodiment, a “feed meter” is provided that allows a trunk or branch to determine whether they are feeding their tree too much or not enough.

In one embodiment, a trunk may send out (or broadcast) content (i.e. food packets) to all the branches and leaves within his community (those connected on the first, second, third, to the nth order). Thus, a trunk can choose to communicate with all members of the community, or just one order or node, or some portion thereof. The trunk is therefore responsible for entertaining and keeping the community interested. In one embodiment, if a trunk “broadcasts” content by sending it to all of the branches and leaves in their community at the same time, a branch or a leaf may only invite new users by passing along that specific content. In other words, they do not pass along new content.

In one embodiment, a player may choose to send content to only a portion of their tree downstream. Thus, they are presented with a list of all of those players downstream and can de-select a friend from the list. In one embodiment, this de-selection process causes that player to be kicked off of the tree. A warning is presented to the player letting them know which downstream players have been deselected. In this case, as a default, the people downstream from that person will be kicked off as well. All players that are kicked off receive a notification message letting them know they are no longer part of that tree. In an optional embodiment, the players that have been kicked off will be presented with options to remain on the tree, such as, but not limited to the payment of virtual currency.

In one embodiment, a branch may feed the tree by sending content (i.e. food packets such as questions) downstream. In another embodiment, a trunk may feed itself by responding to content (i.e. food packets such as questions) that is sent upstream.

In an alternate embodiment, a trunk or branch may send out content (i.e. food packets such as questions) only to their immediate branches and leaves (those connected on a first order either upstream or downstream).

In one embodiment, content may be sent laterally, between trees. For example, branches and leaves may be able to respond to content or a food packet from other trees that will help feed one of the trees that they are on. In another example, players that are members of more than one tree can initiate cross-tree communication and pass content (or food packets) between those trees to help maintain the forest and create a symbiotic relationship.

In another embodiment, trunks and/or branches are able to view the results of all of the content that is sent out. For example, where the content is question-based, trunks and branches can see which children answered the questions about them, what they answered, and who got the answer right or wrong. In one embodiment, a trunk is only fed with each correct answer by a branch or leaf; thus, an incorrect answer is a failure to nurture a tree and may result in failure to thrive and ultimate death for the tree.

In one embodiment, if a branch or leaf does not respond to content within the predetermined time period or if they respond incorrectly and choose to die, all of the branches and leaves connected to that person fall off the tree. In an alternate embodiment, all of the branches and leaves connected to that person are notified that they are falling off and need to take some action, and are presented with options, to remain part of the tree, such as spend virtual currency. Thus, people downstream can collectively pay to stay on. After paying, those people downstream are connected to the next level up and only the intermediary branch dies and falls off.

In an alternate embodiment, the branches and leaves at the very end of the tree die if the tree is not fed within a pre-determined time period.

In one embodiment, a player may spend virtual currency and pre-feed the tree (so that the tree is automatically fed until the next predetermined time period cycle); this allows for people to not participate and not be connected to the game within the predetermined time period.

In one embodiment, a player may enable “overdraft protection” which allows the system to auto-deduct coins from their virtual currency bank if the tree is not fed within a predetermined time period. Thus, content is not passed on because virtual currency has been paid. In one embodiment, the system automatically sends content downstream if the tree is not otherwise fed.

In one embodiment, that content is selected from a bank of generic content, such as but not limited to generic, factual, questions that the initiating user or branch has pre-answered.

In one embodiment, a user may enable a vacation auto-feeder option whereby content can be set up in advance to auto-feed the tree in case the player is not able to connect.

In one embodiment, notifications may be sent to a player to feed their tree. Further, a player can establish their own notifications time table.

### Friends Lists and Sending Content

In addition to providing a powerful graphical representation of the game, in one embodiment, an initiating user, or first user, is able to expand his or her social network by having all of the individuals within the community become part of the first user's social network. When the first user initiates a mini-game, he has a social network with a first group of connected friends. As the game grows, the community increases by having friends of friends of friends become part of that community or mini-game. Those subsequent friends were not originally part of the initiating user's first group of connected friends. Rather, those subsequent friends are part of the initiating user's friends' social networks.

In one embodiment, all players can invite their friends to play (i.e. by sending content, such as a question, to them) by at least the following methods: Facebook®; using an address book on the person's device or email account; typing in an email address; Twitter®, Linkedln®; Apple® Game Center; or Instagram®. In one embodiment, questions can be sent via direct notifications to a player's device; on their Facebook® wall; via Instagram®; or through their Twitter® feed.

In one embodiment, players can share their friends list (such as the Facebook® contact list) so that the game app can search and see if their friends are already playing the game and/or send a request to the friend to be invited as a child on that tree and be part of that community. As mentioned above, a player can also receive a request from a friend to be on their tree. Players can set these approval settings in their user profile.

In order to join a community, a player gives access to their list of contacts. At least one tree that belongs to at least one contact is presented to that player. A player can see who is on the tree and then request to join selected trees. A request will then go out for that requesting player to join a tree. In one embodiment, the first player to accept the requesting player gets that player as a child. The requested player is notified that they are accepted.

In one embodiment, a stranger may join a community or tree. A random player will make a general request to join a tree. Players on the tree will receive that request if they have that option turned on in settings. Optionally, only leaves can have strangers join. When content is sent and the player clicks on it (i.e. from Twitter®, FACEBOOK® or through some program on their PC or mobile device), if the player is not already a user and has never installed the gaming application, in one embodiment, the program will redirect that user to the proper location to install the game. For example, the program may send the user to the appropriate application store, such as iOS, Google Play, or Facebook®. In another example, the user may be redirected to a website to download the game application or program.

In another embodiment, when a question is sent and the player clicks on it (i.e. from Twitter®, FB or through some program on their PC, iPad or mobile device), and that player has already installed the app or program on their device, the app is opened up on that device.

In one embodiment, to avoid a tree growing into itself, a player cannot be invited to a tree that he is already on. Further, a user can be a part of a limited number of trees or networks.

### How to Get Extra Coins

Players can earn virtual currency by taking several actions. For example, a player can earn extra coins by logging in each day. In one embodiment, players can earn coins by providing a verified email address or by leaving notifications on. A player can also earn coins by using Facebook® to log in. In another embodiment, players can earn coins for each person that they invite to the game that becomes connected to them. In another embodiment, players can earn additional coins for each player they invite to the game that installs the game app. Optionally, players can earn coins for providing a review to the game. The number of coins may be decided upon based on the type of review (i.e. good, bad, neutral, etc.).

In another embodiment, players can earn extra coins based upon a scale of the number of questions they answer. For example, a player might earn 2 coins for each 25 questions answered.

In one embodiment, earning virtual currency is scaled based on tree statistics or the “level” a player has achieved. Thus, more coins can be earned the older a tree is or the bigger/taller the tree is.

In another embodiment, players can earn extra coins by sending content or responding to content that is ranked at a higher, more advanced level. In addition, players can earn extra coins by sharing paid content.

Optionally, to allow people to earn more currency and to pass time while waiting for questions, branches and leaves can answer questions from other trees which can help feed one of the trees, of their choosing, of which they are a member.

### Leaderboards

In one embodiment, the gaming application can display leaderboards for all players of the game. In one embodiment, the leaderboards may consist of, but are not limited to: largest tree; oldest tree; most branches (i.e. friends); most branches in a tree; most trees in a forest; most trees a player is in; most questions answered; a BFF leaderboard showing “I know PLAYER best” (this can be based on a challenge, as described below); “I know trunk best” leaderboard (which can be a sorted list of people that answered the Trunk's questions that they send to the whole tree with the most correct number of answers or based on a challenge as described below); most money raised (for charity—see below); or most questions answered correctly. In another embodiment, there can be one leaderboard per tree that shows who has the most branches and leaves downstream from each player.

### Meet Your Match

In one embodiment, as questions are answered by a millions of users, the gaming application of the present specification can match people that gave the same answers to questions. Optionally, additional questions can be used as a dating game.

### Celebrity Challenge

In one embodiment, the gaming application of the present specification envisions game play between celebrities and a plurality of players. It should be understood that a celebrity or one of star status would find it difficult to play a game with more than a handful of people. With the design of the gaming application, a celebrity can issue or broadcast a “challenge” (in any of, but not limited to, the content types described above) and have thousands of people play the game or challenge concurrently and interact with the celebrity. Many people can thus play against one person.

### Charity

Because being part of a large community doing good feel great and is rewarding, in one embodiment, trees can be designated as a Charity Tree where a certain percentage of the revenue generated by the people of that tree will be donated to the tree's charity. This allows people to be part of a giving community. For those trees that are designated as a charity tree, a display is provided that shows how much money has been raised in total for the tree and the entire game.

### Monetization

In one embodiment, the game application is offered for free. In one embodiment, the game application is offered in exchange for currency. Optionally, the paid version of the game application may be a more enhanced version (i.e. ad-free, greater number of currency to start with, premium features). Further, virtual currency may be purchased by a user through the single point of purchase functionality described above, which triggers a purchase process by authorizing the use of a stored set of billing processes, such as a bank withdrawal or credit card charging process. In one embodiment, that virtual currency is represented by coins. In one embodiment, coins can be purchased at a specified rate, with larger, bulk quantities being discounted. For example, 10 coins may cost $1.00, while 100 coins may cost $9.00. Optionally, a player can purchase seeds to start trees for a fee, such as 99 cents.

In one embodiment, certain content may only be available to users who pay for expanded content.

In one embodiment, certain trunk features are available only if purchased. Further, they may be purchased as a one-time purchase or via a monthly subscription. Further, in one embodiment, a player may have to pay to see statistics or question results. As mentioned above, a player can earn a coin with a correct answer to a question but must spend a coin to remain on the tree with an incorrect answer.

In one embodiment, questions may be sponsored.

### Exemplary Game Interface

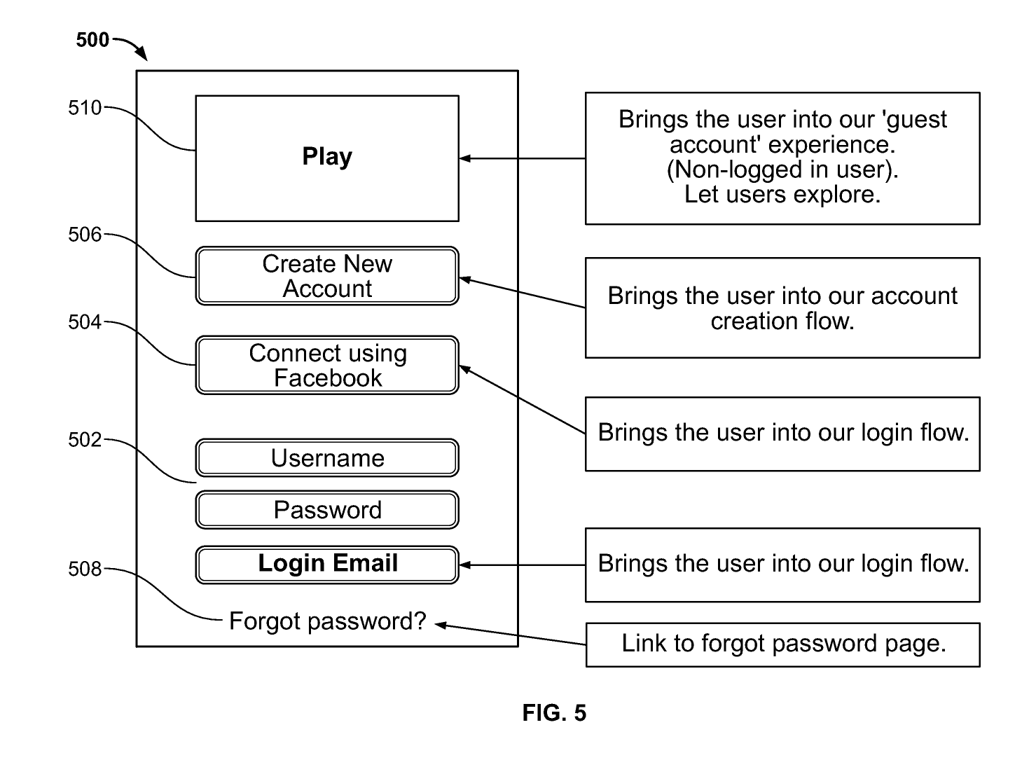

The description below, with reference to FIGS. 5-39, is provided to illustrate an exemplary framework of a basic game structure in accordance with one embodiment of the gaming application described in the present specification. These are only exemplary graphical user interface (GUI) wireframes and are not to be construed as limiting.

FIG. 5 shows an exemplary lobby screen 500 of the gaming application of the present specification. The lobby screen allows for the user to sign-on by inputting sign-on credentials (user name and password 502), to log-in using Facebook® account credentials (connect using Facebook® 504), or to create a new account 506. If a user has forgotten his or her password, the user can enter a login email and select a forgot password button 508 to be provided with password retrieval and/or reset instructions. In addition, a user can select a play button 510 and can be part of the guest account user experience for demo play so that users can explore the game.

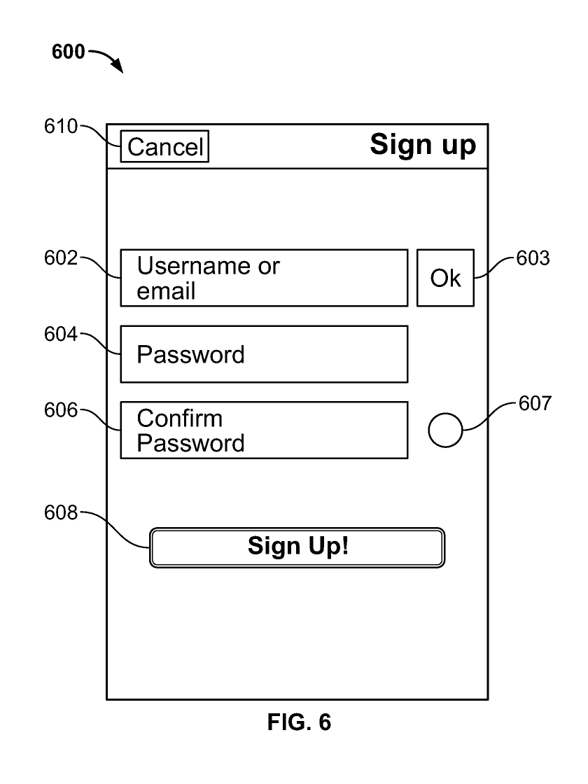

FIG. 6 shows an exemplary sign-up screen 600 where a user can sign up for the gaming application of the present specification by entering certain bits of information, such as a username and/or email 602, and a password 604. In one embodiment, the username is automatically tested for uniqueness against the database of existing usernames. In one embodiment, if the username is acceptable, a window 603 proximate the username 602 will display ‘OK’. If the username is taken or unacceptable, the window 603 will display ‘Taken’ or ‘Unacceptable’ respectively. In one embodiment, the password must be at least six characters in length. In one embodiment, the password is tested for strength. In one embodiment, the user must re-enter the password 606 to confirm said password. In one embodiment, when the password is confirmed, a small window 607 proximate confirm password 606 is illuminated. In one embodiment, if all the entered information is correct, the sign up button 608 becomes highlighted. Once all required information has been entered, the user can select the sign up button 608 to continue the process. A user can also select the cancel button 610 to cancel out of signing up. In one embodiment, a user is prompted to create an account or sign on when they attempt an action that they must have an account for or be signed in for. This includes, but is not limited to making a tree, becoming a leaf, passing content along to friends, and requesting linkage on a friend's tree. In one embodiment, an account creation pop-up window appears at any of the cases where log-in or sign-up is required.

Once a user signs up for the gaming application of the present specification, they are, in one embodiment, asked to verify their email. In one embodiment, an email is sent to the user's account with a verification link. In another embodiment, the user is prompted to enter a code sent via email onto their game interface. Once the email is verified, in one embodiment, the user must accept the Terms of Use/Privacy Policy prior to using the gaming application of the present invention.

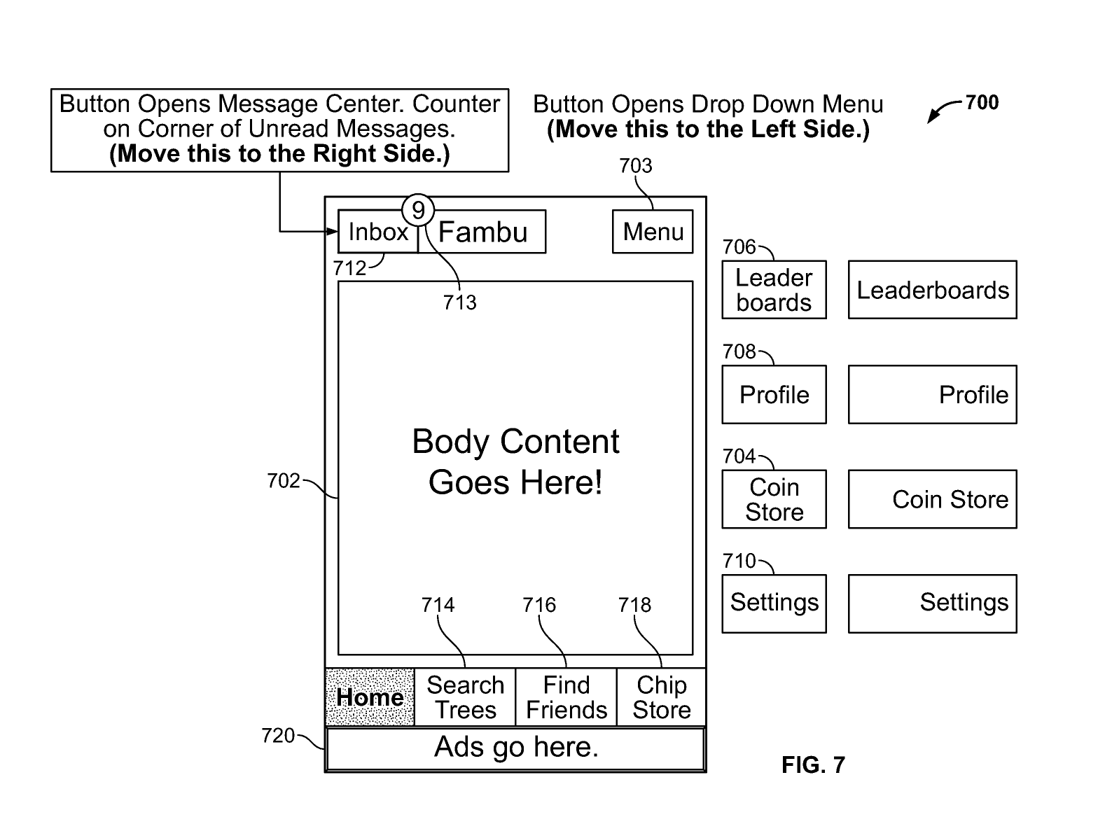

FIG. 7 shows an exemplary home screen wireframe 700 of the gaming application of the present specification. An exemplary home screen may include, but is not limited to, a gameplay interface 702, an in-game store 704, a leaderboard 706, a profile link 708 so that the user can edit their profile attributes, and a settings link 710. In one embodiment, the store 704, leaderboard 706, profile 708, and settings 710 buttons are accessed by first selecting a menu 703 button. The gameplay interface is provided for a user to start a tree, feed a tree, stay on a friend's tree and/or submit friend requests. In addition, a message center button 712 may be found on the home page. Selecting the message center button 712 takes the user to his or her message center. In one embodiment, a counter 713 provided proximate the message center button 712 informs the user of the number of unread messages in the message center.

In addition, a user can search trees 716 and find friends 718 using the home page. In one embodiment, the home page provides another link for the chip store 720 that can be accessed without having to first select the menu button 703. In one embodiment, a home button 714 is included with the search trees 716, find friends 718, and chip store 720 buttons. Selecting any of these buttons 714, 716, 718, 720 results in the gameplay interface 702 displaying the appropriate content for the selected button. Selecting the home button 714 brings the user back to the home page. In one embodiment, these four buttons 714, 716, 718, 720 are locked to the bottom of the screen. In one embodiment, the button of the currently selected page is highlighted. In one embodiment, advertisements 722 are displayed on the home screen.

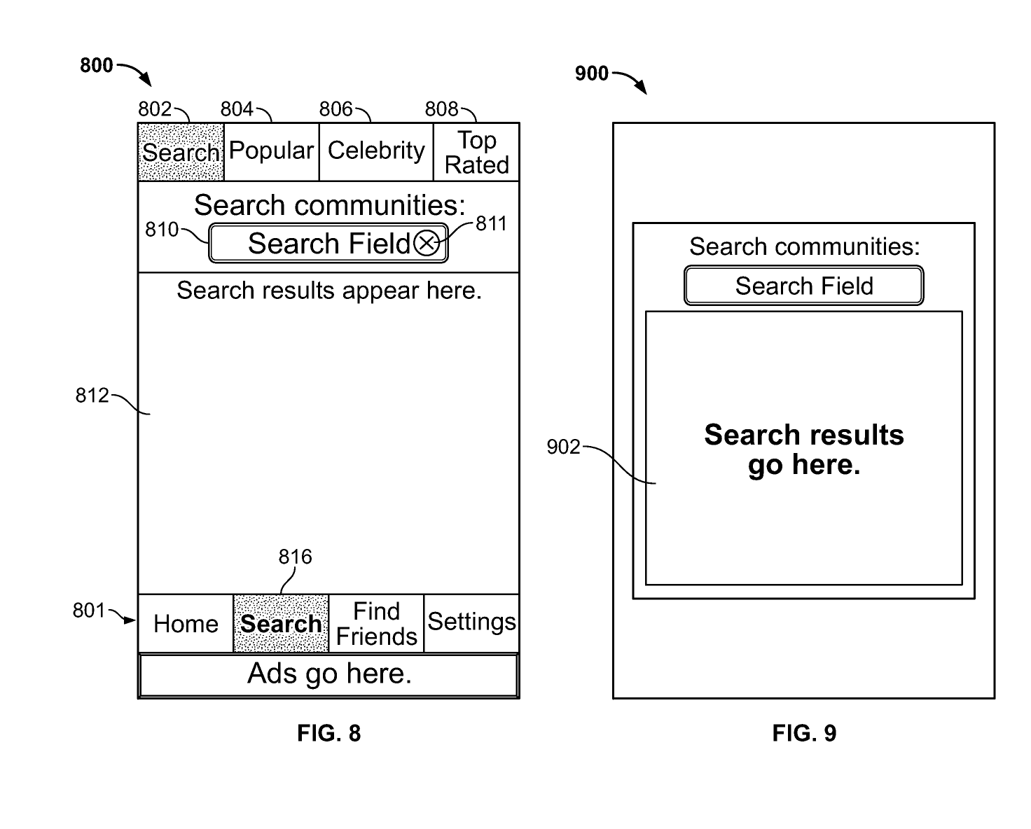

FIG. 8 is an exemplary “Search Trees” screen wireframe 800, where a user can search communities for trees by at least tree names and tree owner. In one embodiment, the search trees screen wireframe 800 of FIG. 8 is accessed by selecting the search trees button 716 on the home screen of FIG. 7. In one embodiment, the user can do a simple search 802, search what is popular 804, search celebrities 806, and search top rated 808 by selecting the appropriate button at the top of the screen. In one embodiment, the user can also search sponsored trees. In one embodiment, the button of the currently selected search type is highlighted (simple search 802, in FIG. 8). In one embodiment, the user then enters search terms in a search field 810 section. Selecting the x icon 811 in the search field will clear the search field 810. Search results are then displayed on a search results section 812 below. The search trees button 816 of the menu bar 801 at the bottom of the screen is highlighted, informing the user he or she is on the search trees screen.

FIG. 9 is an exemplary “Search Results” screen wireframe 900, where results of the search input into the interface of FIG. 8 are shown. The display 902 may include the following tree attributes: number of people; number of leaves or branches; number of pieces of content; status indicators (such as last time updated). In an optional embodiment, a sorted list presents results based on relevancy. In another optional embodiment, a tree is listed even if dead. In one embodiment, tree attributes are not shown directly on the search results screen but can be accessed by clicking on any tree of interest. In one embodiment, a verified account icon appears on this screen. In one embodiment, a stranger can make a general request to a tree to join on this screen. In one embodiment, players on a tree can get a request if the player has that option turned on in settings. In another embodiment, only leaves can have strangers join.

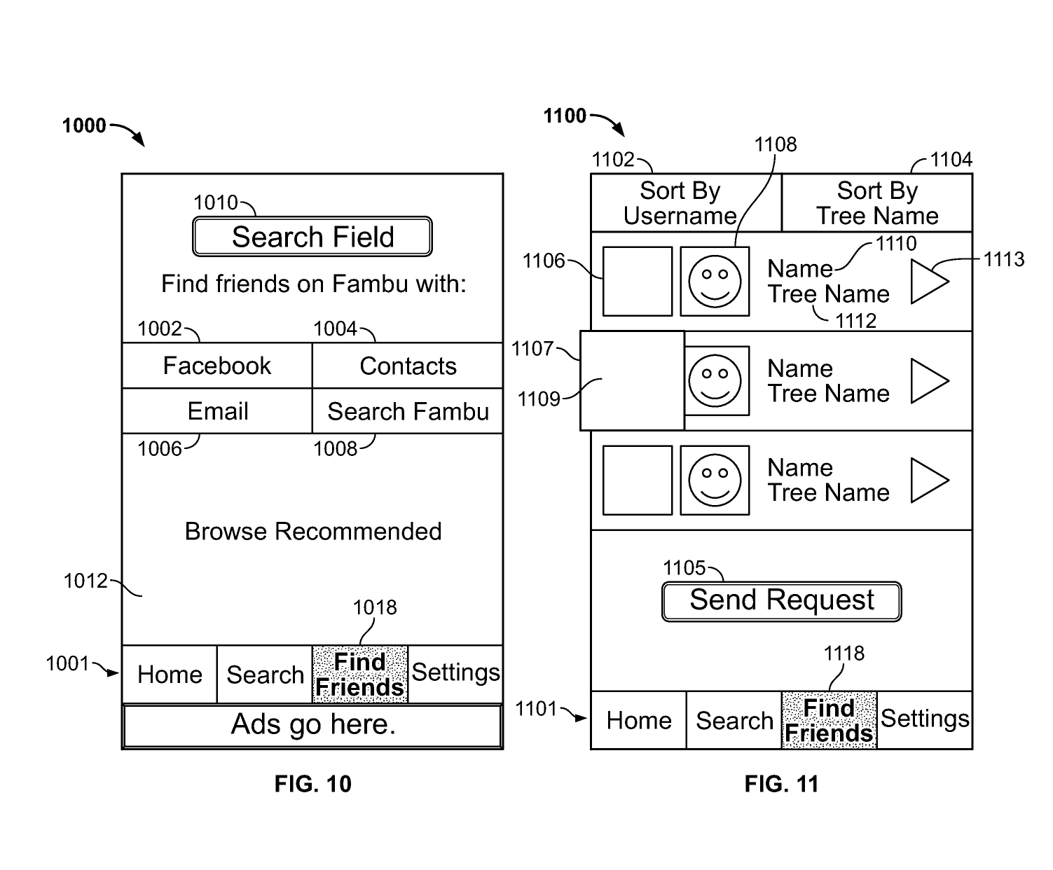

FIG. 10 is an exemplary “Find Friends” screen 1000 where a user can search for other friends that are playing or interacting with the gaming application of the present invention. In one embodiment, a user can also join friends' trees from this page. A user can search for friends using their contacts 1004 on their gaming device, via Facebook® 1002, by inputting an email address 1006 or searching the database of users 1008 within the gaming application of the present invention by selecting the corresponding button. After selecting by which method to search, the user enters the search terms in the search field 1010. In one embodiment, a user can also browse recommended friends and trees 1012 by selecting the corresponding screen section. The find friends button 1018 of the menu bar 1001 at the bottom of the screen is highlighted, informing the user he or she is on the find friends screen.

In one embodiment, once a user has selected one of the find friends options presented on the screen of FIG. 10, the system checks to see if the selected user has granted permission for the system to access those contacts. If permission has been granted, the system navigates to a new screen that includes search specific functions corresponding to the type of friend chosen. In one embodiment, if a friend is searched for via Facebook® 1002, the system looks at the Facebook® friends, cross sections those friends with active users of the current invention, and then displays the active communities of those friends. A results page shows the user's friends and what communities those friends are in, and then allows the user to sort by friends, community, or other associated criteria. In one embodiment, if a friend is searched for via contacts 1004, the system displays all the contacts from the user's address book who are users of the current invention. In one embodiment, if a friend is searched for via email 1006, the system displays a screen wherein the user can look up a friend by the friend's email address. In one embodiment, if a friend is searched for via the database 1008 of the current invention, the system displays a screen wherein the user can look up a friend by the friend's username within the current invention and/or by the friend's email address associated with the current invention.

FIG. 11 is an exemplary “Find Friends” results screen 1100 where the search results are displayed. On this screen, the user can select at least one friend to which to send a request. In one optional embodiment, only friends for which the user is not already on a tree are displayed. The list of friends can be sorted by user name, tree name, etc. In one embodiment, if a player asks multiple people on the same tree to be their friend, they are put onto the tree (or branch) of the first friend to accept their request. If the other friend(s) accept the request later, they are sent a message stating that it is too late for them to add this person to their tree. In one embodiment, the system automatically discards invitation requests that cannot be accepted once a friend has been added to a tree. The invitation request is then removed from the message system. In one embodiment, when a player is accepted to a tree, the system sends a push notification which appears in ‘trees you are on’ displaying a message.

Referring to FIG. 11, the user may sort the find friends results display by username or tree name by selecting the sort by username button 1102 or sort by tree name button 1104 respectively. In one embodiment, each found friend is displayed in a row and includes the following: a selection checkbox 1106; an image 1108 of the friend; the friend's username 1110; the friend's tree name 1112; and, an action arrow button 1113. In one embodiment, the selecting the action arrow button 1113 allows the user to send the selected friend a message. In other embodiments, the action arrow button 1113 performs various actions associated with the selected friend. In one embodiment, selecting the selection checkbox of a friend highlights 1107 said selection checkbox. In another embodiment, selecting the selection checkbox of a friend results in an X 1109 being placed in said checkbox. Once one or more friends have been selected, the send request button 1105 becomes highlighted and can be selected. Again, the find friends button 1118 of the menu bar 1101 at the bottom of the screen is highlighted, informing the user he or she is on the find friends screen.

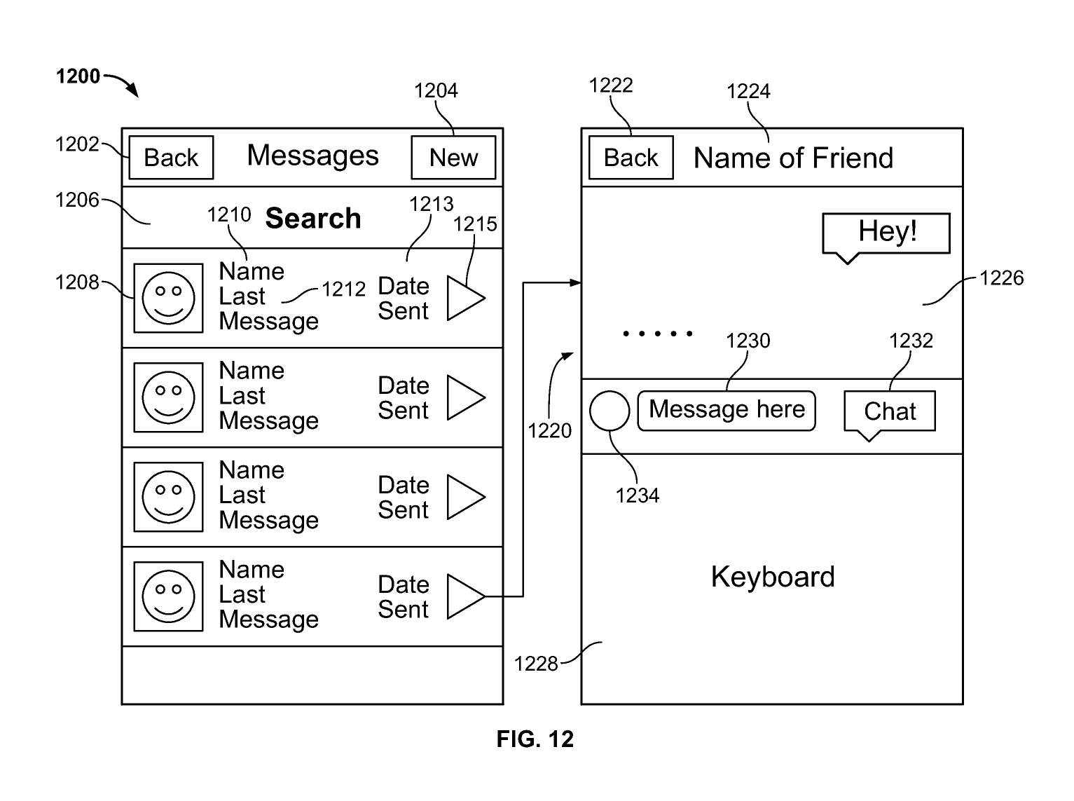

FIG. 12 is an exemplary “Inbox/Message Center” screen 1200 where a user can chat with any of their friends, independent of tree relationships. Users can also use this interface to send messages regarding trees that they are on or questions/comments regarding content they have sent out. In one embodiment, the Message Center has an integrated notification system for when the following activities occur (but not limited to said activities): a user will get a message when one of their branches drops off and they inherit the branches downstream of that branch; a user will get a message when their branch leaves a tree and they are part of a new branch; a user will get a message when they or any of their friends achieve a certain level or accolade within the gaming application of the present invention.

In one embodiment, a user accesses the Inbox/Message center screen by selecting the inbox button 712 on the home screen of FIG. 7. Referring to FIG. 12, the inbox message center screen allows users to draft a new message or return to the home screen by selecting the new button 1204 or back button 1202 respectively. A user can search through their messages by entering search terms in the search field 1206. Selecting the search field 1206 brings up a keyboard with an enter/search button (not shown) wherein the user enters search terms and clicks enter/search to search for a message. A summary of messages is listed under the search field 1206. In one embodiment, the messages are listed by rows and each includes the following: an image 1208 of the friend who sent the message; the username 1210 of the friend who sent the message; a portion of the title 1212 of the last message sent by the friend; the date 1213 the message was sent by the friend; and, an action arrow button 1215 which, when selected, opens up a chat window 1220 with the friend who sent the message. In one embodiment, the chat window 1220 includes: a back button 1222 which takes the user back to the inbox/message center screen 1200; a display 1224 of the username of the friend; a conversation portion 1226 which lists the last few messages sent between the user and the friend; a keyboard 1228 for entering a new message; a message display 1330 which displays the current message being typed by the user; a chat button 1232 which, when selected, sends the current message. In one embodiment, the chat window 1220 further includes an action button 1234 which allows the user to perform a specific action related to the message. In one embodiment, the action button 1234 allows the user to add an attachment, such as an image, to the message. In one embodiment, the action button 1234 allows the user to take a picture with their mobile device, wherein said picture is then added to the current message.

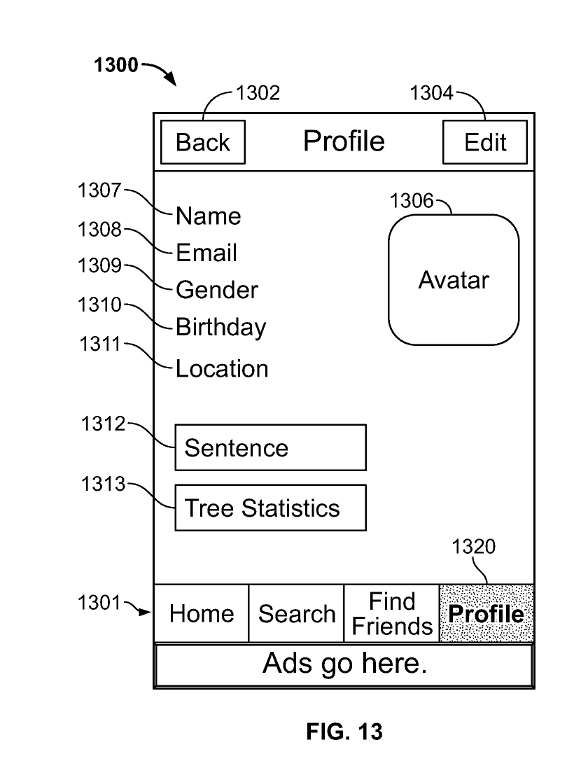

FIG. 13 is an exemplary “Profile” screen wireframe 1300 where a user can see details about themselves. In one embodiment, a user accesses the profile screen by selecting the menu button 703 on the home screen and then the profile button 708 of FIG. 7. Referring to FIG. 13, the profile screen allows users to view their profile within the system. A user can also edit their profile or return to the home screen by selecting the edit button 1304 or back button 1302 respectively. The profile screen includes attributes such as an avatar 1306, a display name 1307, an email address 1308, gender 1309, birthday 1310, location 1311, a short paragraph or sentence 1312 about the user; and, optionally, tree statistics 1313. A user can edit their avatar by clicking on the avatar image and choosing a new image. In one embodiment, the profile screen further includes a menu bar 1301 at the bottom. The profile button 1320 is highlighted to indicate to the user he or she is on the profile screen.

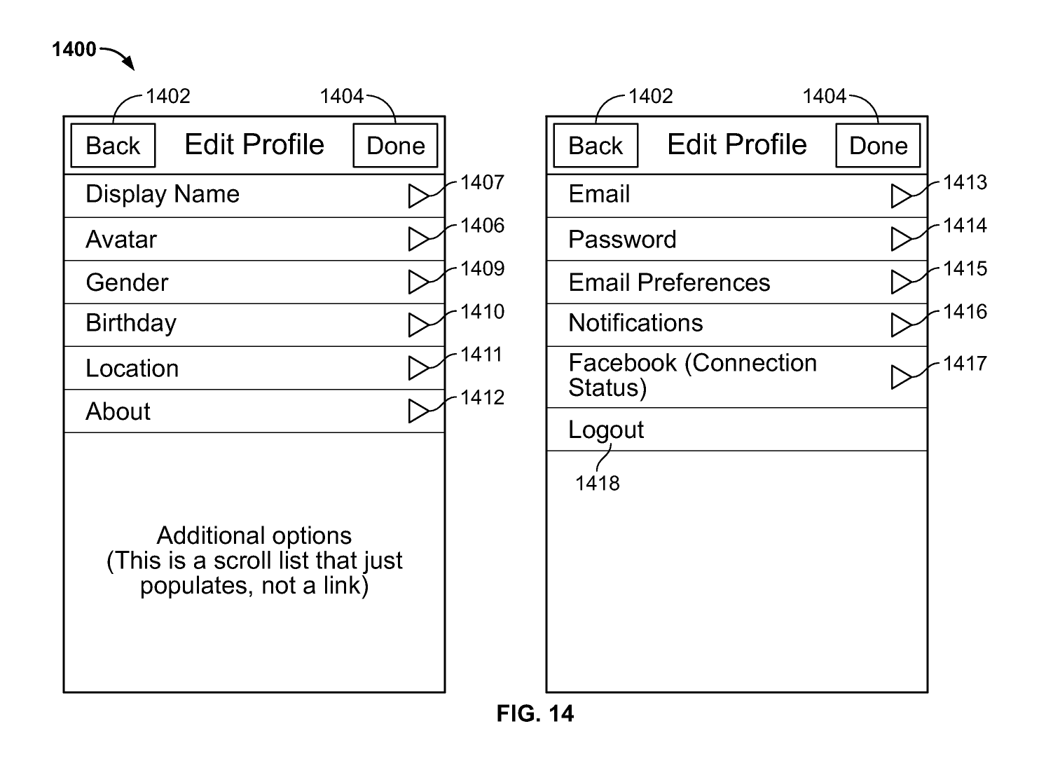

In one embodiment, selecting the edit button 1304 will direct the user to an “Edit Profile” screen 1400, as shown in FIG. 14, in which the user can edit any and all of the attributes listed with respect to FIG. 13. The edit profile screen 1400 includes a display name 1407 edit arrow, an avatar edit button 1406, a gender edit button 1409, a birthday edit button 1410, a location edit button 1411, and an about edit button 1412. In addition, the user can scroll down the edit profile screen 1400 and select edit arrows 1413, 1414, 1415, 1416, 1417, and 1418 to edit the email associated with the account, edit their password, edit email preferences, edit notification preferences, connect with a Facebook® account, and log out of their account respectively. The user can select the back button 1402 to return to the profile screen 1300 of FIG. 13 without making any edits or can select the done button 1404 to save changes and return to the profile screen 1300 of FIG. 13.

In one embodiment, a “Settings” screen is used to allow a user to sign in, control notifications, and access other settings features, such as but not limited to system messages; on/off push notifications; editing of Facebook®/Twitter® account links; allowing friends requests; allowing requests from strangers; allowing users to upgrade to premium versions; privacy settings, including allowing people to set themselves as public and discoverable, allowing strangers to join as a child on the tree, allowing friends to request to join you as a child on the tree, etc. A Settings screen may also include game promotions so that users can turn on options to receive a daily bonus. In addition, a Settings screen may also include options to set the AutoFeeder as described in detail above. In one embodiment, each trunk has its own AutoFeeder settings button and thus, screen.

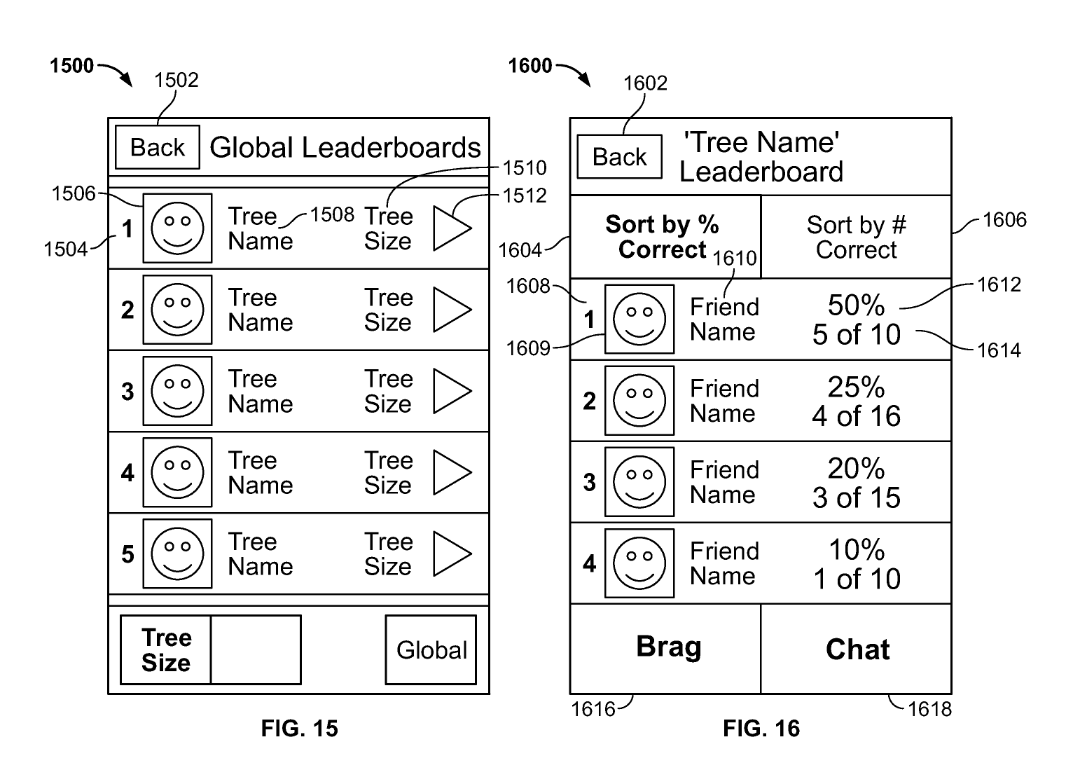

FIGS. 15 and 16 show exemplary wireframe leaderboard screens, including “Global Leaderboard Screens” 1500 and “Local Leaderboard Screens” 1600 for displaying global leaderboards for the game and local leaderboards for the trunk/branch, respectively. In one embodiment, a user accesses the leaderboard screens by selecting the menu button 703 on the home screen and then the leaderboards button 706 of FIG. 7. The global leaderboard screen 1500 includes a back button 1502 for returning to the home screen and displays the leaders in rows. In one embodiment, each row displays the leader's number 1504, an image of the leader 1506, the tree name 1508, and the tree size 1510. Selecting an action button 1512 associated with each leader allows the user to view additional tree information. In various embodiments, optional leaderboards for viewing include oldest tree, most branches (i.e. friends), most total branches in a tree, most trees a player is in, most questions answered, most money raised (for trees that are designated as a charity), most questions answered correctly, and a leaderboard per tree that shows who has the most branches and leaves downstream from each player.

Referring to FIG. 16, the local leaderboard screen 1600 includes a back button 1602 for returning to the home screen and displays the leaders in rows. In one embodiment, the a user can select a sort by % correct button 1604 to sort leaders by percentage of questions answered correctly or a sort by # correct button 1606 to sort leaders by the number of questions answered correctly. In one embodiment, each row displays the leader/friend's number 1608, an image/avatar 1609 of the friend, the friend's username 1610, the percentage 1612 of questions the friend has answered correctly, and the number 1614 of questions the friend has answered correctly out of total questions answered. A brag button 1616 and chat button 1618 are also available for the user to interact with other players regarding their play. In one embodiment, the local leaderboard screen displays a ‘I know player best’ leaderboard that lists the best friends of the user. In one embodiment, the local leaderboard displays a ‘I know trunk best’ leaderboard that lists players that correctly answered the most of the trunk's questions that were sent to the whole tree. These leaderboards would be on the branch tree information.

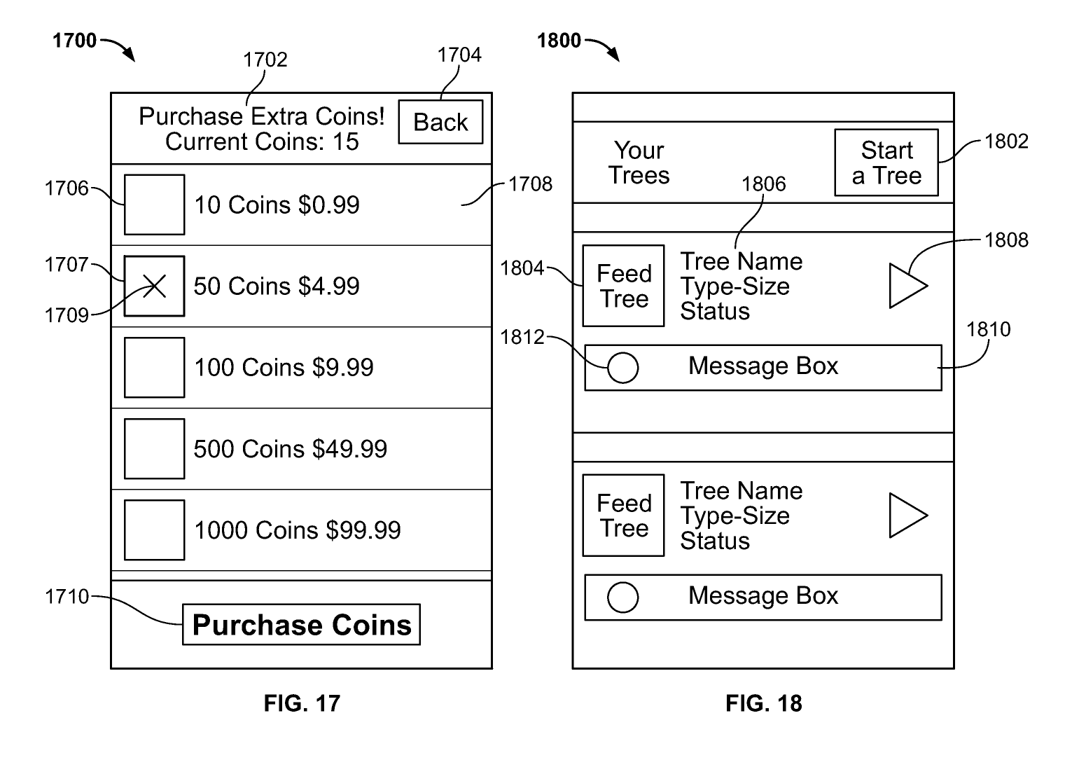

FIG. 17 shows an exemplary wireframe “Store” screen 1700 for making it easy for the user to purchase coins, upgrades, enhanced food packets, etc. In one embodiment, a user accesses the store screen by selecting the menu button 703 on the home screen and then the coin store button 704 of FIG. 7. In another embodiment, a user accesses the store screen by selecting the chip store button 718 on the home screen of FIG. 7. The store screen displays the user's current amount of coins 1702 and includes a back button 1704 for returning the user to the home screen. A user can select the selection box 1706 of a row describing an amount of coins for purchase and a dollar amount associated with said coins 1708. In one embodiment, the selection box 1706 is highlighted 1707 once selected. In another embodiment, the selection box 1706 is filled with an X 1709 once selected. Once an amount is chosen, the purchase coins button 1710 becomes highlighted and the user can purchase the coins. In another embodiment (not shown), coins are purchased by selecting buttons for each coin amount rather than selecting a checkbox and then selecting a purchase coins button. In one embodiment, once a purchase decision is made, a popup window appears to confirm the purchase. In various embodiments, the store screen includes various promotions to encourage the user to purchase coins. In one embodiment, the user can purchase ‘seeds’, ‘food’, and ‘category packs’ for their tree.

FIG. 18 shows an exemplary wireframe for a “Your Trees” Screen 1800 allowing a user to view their own trees, start a tree, and interact with their trees (provide food packets, message, etc.). In one embodiment, the ‘your trees’ screen includes a start a tree button 1802, which will allow a user to check if he or she has seeds, provide the opportunity to purchase seeds, and provide the ability to start a tree. The ‘your trees’ screen also includes a feed tree button 1804, information 1806 about the tree, including tree name, tree type, and size status, and, an arrow button 1808 which takes the user to a trunk tree information screen. Also included is a message box 1810 allowing a user to send a message to their entire tree or just friends. In one embodiment, an optional camera button 1812 is included. In one embodiment, the ‘your trees’ screen includes a clock (not shown) which shows time remaining for a tree. In various embodiments, a user has other options on the ‘your trees’ screen including, but not limited to: if a tree dies, bringing it back for a dollar amount; and, left swiping a tree to delete it forever. In one embodiment, a player is not allowed to remove a living tree from the ‘your trees’ screen. In one embodiment, the ‘your trees’ screen also displays the player's seed count (not shown). In one embodiment, the ‘your trees’ screen further includes a message number informing the user he or she has unread messages.

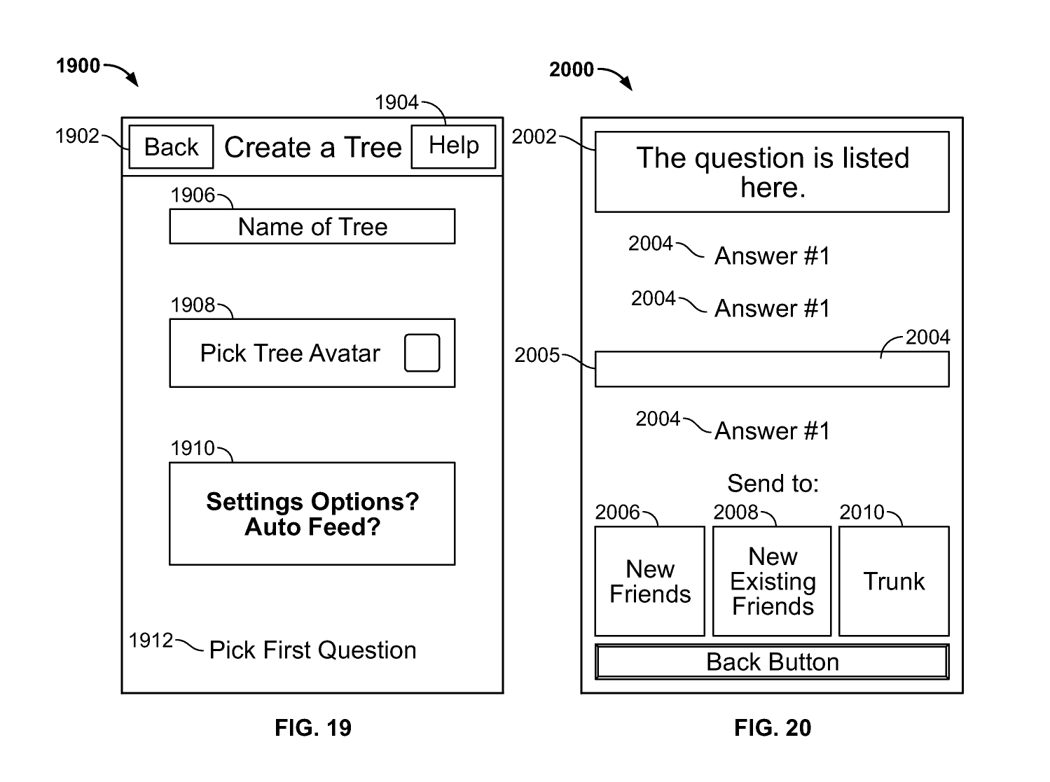

FIG. 19 shows an exemplary wireframe for a “Start a Tree” screen 1900, which will allow a user to start a new tree. The user can name the tree, customize the tree profile, and/or set an auto-feed. The ‘start a tree’ screen includes a back button 1902 to return to the ‘your trees’ screen and a help button 1904. The screen also includes a space to enter the name of the tree 1906, a pick tree avatar button 1908, a setting and auto feed options button 1910, and a pick first question 1912 button. A user must have a Facebook® account or a verified email address to start a tree.

FIG. 20 shows an exemplary wireframe for a “Feed Tree” screen 2000 in which a player or user answers a question or responds to content and then decides where to send that food packet. A user can either access this by either pressing “Feed Tree” from their Trees screen or from Start a Tree screen for the first time. Note that as mentioned above, a user must continually feed their tree by broadcasting content in order for the tree to remain alive. The ‘feed tree’ screen includes the question 2002 and a series of answers 2004. A user selected answer becomes highlighted 2005. A user has the options of sending the ‘food’ to a new friend 2006, a new existing friend 2008, or a trunk 2010. If the trunk 2010 option is selected, a confirmation will pop up and the send to friends page will be skipped.

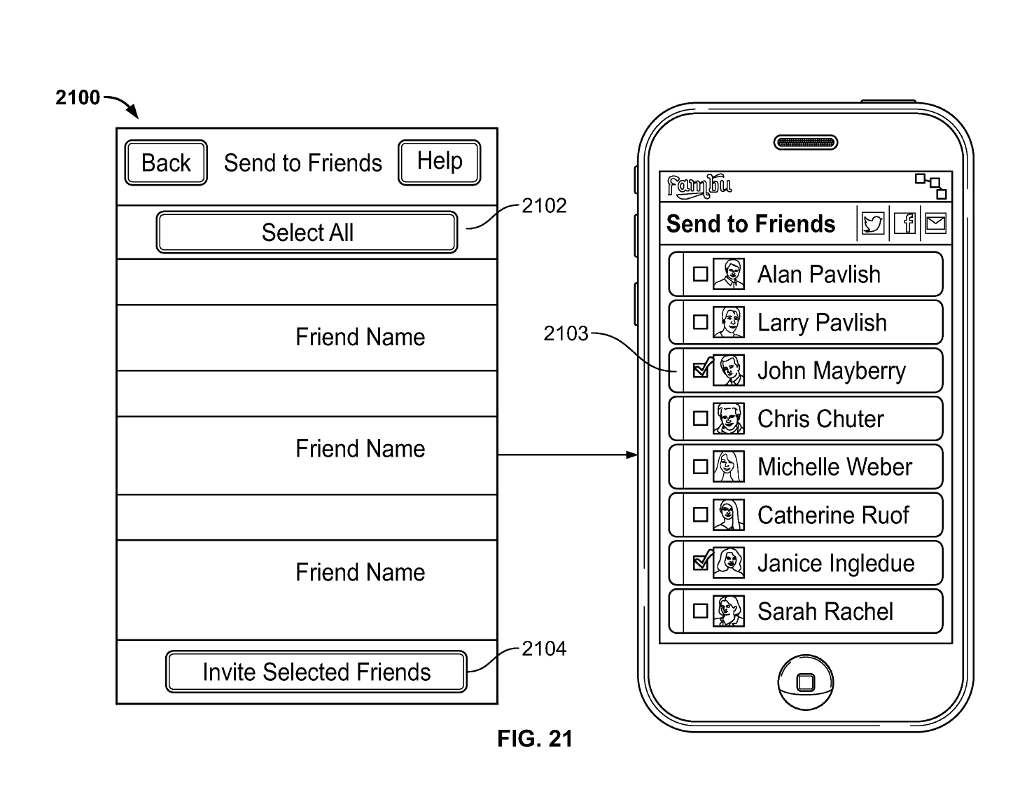

FIG. 21 shows an exemplary wireframe for a “Send to Friends” screen 2100 in which a users can select from a list of their friends to invite and to send content. In one embodiment, the list is arranged in alphabetical order. In one embodiment, the user can select the entire list by clicking one button 2102. In another embodiment, a user can send content to a select group of friends from their list 2103. Once at least one friend has been selected, the invite selected friends button 2104 is highlighted and can be selected. Once the invite selected friends button 2014 is selected, a confirmation popup appears and must be confirmed. In one embodiment, friends are categorized on the list by how the user is friends with them. In one embodiment, when a question is sent to a friend who already has the application installed, it is sent through a notification. In one embodiment, if a friend does not have the application installed, they are re-directed to the proper application store to obtain the application.

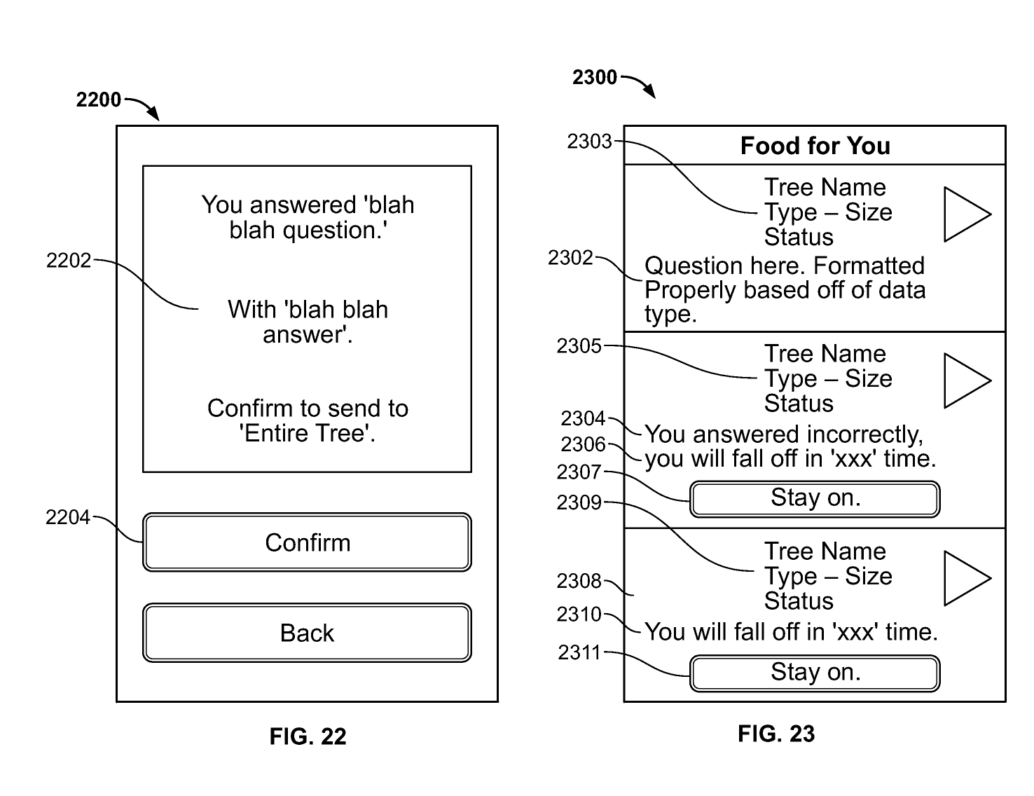

FIG. 22 shows an exemplary wireframe for a “Confirmation” pop-up screen 2200 in which a user can confirm that they are sending content out to the entire tree or a select group of friends. In one embodiment, the screen includes an area 2202 listing a portion of what they are confirming to send out and to whom they are sending. The screen also includes a confirm button 2204 which sends the information and returns the user to the home screen. In one embodiment, the system plays a feeding animation after the user selects the confirm button 2204 and before returning to the home screen.

FIG. 23 shows an exemplary wireframe for a “Home Content” screen 2300 in which users can view all content that is available for them to interact with. In one embodiment, all questions that are available for the user to answer are listed. Unanswered questions 2302 are listed with information regarding the associated tree 2303. Questions answered incorrectly 2304 are listed, along with tree information 2305, a statement of time before falling off the tree 2306, and a stay on button 2307 for spending a coin and navigating to a leaf/branch flow screen. Questions answered correctly but for which the user has chosen to not stay on the tree 2308 are also listed, along with tree information 2309, a statement of time before falling off the tree 2310, and a stay on button 2311 for navigating to a leaf/branch flow screen. In one embodiment, questions are queued. A countdown timer starts with each new question. If a tree is dying, questions continue to be queued. In one embodiment, queued questions are not inherited by branches and leaves when the person (branch) to whom they were originally sent drops off the tree.

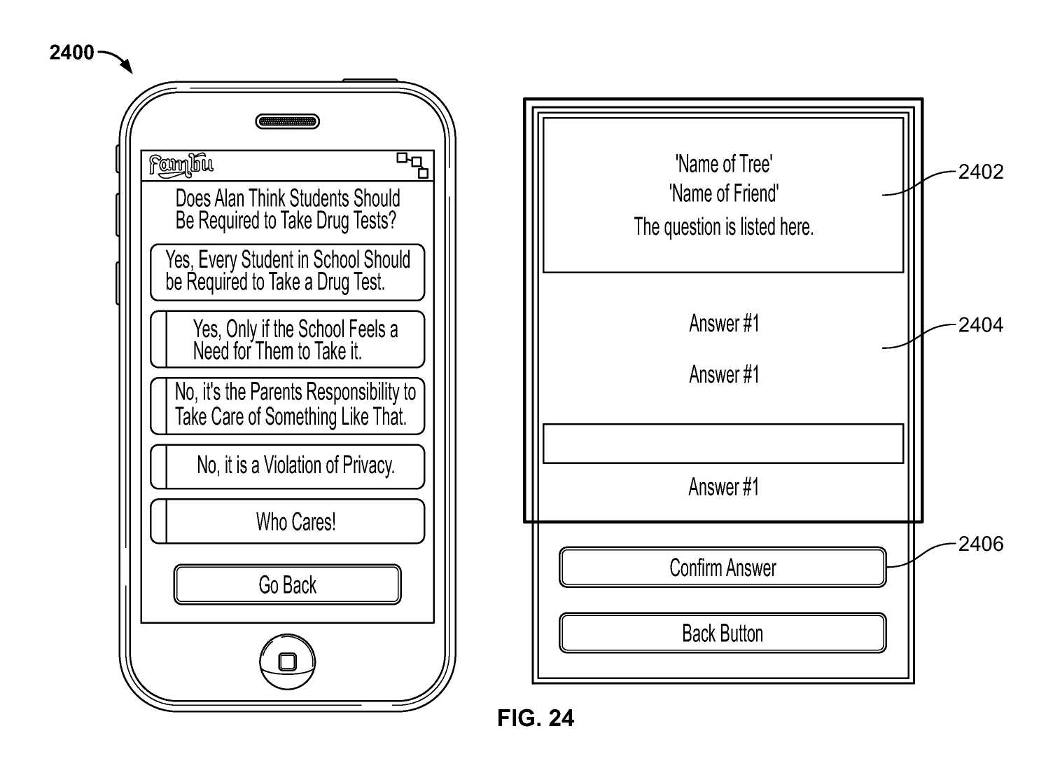

FIG. 24 shows an exemplary wireframe for a content response screen 2400. In one embodiment, the content response screen is a question answer screen in which a player answers a question from a friend that is upstream from them in the tree. This is, in one embodiment, a screen that a user will see if they are answering a question presented by another user. In one embodiment, the screen includes a question section 2402 that includes the name of the tree, name of the friend, and the question. A series of answers 2404 is available and the selected answer becomes highlighted. After an answer is selected, the confirm answer button 2406 becomes highlighted and can be selected. The system will bring up either a correct or incorrect answer popup. In one embodiment, if a branch falls off or becomes a leaf, then food is not passed down to its previous leaves or branches.

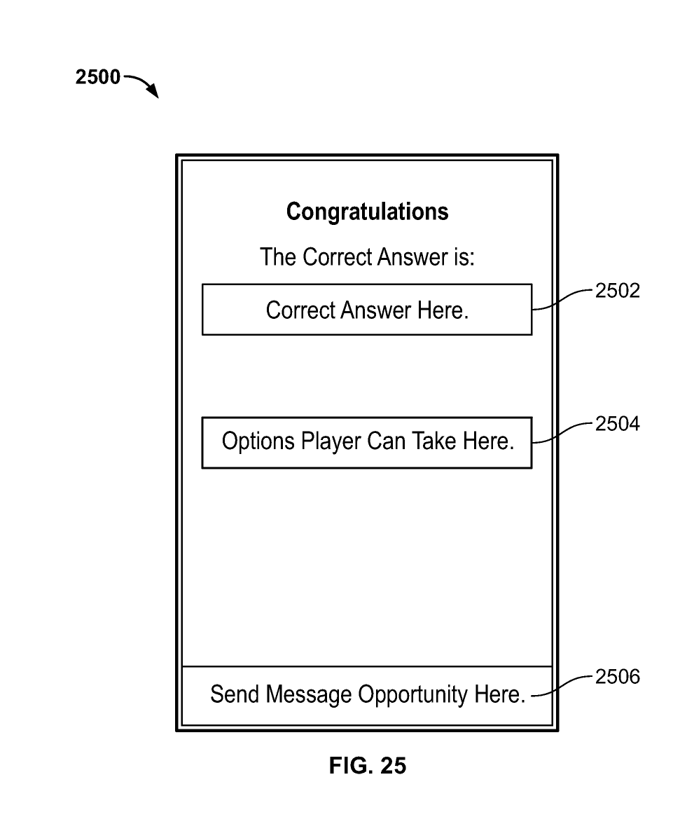

FIG. 25 shows an exemplary wireframe for a “Results” screen 2500, when the response is correct. It lets the user know if they answered the question correctly and displays the correct answer 2502 and presents them with options of actions 2504 they can take. In one embodiment, options include staying on the tree, leaving the tree, and sending food down the tree. In one embodiment, the user has an opportunity to send a message 2506 to the tree chat page.

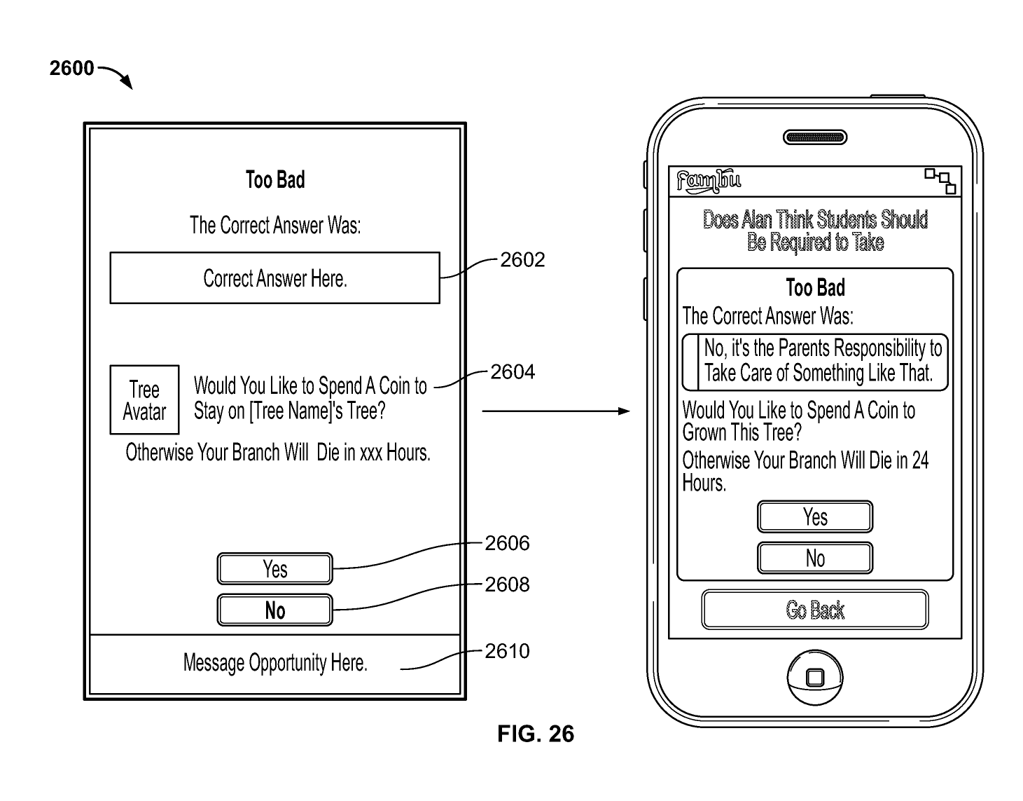

FIG. 26 shows an exemplary wireframe for a “Results” screen, when the response is incorrect 2600. It lets the user know they got the question wrong, displays the correct answer 2602 and presents them with opportunities 2604 to stay on the tree. In one embodiment, the user must spend a pre-determined amount of coins to stay on the tree. The user is notified how much time remains until the branch will die. If the user chooses to stay on the tree, he or she selects the yes button 2606 and spends the requisite amount of coins. If the user selects the no button 2608, the user is returned to the home screen. The user can also send food down the tree. In one embodiment, the user has an opportunity to send a message 2610 to the tree chat page.

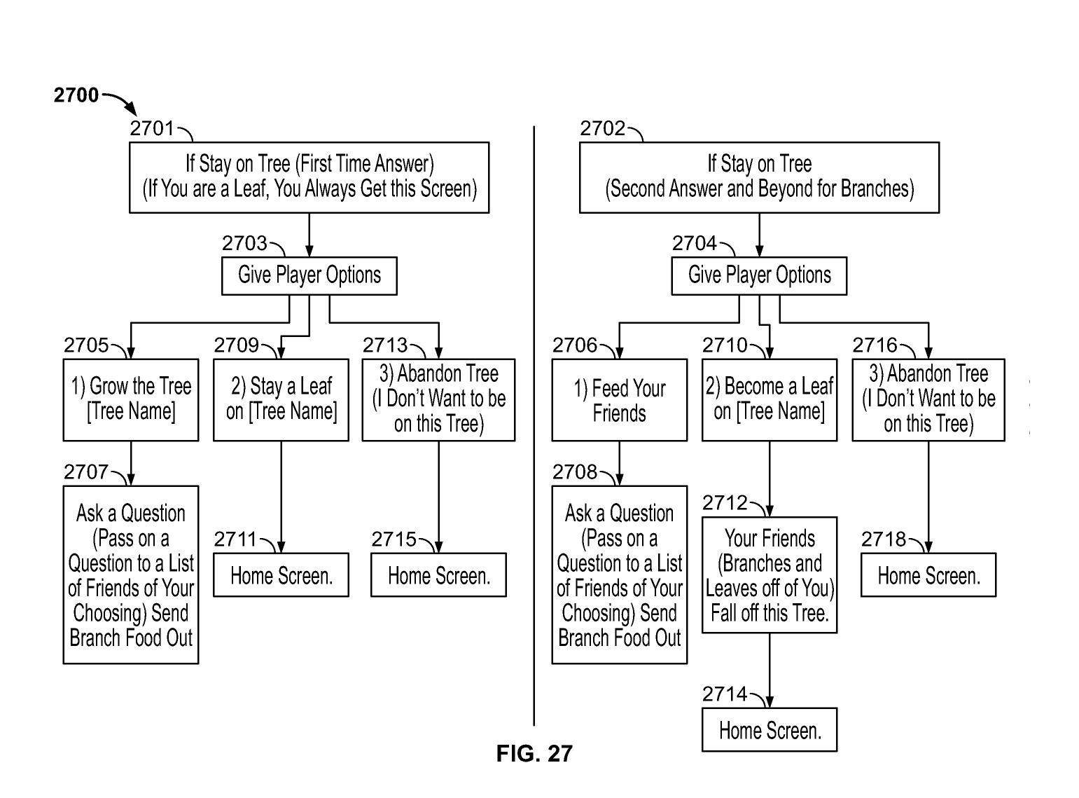

FIG. 27 shows an exemplary wireframe for a “Tree and Trunk Feeding Results Flow” 2700, if a user provides a correct response or spends a coin to stay on the tree. If the user provides a correct response to the tree community for the first time and is a leaf 2701, the user will have several options 2703. In one option, the user can grow the tree 2705 by passing along content to a list of friends of their choosing 2707. In another option, the user can remain a leaf on the tree 2709. The user is then taken to the home screen 2711. In yet another option, the user can abandon the tree by opting to not be on the tree 2713. The user is then taken to the home screen 2715.

If the user is a branch on the tree and provides a correct response to the tree community 2702, the player will be presented with several options 2704. In one option, the user can grow the tree 2706 by passing along content to a list of friends of their choosing 2708. In another option, the branch can choose to become a leaf (by not passing along content) 2710. In this scenario, the branch will fall off, along with any leaves associated with it, and become a leaf to the next branch up 2612. The user is then taken to the home screen 2714. In another option, the branch can choose to abandon the tree 2616. The user is then taken to the home screen 2718.

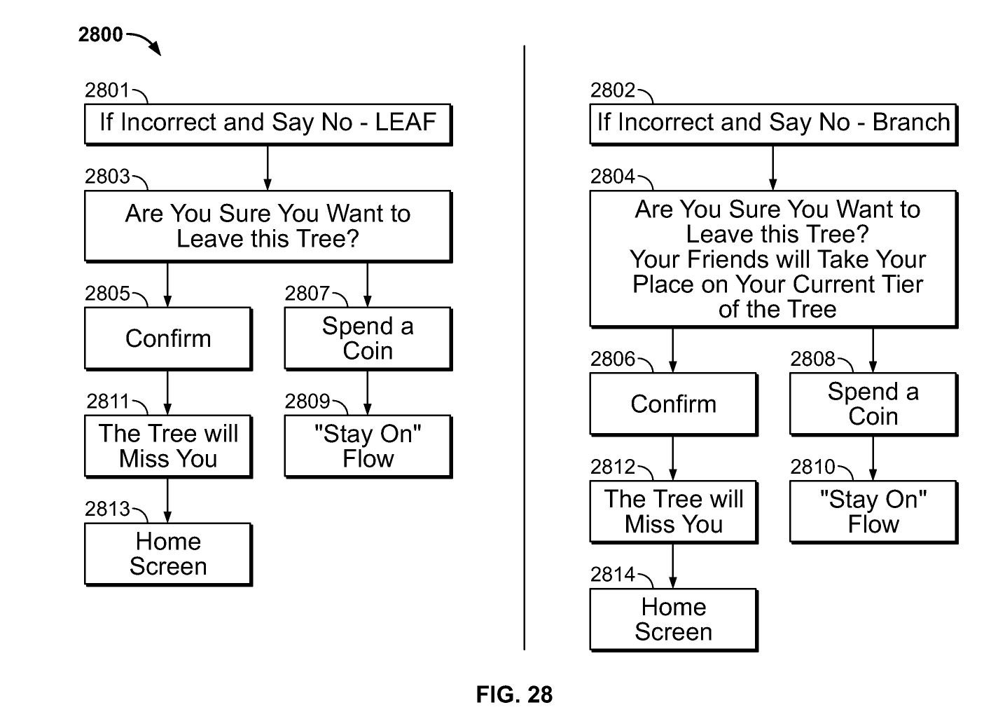

FIG. 28 shows an exemplary wireframe for a “Tree and Trunk Feeding Results Flow” 2800, if a user provides an incorrect response. If the response is incorrect, and the user is a leaf 2801, the user is presented with a choice 2803 to either leave the tree 2805 or to stay on the tree by spending virtual currency 2807. If the user chooses to spend a coin, they are “saved” and are still a leaf as their status remains unchanged 2809. If the user decides to leave the tree 2805, they are presented with a departure message 2811 and are returned to the home screen 2813.

If the response is incorrect, and the user is a branch 2802, the user is presented with a choice 2804 to either leave the tree 2806, at which point that user's friends will take their place on the current tier of their tree, or to remain on the tree and spend a coin 2808, at which point, their status is unchanged 2810. If the user decides to leave the tree 2806, they are presented with a departure message 2812 and are returned to the home screen 2814.

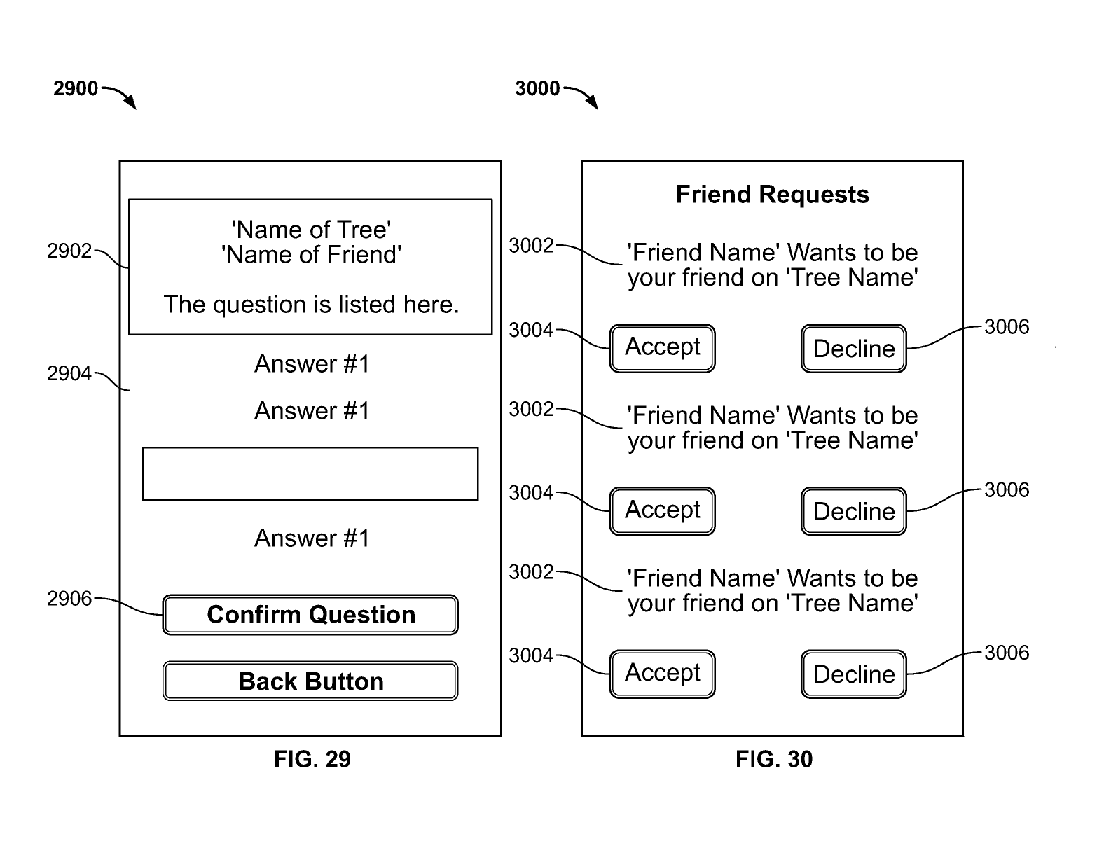

FIG. 29 shows an exemplary wireframe for a “Friend Question/Branch Sends Food” 2900 that illustrates how a user can send a piece of content or a food packet downstream. Thus, the screen is a wireframe of what the user will see if they have responded to content from above them in the tree correctly and are now allowed to send content down the tree, or stated differently, downstream from their position on the tree. The screen includes a question area 2902 including the name of the tree, the name of the friend, and the question. A series of answers 2904 is listed below. A user selects a confirm question button 2906 to bring up a friend selection window for sending the question.

FIG. 30 shows an exemplary wireframe for a “Friend Requests” screen 3000 that allows users to view pending friend requests 3002 and respond to them. In one embodiment, a user sees a list of friend requests 3002. They can either accept or decline these requests to be on their tree by selecting the corresponding accept button 3004 or decline button 3006. When a user accepts a friend request, that friend (the requestor) is now a leaf on that user's trunk or branch (whichever their status is) and a message is sent to the requesting friend that they have been accepted. If a friend request is denied, then the requestor does not become part of the trunk/branch. In one embodiment, it is possible to be friends with another user/player without being a part of that person's tree. Thus, the gaming application of the present specification allows people to be connected outside of the tree community.

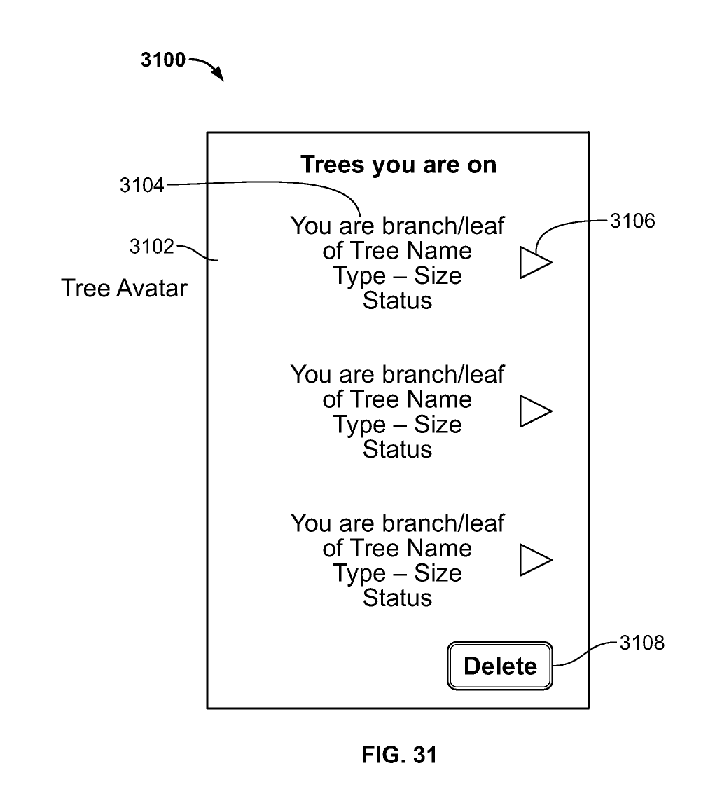

FIG. 31 shows an exemplary wireframe for a “Trees You Are On” content screen 3100, in which the user is presented, on the screen display, valuable information regarding the trees that they are on. In one embodiment, different messages can appear for each tree that the user is on. In one embodiment, the user is presented with a list of trees that they are on (or a list of communities to which they belong) that includes context sensitive information 3104. For example, in one embodiment, tree information such as but not limited to tree name, size of the tree, and the status of the tree (such as when the tree was last fed) is included. In one embodiment, the user's connection to the tree is shown, including whether they are fully connected, whether they need to pay to stay on, whether they are in danger of falling off, or any other type of tree-based relationship. In one embodiment, users on a tree can nudge a tree owner to feed that tree. In one embodiment, when a predetermined percentage of people on a tree nudge the owner, the owner receives a notification with a message indicating that the tree is ready for more food. In one embodiment, the list includes an avatar 3102 of the tree. Selecting an information arrow 3106 takes the user to a screen with more information relating to the corresponding tree. In one embodiment, a user can swipe the tree to the left to reveal a delete button 3108 for deleting the swiped tree.

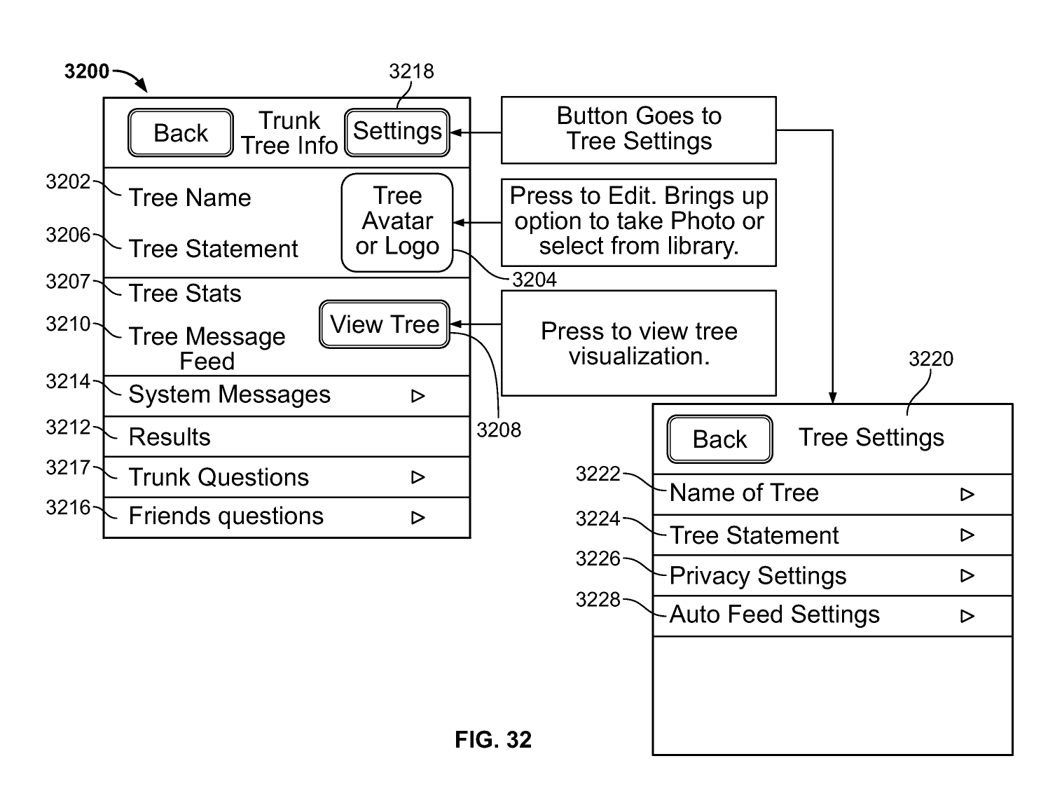

FIG. 32 shows an exemplary wireframe for a “Trunk Tree Information” screen 3200 that displays valuable information about the trunk to the user. In one embodiment, the information displayed includes, but is not limited to, the name of the tree 3202, the tree avatar/logo 3204, a mission statement about the tree 3206, tree stats 3207, including the size of the tree and the number of levels/tiers of the tree, a tree viewer 3208, a tree message feed 3210, content response results 3212, system messages 3214, friend messages/questions 3216, trunk questions 3217, and settings 3218. Selecting the settings button 3218 brings up a tree settings sub-menu 3220 that allows the user to edit the name of the tree 3222, tree statement 3224, privacy settings 3226, and auto feed settings 3228.

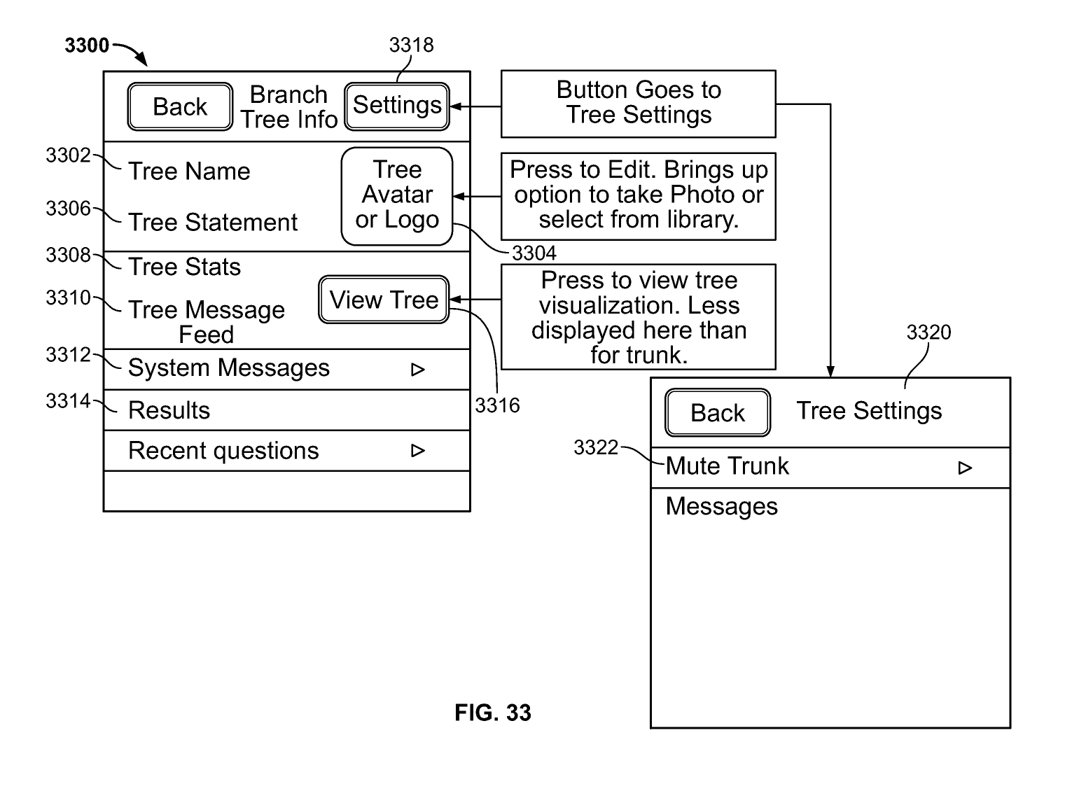

FIG. 33 shows an exemplary wireframe for a “Branch Tree Information” screen 3300 that displays valuable information about the branch to a user. The tree name 3302, tree avatar or logo 3304, and tree statement 3306 are displayed. In one embodiment, the information displayed further includes, but is not limited to tree stats 3308 including the size of the tree and the number of levels on the tree, a tree message feed 3310, system messages 3312, results of recent questions 3314, and the position (not shown) of the user on the tree from the trunk (1^{st} order, 2^{nd} order, 3^{rd} order, etc). In one embodiment, this branch view 3316 is limited to only the trunk and those branches and leaves to which the branch is connected (thus, the parent branch and the children branches and leaves). In the visual display, all other portions of the tree are inactive or grayed out. The screen includes a settings button 3318 which brings up a tree settings sub-menu 3320 wherein the user can mute trunk messages 3322.

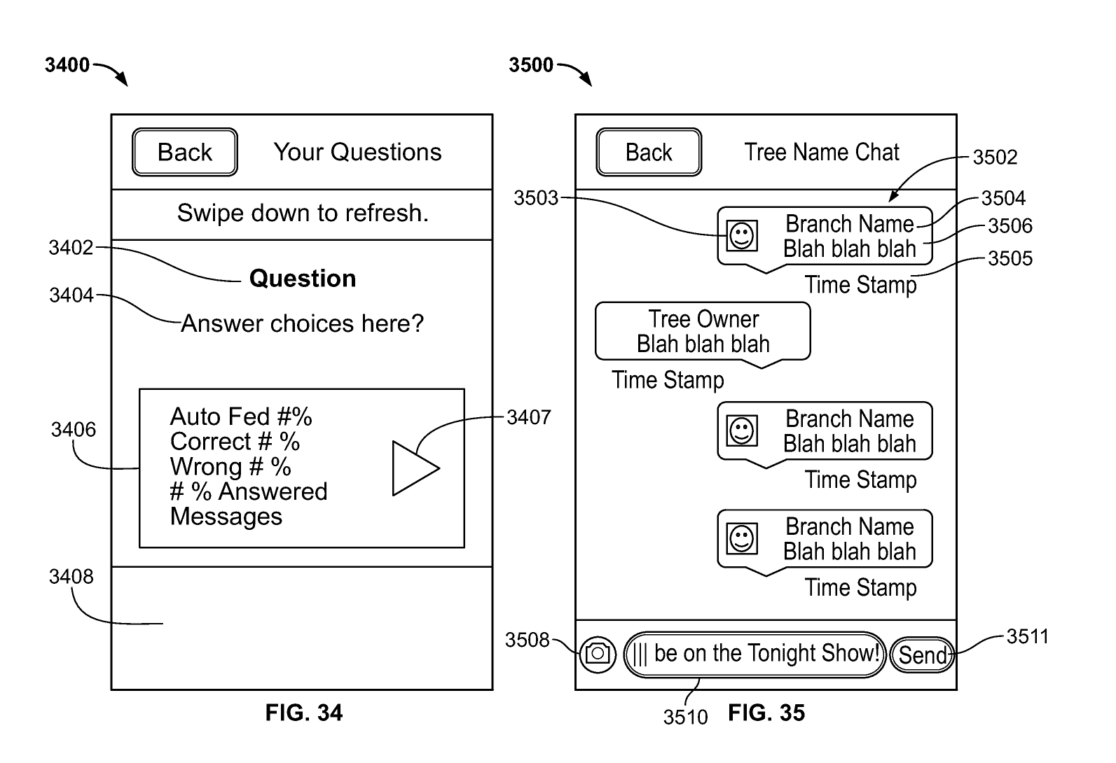

FIG. 34 shows an exemplary wireframe for a “Question Summary” screen 3400, which displays valuable information about the content the user has shared with the constituents of their tree. Thus, this screen is used for statistical information about the content that has passed between members of the tree community. The question summary screen includes the question 3402, a series of answers 3404, and information regarding the answers 3406, including but not limited to, the auto fed number and percentage, the correct number and percentage, the wrong number and percentage, and the number and percentage of answered message. In one embodiment, a detail arrow button 3407 provides the user with access to more detail regarding the current question. In one embodiment, additional recent questions are listed at the bottom of the screen 3408. In one embodiment, the 10 most recent questions are listed. In one embodiment, the user can load more old questions by scrolling to the bottom of the page and selecting load more questions.

FIG. 35 shows an exemplary wireframe for a “Tree Chat” screen 3500, which is used to graphically depict the tree and all communication channels. Thus, different members of the tree community can chat with each other. In one embodiment, only trunks and branches can participate in the chat. In one embodiment, the chat message 3502 contains the user's avatar 3503, the user's name 3504, a time stamp 3505, and the message 3506. In one embodiment, images can be embedded in the message using a embed photo button 3508. In one embodiment, the tree owner has a mute button (which they can access on their profile screen as described above). In one embodiment, the tree owner can delete a message so that it is removed from a tree chat screen for all users on the tree. A user can draft a message in the message area 3510 and then select the send button 3511 to send the message.

The above examples are merely illustrative of the many applications of the system of present specification. Although only a few embodiments of the present specification have been described herein, it should be understood that the present specification might be embodied in many other specific forms without departing from the spirit or scope of the specification. Therefore, the present examples and embodiments are to be considered as illustrative and not restrictive, and the specification may be modified within the scope of the appended claims.

We claim:

1. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of questions and answers, in a plurality of formats, for said game;
enabling an initiating user who has downloaded the gaming application to access a first question from said database and receive a first question;
receiving a first answer from said initiating user to said first question;
enabling said initiating user to choose a plurality of second users from a contact list of said initiating user;
sending a first question associated with a challenge to each one of said plurality of second users via a social network message;
enabling each one of said plurality of second users to independently view and answer said first question associated with a challenge;
revealing said initiating user's answer to the first question to said plurality of second users;
enabling each one of said second users to i) progress with said game if said answer to said first question is correct by re-answering the first question with a personal response or receiving a second question to respond to or ii) providing each one of said second users the opportunity to spend virtual currency to remain in the game if said answer to said first question is incorrect;
enabling each of said second users to choose a plurality of third users from a contact list of each one of said second users after each one of said second users answers said first or second question;
sending a first or second question to each one of said plurality of said third users via a social network message; and,
repeating the steps of enabling members to choose additional members from contact lists as questions are answered correctly, thereby indefinitely adding new members to said game.

2. The method of online gaming among members of an online social network of claim 1, wherein said first or second question comprises a restatement of the first or second question after a response to said first or second question is provided by said initiating user, forming a challenge.

3. The method of online gaming among members of an online social network of claim 1, wherein each member has a predetermined time period to answer a question, further wherein said member is removed from said game if said question is not answered by said member within said time period.

4. The method of online gaming among members of an online social network of claim 3, wherein said time period is 24 hours.

5. The method of online gaming among members of an online social network of claim 4, wherein said gaming site sends periodic social network messages during said time period to remind said member to answer said question.

6. The method of online gaming among members of an online social network of claim 1, further comprising the step of providing each member a graphical user interface wherein said questions and members of said game are graphically represented by a tree, further wherein said initiating user is represented by a trunk of said tree, said first players are represented by a first set of branches emanating from said trunk, and said second players are represented by a second set of branches emanating from said first set of branches, and so forth.

7. The method of online gaming among members of an online social network of claim 6, further comprising the step of enabling said members to view member profiles, send questions to new members, answer questions, and view gaming statistics from said graphical user interface.

8. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of questions and answers, in a plurality of formats, for said game;
enabling an initiating user who has downloaded the gaming application to access a first question from said database and receive a first question, by planting a seed and growing a tree;
receiving a first answer from said initiating user to said first question, forming a trunk of a tree;
enabling said initiating user to choose a plurality of second users from a contact list of said initiating user;
sending a first question to each one of said plurality of second users via a social network message;
enabling each one of said plurality of second users to independently view and answer said first question;
revealing said initiating user's answer to the first question to said plurality of second users; and
enabling each one of said second users to become a leaf on said tree by choosing not to progress with said game.

9. The method of online gaming among members of an online social network of claim 8, wherein said first or second question comprises a restatement of the first or second question after a response to said first or second question is provided.

10. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of questions and answers, in a plurality of formats, for said game;
enabling an initiating user who has downloaded the gaming application to access a first question from said database and receive a first question;
receiving a first answer from said initiating user to said first question;
enabling said initiating user to choose a plurality of second users from a contact list of said initiating user;
sending said first question to each one of said plurality of second users via a social network message;
enabling each one of said plurality of second users to independently view and answer said first question;
revealing said initiating user's answer to the first question to said plurality of second users; and
enabling each one of said second users to i) progress with said game if said answer to said first question is correct by re-answering the first question or receiving a second question or ii) providing each one of said second users the opportunity to spend virtual currency to remain in the game if said answer to said first question is incorrect.

11. The method of claim 10 further comprising the step of enabling each of said second users to choose a plurality of third users from a contact list of each one of said second users after each one of said second users answers said first or second question.

12. The method of claim 11 further comprising the step of sending said answered first or second question to each one of said plurality of said third users via a social network message.

13. The method of claim 12 further comprising repeating the steps of enabling members to choose additional members from contact lists as questions are answered correctly, thereby indefinitely adding new members to said game.

14. The method of online gaming among members of an online social network of claim 10, wherein each member has a predetermined time period to answer a question, further wherein said member is removed from said game if said question is not answered by said member within said time period.

15. The method of online gaming among members of an online social network of claim 14, wherein said time period is 24 hours.

16. The method of online gaming among members of an online social network of claim 14, wherein said gaming site sends periodic social network messages during said time period to remind said member to answer said question.

17. The method of online gaming among members of an online social network of claim 10, further comprising the step of providing each member a graphical user interface wherein said questions and members of said game are graphically represented by a tree, further wherein said initiating user is represented by a trunk of said tree, said first players are represented by a first set of branches emanating from said trunk, and said second players are represented by a second set of branches emanating from said first set of branches, and so forth.

18. The method of online gaming among members of an online social network of claim 17, further comprising the step of enabling said members to view member profiles, send questions to new members, answer questions, and view gaming statistics from said graphical user interface.

19. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of questions and answers, in a plurality of formats, for said game;
enabling an initiating user who has downloaded the gaming application to access a first question from said database and receive a first question, by planting a seed and growing a tree;
receiving a first answer from said initiating user to said first question, forming a trunk of a tree;
enabling said initiating user to choose a plurality of second users from a contact list of said initiating user;
sending said first question to each one of said plurality of second users via a social network message;
enabling each one of said plurality of second users to independently view and answer said first question;
revealing said initiating user's answer to the first question to said plurality of second users;
enabling each one of said second users to i) progress with said game if said answer to said first question is correct by re-answering the first question or receiving a second question or ii) providing each one of said second users the opportunity to spend virtual currency to remain in the game if said answer to said first question is incorrect;
enabling each of said second users to choose a plurality of third users from a contact list of each one of said second users after each one of said second users answers said first or second question;
sending said answered first or second question to each one of said plurality of said third users via a social network message, allowing said second user to become a branch on the tree; and,
repeating the steps of enabling members to choose additional members from contact lists as questions are answered correctly, thereby indefinitely adding new branches to said tree.

20. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of content, in a plurality of formats, for said game;
enabling an initiating user who has downloaded the gaming application to access and select at least one content type from said database, receive a first piece of content corresponding to said at least one content type, and provide a response to said first piece of content;
receiving a first response from said initiating user from said user's interaction with said first piece of content;
enabling said initiating user to choose a plurality of first players from a contact list of said initiating user;
sending said first piece of content to each one of said plurality of first players via a social network message;
enabling each one of said plurality of first players to independently view and respond to said first piece of content;
revealing said initiating user's answer to said first piece of content to said plurality of second users;
enabling each one of said first players to i) progress with said game if said response to said first piece of content is correct by providing a personal response to said first piece of content or receiving a second piece of content to provide a response to or ii) providing each one of said first players the opportunity to spend virtual currency to remain in the game if said response to said first piece of content is incorrect;
enabling each of said first players to choose a plurality of second players from a contact list of each one of said first players after each one of said first players responds to said first or said second piece of content;
sending said answered first or second piece of content to each one of said plurality of said second players via a social network message; and,
repeating the steps of enabling members to choose additional members from contact lists as content is responded to correctly, thereby indefinitely adding new members to said game.

21. The method of online gaming among members of a social network of claim 20, wherein after a response is provided to each of a first, second, and any subsequent piece of content, the piece of content is modified by at least one processor in accordance with said response prior to being sent to each of a first, second or subsequent player.

22. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of content, in a plurality of formats, for said game;
enabling an initiating user who has downloaded the gaming application to access and select at least one content type from said database, receive a first piece of content corresponding to said at least one content type, and provide a response to said first piece of content, by planting a seed and growing a tree;
receiving a response from said first user to said first piece of content, forming a trunk of a tree;
enabling said first user to choose a plurality of second users from a contact list of said first user;
sending said first piece of content to each one of said plurality of second users via a social network message;
enabling each one of said plurality of second users to independently view and answer said first piece of content;
revealing said initiating user's answer to the first piece of content to said plurality of second users; and
enabling each one of said second users to become a leaf on said tree by choosing not to send the content along to subsequent players and to not progress with said game.

23. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of content, in a plurality of formats, for said game;
enabling an initiating user who has downloaded the gaming application to access and select at least one content type from said database and receive a first piece of content corresponding to said at least one content type;
receiving a first response from said initiating user from said user's interaction with said first piece of content;
enabling said initiating user to choose a plurality of first players from a contact list of said initiating user;
sending said first piece of content to each one of said plurality of first players via a social network message;
enabling each one of said plurality of first players to independently view and respond to said first piece of content;
revealing said initiating user's answer to the first piece of content to said plurality of first players; and
enabling each one of said first players to i) progress with said game if said response to said first piece of content is correct by providing a personal response to said first piece of content or receiving a second piece of content to provide a response to or ii) providing each one of said first players the opportunity to spend virtual currency to remain in the game if said response to said first piece of content is incorrect;

24. The method of claim 23 further comprising the step of enabling each of said first players to choose a plurality of second players from a contact list of each one of said first players after each one of said first players responds to said first or said second piece of content.

25. The method of claim 24 further comprising the step of sending said answered first or second piece of content to each one of said plurality of said second players via a social network message.

26. The method of claim 25 further comprising the steps of enabling members to choose additional members from contact lists as content is responded to correctly, thereby indefinitely adding new members to said game.

27. The method of online gaming among members of a social network of claim 23, wherein after a response is provided to each of a first, second, and any subsequent piece of content, the piece of content is modified by at least one processor in accordance with said response prior to being sent to each of a first, second or subsequent player.

28. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of questions and answers, in a plurality of formats, for said game;
enabling an initiating user who has downloaded the gaming application to access a first question from said database and receive a first question;
receiving a first answer from said initiating user to said first question, thereby creating a challenge;
enabling said initiating user to choose a plurality of first players from a contact list of said initiating user;
sending said challenge to each one of said plurality of first players via a social network message;
enabling each one of said plurality of first players to independently view and respond to said challenge;
revealing said initiating user's answer to said first question to said plurality of first players;
enabling each one of said first players to i) progress with said game if said challenge is responded to correctly by re-creating a challenge with a personal response or receiving a second question to create a new challenge or ii) providing each one of said first players the opportunity to spend virtual currency to remain in the game if said response to said challenge is incorrect;
enabling each of said first players to choose a plurality of second players from a contact list of each one of said first players after each one of said first players responds to said first or said new challenge;
sending said first challenge or said new challenge to each one of said plurality of said second players via a social network message; and,
repeating the steps of enabling members to choose additional members from contact lists as challenges are responded to correctly, thereby indefinitely adding new members to said game.

29. A method of online gaming among members of a social network, said online gaming effectuated by a plurality of programmatic instructions stored in a non-volatile memory, either remote or local to client devices and servers, and executed by processors at the client devices or servers, said method comprising the steps of:
providing a gaming application for downloading onto a mobile device and for use on a mobile platform;
providing a database of content, in a plurality of formats, for said game;
enabling an initiating user who has downloaded the gaming application to access and select at least one content type from said database, receive a first piece of content corresponding to said at least one content type, and provide a response to said first piece of content;
receiving a response from said initiating user to said first piece of content, thereby creating a challenge;
enabling said initiating user to choose a plurality of first players from a contact list of said initiating user;
sending said challenge to each one of said plurality of first players via a social network message;
enabling each one of said plurality of first players to independently view and respond to said challenge;
revealing said initiating user's answer to said first piece of content to said plurality of first players;
enabling each one of said first players to i) progress with said game if said response to said challenge is correct by re-responding to said challenge receiving a second piece of content to create a new challenge or ii) providing each one of said first players the opportunity to spend virtual currency to remain in the game if said response to said challenge is incorrect;
enabling each of said first players to choose a plurality of second players from a contact list of each one of said first players;
sending said first challenge or new challenge to each one of said plurality of second players via a social network message; and,
repeating the steps of enabling members to choose additional members from contact lists as challenges are created and responded to correctly, thereby indefinitely adding new members to said game.

30. A method for providing a mobile game, comprising:
providing a first question to a first user;
receiving a first response to the first question by the first user;
storing said first response to the first question;
offering to the first user an option to send a version of said first question to a plurality of second users;
prompting each of said plurality of second users to answer the version of the first question;
receiving a plurality of second responses from at least a portion of said plurality of second users based upon said prompting;
storing said plurality of second responses in a database;
comparing each of said plurality of second responses against said first response; and
based upon said comparing, prompting the portion of said plurality of second users to either respond to a second question and send a version of the second question to a plurality of third users, wherein the first user, the portion of said plurality of second users, and a portion of said plurality of third users form a hierarchical social network or spend virtual currency to remain part of said hierarchical social network.

31. The method of claim 30 wherein the first question is the same as the second question.

32. The method of claim 30 wherein the first question is not the same as the second question.

33. The method of claim 30 wherein the first question is selected by the first user from a plurality of questions.

34. The method of claim 30 further comprising the step of providing the first user an option to record an audio, text, video or pictorial message after said first user inputs the first response.

35. The method of claim 30 wherein the step of prompting each of said plurality of second users to answer the version of the first question occurs within a predefined time period.

36. The method of claim 30 further comprising the step of notifying each of said plurality of second users of an existence of said version of the first question during said predefined time period using an electronic message.

37. The method of claim 30 further comprising the step of dropping a portion of the plurality of second users from the hierarchical social network who do not respond to the version of said first question within the predefined time period.

38. The method of claim 30 further comprising the step of dropping a portion of the plurality of second users from the hierarchical social network who do not spend virtual currency to remain part of said hierarchical social network.

39. The method of claim 30 wherein said plurality of second users and plurality of third users do not have any individual users in common.

40. The method of claim 30 further comprising the step of providing one of the portion of said plurality of second users with an interface to post an electronic message to other users of the portion of said plurality of second users.

41. The method of claim 30 further comprising the steps of:
receiving a second response to the second question by one of the portion of said plurality of second users;
storing said second response to the second question;
offering to the one of the portion of said plurality of second users an option to send a version of said second question to the plurality of third users;
prompting each of said plurality of third users to answer the version of the second question;
receiving a plurality of third responses from at least a portion of said plurality of third users based upon said prompting;
storing said plurality of third responses in a database;
comparing each of said plurality of third responses against said second response; and
based upon said comparing, prompting the portion of said plurality of third users to either respond to a third question and send a version of the third question to a plurality of fourth users, wherein the first user, the portion of said plurality of second users, the portion of said plurality of third users, and a portion of said plurality of fourth users form said hierarchical social network or spend virtual currency to remain part of said hierarchical social network.
